(19) United States
(12) Patent Application Publication
(10) Pub. No.: US 2021/0150214 A1
(43) Pub. Date: May 20, 2021

(54) Method for Displaying Service Information on Preview Interface and Electronic Device

(71) Applicant: Huawei Technologies Co., Ltd., Shenzhen (CN)

(72) Inventors: Hong Xu, Shenzhen (CN); Guoying Wang, Xi'an (CN)

(21) Appl. No.: 17/262,899

(22) PCT Filed: Jul. 25, 2018
(86) PCT No.: PCT/CN2018/097122

§ 371 Date: Jan. 25, 2021

(51) Int. Cl. G06K 9/00; G06F 3/0488; H04N 5/232; G06K 9/38; G06K 9/62; G06T 3/40

(52) U.S. Cl. CPC G06K 9/00671; G06F 3/0488; H04N 5/232935; G06F 3/0482; G06K 9/6215; G06T 3/40; G06K 2209/01; G06K 9/38

(57) ABSTRACT

A method for displaying service information on a preview interface, includes displaying by an electronic device, a photographing preview interface including a control, displaying p function controls and q function controls in response to a touch operation on the control, where the preview object includes a first sub-object of a text type and a second sub-object of an image type, p function controls correspond to the first sub-object, q function controls correspond to the second sub-object, displaying, in response to a touch operation performed on a first function control in the p function controls, first service information corresponding to a first function option, and displaying, in response to a touch operation performed on a second function control in the q function controls, second service information corresponding to a second function option.

### TECHNICAL FIELD

This application relates to the field of electronic device technologies, and in particular, to a method for displaying service information on a preview interface and an electronic device.

### BACKGROUND

With development of photographing technologies of an electronic device such as a mobile phone, basic hardware configuration such as a camera becomes higher, photographing modes become richer, a shooting effect becomes better, and user experience becomes better. However, in the shooting mode, the electronic device can only shoot an image or can only perform some simple processing on the image, for example, beautification, time-lapse photographing, or watermark adding, and cannot perform deep processing on the image.

### SUMMARY

Embodiments of this application provide a method for displaying service information on a preview interface and an electronic device, to enhance an image processing function of the electronic device during a photographing preview.

To achieve the foregoing objective, the following technical solutions are used in the embodiments of this application.

According to an aspect, a technical solution of this application provides a method for displaying service information on a preview interface, applied to an electronic device having a touchscreen. The method includes: detecting, by the electronic device, a first touch operation used to start a camera application; displaying, by the electronic device, a first photographing preview interface on the touchscreen in response to the first touch operation, where the first preview interface includes a smart reading mode control; detecting, by the electronic device, a second touch operation performed on the smart reading mode control; separately displaying, by the electronic device on a second preview interface in response to the second touch operation, p function controls and q function controls corresponding to the smart reading mode control, where a preview object exists on the second preview interface; and the preview object includes a first sub-object and a second sub-object, the first sub-object is of a text type, the second sub-object is of an image type, the p function controls correspond to the first sub-object, the q function controls correspond to the second sub-object, and the p function controls are different from the q function controls; detecting, by the electronic device, a third touch operation performed on a first function control in the p function controls; displaying, by the electronic device on the second preview interface in response to the third touch operation, first service information corresponding to a first function option, where the first service information is obtained after the electronic device processes the first sub-object on the second preview interface; detecting, by the electronic device, a fourth touch operation performed on a second function control in the q function controls; and displaying, by the electronic device on the second preview interface in response to the fourth touch operation, second service information corresponding to a second function option, where the second service information is obtained after the electronic device processes the second sub-object on the second preview interface; and p and q are natural numbers, p and q may be the same, or may be different.

In this way, in a photographing preview state, the electronic device may display, in response to an operation performed by a user on the smart reading mode control, different function options respectively corresponding to different types of preview sub-objects, and process a preview sub-object based on a function option selected by the user, to obtain service information corresponding to the function option, so as to display, on the preview interface, different sub-objects and service information corresponding to the selected function option. Therefore, a preview processing function of the electronic device can be improved.

In a possible implementation, the first service information is obtained after the electronic device processes a character in a first object on the second preview interface. The character may include characters of various countries, for example, a Chinese character, an English character, a Russian character, a German character, a French character, a Japanese character, and the like, and may further include a number, a letter, a symbol, and the like. The service information includes abstract information, keyword information, entity information, opinion information, classification information, emotion information, association information, or product remark information.

In this solution, a function option corresponding to a preview sub-object of the text type may be used to correspondingly process a character in the preview sub-object of the text type, so that the electronic device displays, on the preview interface, service information associated with character content in the preview sub-object, and converts unstructured character content in the preview sub-object into structured character content, so as to reduce an information amount, reduce time spent by the user in reading a large amount of character information in a text object, help the user read a small amount of information that the user cares most, and facilitate reading and information management of the user.

In a possible implementation, the displaying, by the electronic device, first service information corresponding to a first function option includes: displaying, by the electronic device, a function interface on the second preview interface in a superimposing manner, where the function interface includes the first service information corresponding to the first function option.

In this way, it is convenient for the user to learn of service information through a function interface displayed in front.

In another possible implementation, when the electronic device displays service information corresponding to a plurality of function options, the function interface includes a plurality of parts, and each part is used to display service information of one function option.

In this way, it is convenient for the user to distinguish between service information corresponding to different function options.

In another possible implementation, the displaying, by the electronic device, first service information corresponding to a first function option includes: displaying, by the electronic device in a marking manner on the preview object displayed on the second preview interface, the first service information corresponding to the first function option.

In this way, the service information in the preview object may be highlighted in the marking manner, so that the user browses the service information conveniently.

In another possible implementation, displaying, by the electronic device on the first preview interface, a function control corresponding to the smart reading mode control includes: displaying, by the electronic device on the first preview interface, a function list corresponding to the smart reading mode control, where the function list includes a function option.

In this way, function options can be displayed in the function list in a centralized manner.

In another possible implementation, in response to the detecting, by the electronic device, a touch operation performed by a user on the smart reading mode control, the method further includes: displaying, by the electronic device, a language setting control on the touchscreen, where the language setting control is used to set a language type of the service information.

In this way, it is convenient for the user to set and switch the language type of the service information.

In another possible implementation, after the electronic device displays a function option on the touchscreen, the method further includes: hiding the function option if the electronic device detects a first operation performed by the user on the touchscreen.

In this way, when the user does not need to use the function option or the function option hinders the user from browsing the preview object, the electronic device may hide the function option.

In another possible implementation, after the electronic device hides the function option, after detecting a second operation performed by the user, the electronic device may resume displaying the function option.

In this way, it is convenient for the user to invoke the function option again when the user needs to use the function option.

In another possible implementation, before the displaying, by the electronic device, first service information corresponding to a first function option, the method further includes: obtaining, by the electronic device, a preview image in a RAW format of the preview object; determining, by the electronic device based on the preview image, a standard character corresponding to a to-be-recognized character in the preview object; and determining, by the electronic device based on the standard character corresponding to the to-be-recognized character, the first service information corresponding to the first function option.

In this way, the electronic device may directly process an original image that is in the RAW format and that is output by a camera, without a need to perform, before character recognition, ISP processing on the original image to generate a picture. A picture preprocessing operation (including some inverse processes of ISP processing) performed during character recognition in some other methods is omitted, so that computing resources are saved, noise introduced due to preprocessing can be avoided, and recognition accuracy can be improved.

In another possible implementation, the determining, by the electronic device based on the preview image, a standard character corresponding to a to-be-recognized character in the preview object includes: performing, by the electronic device, binary processing on the preview image, to obtain a preview image including a black pixel and a white pixel; determining, by the electronic device based on a location relationship between adjacent black pixels in the preview image, at least one target black pixel included in the to-be-recognized character; performing, by the electronic device, encoding based on coordinates of the target black pixel, to obtain a first encoding vector of the to-be-recognized character; calculating, by the electronic device, a similarity between the first encoding vector and a preset second encoding vector of at least one standard character in a standard library; and determining, by the electronic device based on the similarity, the standard character corresponding to the to-be-recognized character.

In this way, the electronic device may calculate a similarity based on an encoding vector including coordinates of a pixel, and then perform character recognition. In this method, accuracy is relatively high.

In another possible implementation, a size range of the standard character is a preset size range, and the performing, by the electronic device, encoding based on coordinates of the target black pixel, to obtain a first encoding vector of the to-be-recognized character includes: scaling, by the electronic device, down/up a size range of the to-be-recognized character to the preset size range; and performing, by the electronic device, encoding based on coordinates of the target black pixel in the scaled-down/up to-be-recognized character, to obtain the first encoding vector.

When the standard character corresponding to the to-be-recognized character is determined, because the to-be-recognized character and the standard character may have different size ranges, the to-be-recognized character usually needs to be processed before being compared with the standard character.

In another possible implementation, a size range of the standard character is a preset size range, and the performing, by the electronic device, encoding based on coordinates of the target black pixel, to obtain a first encoding vector of the to-be-recognized character includes: performing, by the electronic device, encoding based on the coordinates of the target black pixel in the to-be-recognized character, to obtain a third encoding vector; calculating, by the electronic device, a ratio Q of the preset size range to a size range of the to-be-recognized character; and calculating, by the electronic device based on the third encoding vector, the ratio Q. and an image scaling algorithm, the first encoding vector corresponding to the to-be-recognized character that is scaled down/up by Q times.

In another possible implementation, a size range of a character is a size range of an area enclosed by a first straight line tangent to a left side of a leftmost black pixel of the character, a second straight line tangent to a right side of a rightmost black pixel of the character, a third straight line tangent to an upper side of an uppermost black pixel of the character, and a fourth straight line tangent to a bottom side of a bottom black pixel of the character.

In this way, a size of the size range of the to-be-recognized character may be determined, so that the to-be-recognized character may be scaled down or scaled up based on the size range.

In another possible implementation, the standard library includes a reference standard character and a first similarity between each of other standard characters and the reference standard character, and the calculating, by the electronic device, a similarity between the first encoding vector and a preset second encoding vector of at least one standard character in a standard library includes: calculating, by the electronic device, a second similarity between the first encoding vector and a second encoding vector of the reference standard character; determining at least one target first similarity, where an absolute value of a difference between the target first similarity and the second similarity is less than or equal to a preset threshold; and calculating a third similarity between the first encoding vector and a second encoding vector of a standard character corresponding to each of the at least one target first similarity; and the determining, by the electronic device based on the similarity, the standard character corresponding to the to-be-recognized character includes: determining, by the electronic device based on the third similarity, the standard character corresponding to the to-be-recognized character.

In this way, the electronic device does not need to sequentially compare the to-be-recognized character with each standard character in the standard library, so that a similarity calculation range can be narrowed down, a process of calculating a similarity between the to-be-recognized character and Chinese characters in the standard library one by one is effectively avoided, and a time for calculating a similarity is greatly reduced.

According to another aspect, a technical solution of this application provides a method for displaying service information on a preview interface, applied to an electronic device having a touchscreen. The method includes: detecting, by the electronic device, a first touch operation used to start a camera application; displaying, by the electronic device, a first photographing preview interface on the touchscreen in response to the first touch operation, where the first preview interface includes a smart reading mode control; detecting, by the electronic device, a second touch operation performed on the smart reading mode control; displaying, by the electronic device on the first preview interface in response to the second touch operation, m function controls corresponding to the smart reading mode control, where m is a positive integer; detecting, by the electronic device, a third touch operation performed on a first function control in the m function controls; and displaying, by the electronic device on a second preview interface in response to the third touch operation, first service information corresponding to a first function option, where a first preview object exists on the second preview interface, and the first service information is obtained after the electronic device processes the first preview object on the second preview interface.

In a possible implementation, the method further includes: when the first preview object on the second preview interface is switched to a second preview object, displaying, by the electronic device on the second preview interface, second service information corresponding to the first function option, where the second service information is obtained after the electronic device processes the second preview object on the second preview interface; and stopping, by the electronic device, displaying the first service information.

A display location of the second service information may be the same as or different from a display location of the first service information.

In another possible implementation, the method further includes: when the first preview object on the second preview interface is switched to a second preview object, displaying, by the electronic device on the second preview interface, second service information corresponding to the first function option, where the second service information is obtained after the electronic device processes the second preview object on the second preview interface; displaying, by the electronic device in a shrinking manner in an upper left comer, an upper right corner, a lower left comer, or a lower right corner of the second preview interface, the first service information corresponding to the first function option, where a display location of the first service information is different from a display location of the second service information; detecting, by the electronic device, a third operation; and displaying, by the electronic device, the first service information and the second service information in a combined manner in response to the third operation.

In this solution, the electronic device may display the first service information of the first preview object in the shrinking manner, and display the second service information of the second preview object. In addition, the first service information and the second information may further be displayed in the combined manner, so that a user integrates related service information corresponding to a plurality of preview objects.

In another possible implementation, the method further includes: when the first preview object on the second preview interface is switched to a second preview object, displaying, by the electronic device on the second preview interface, third service information corresponding to the first function option, where the third service information includes the first service information and second service information, and the second service information is obtained after the electronic device processes the second preview object on the second preview interface.

In this solution, the electronic device may display, in a combined manner, related service information corresponding to a plurality of preview objects.

According to another aspect, a technical solution of this application provides a method for displaying service information on a preview interface, applied to an electronic device having a touchscreen. The method includes: detecting, by the electronic device, a first touch operation used to start a camera application; displaying, by the electronic device, a first photographing preview interface on the touchscreen in response to the first touch operation; detecting, by the electronic device, a fourth operation performed on the touchscreen; displaying, by the electronic device, m function options on the first preview interface in response to the fourth operation, where m is a positive integer; detecting, by the electronic device, a third touch operation performed on one function control in the m function controls; and displaying, by the electronic device on a second preview interface in response to the third touch operation, service information corresponding to the one function option, where a preview object exists on the second preview interface, and the service information is obtained after the electronic device processes the preview object on the second preview interface.

The fourth operation may be a touch and hold operation, an operation of holding and dragging by using two fingers, an operation of swiping upward, an operation of swiping downward, an operation of drawing a circle track, an operation of pulling down by using three fingers, or the like.

According to another aspect, a technical solution of this application provides a method for displaying service information on a preview interface, applied to an electronic device having a touchscreen. The method includes: detecting, by the electronic device, a first touch operation used to start a camera application; displaying, by the electronic device, a first photographing preview interface on the touchscreen in response to the first touch operation, where the first preview interface includes m function options, and m is a positive integer; detecting, by the electronic device, a third touch operation performed on one function control in the m function controls; and displaying, by the electronic device on a second preview interface in response to the third touch operation, service information corresponding to the one function option, where a preview object exists on the second preview interface, and the service information is obtained after the electronic device processes the preview object on the second preview interface.

According to another aspect, a technical solution of this application provides a method for displaying service information on a preview interface, applied to an electronic device having a touchscreen. The method includes: detecting, by the electronic device, a first touch operation used to start a camera application; displaying, by the electronic device, a photographed preview interface on the touchscreen in response to the first touch operation, where a preview object exists on the preview interface, there is also service information of m function options and service information of k function options on the preview interface, the k function options are selected function options in the m function options, m is a positive integer, and k is a positive integer less than or equal to m detecting, by the electronic device, a fifth touch operation of deselecting a third function option in the k function options by the user; and stopping, by the electronic device in response to the fifth touch operation, displaying service information of the third function option on the preview interface.

According to another aspect, a technical solution of this application provides a method for displaying service information on a preview interface, applied to an electronic device having a touchscreen. The method includes: detecting, by the electronic device, a first touch operation used to start a camera application; displaying, by the electronic device, a first photographing preview interface on the touchscreen in response to the first touch operation, where the first preview interface includes a photographing option; detecting, by the electronic device, a touch operation performed on the photographing option; displaying, by the electronic device, a shooting mode interface in response to the touch operation performed on the photographing option, where the shooting mode interface includes a smart reading mode control; detecting, by the electronic device, a second touch operation performed on the smart reading mode control; displaying, by the electronic device on a second preview interface in response to the second touch operation, m function controls corresponding to the smart reading mode control, where m is a positive integer; detecting, by the electronic device, a third touch operation performed on one function control in the m function controls; and displaying, by the electronic device on a third preview interface in response to the third touch operation, service information corresponding to the one function option, where the service information is obtained after the electronic device processes a preview object on the third preview interface.

According to another aspect, a technical solution of this application provides a picture display method, applied to an electronic device having a touchscreen. The method includes: displaying, by the electronic device, a first interface on the touchscreen, where the first interface includes a picture and a smart reading mode control; detecting, by the electronic device, a second touch operation performed on the smart reading mode control; displaying, by the electronic device on the touchscreen in response to the second touch operation, m function controls corresponding to the smart reading mode control, where m is a positive integer; detecting, by the electronic device, a third touch operation performed on one function control in the m function controls; and displaying, by the electronic device on the touchscreen in response to the third touch operation, service information corresponding to the one function option, where the service information is obtained after the electronic device processes the picture.

The service information is obtained after the electronic device processes a character on the picture.

According to another aspect, a technical solution of this application provides a text content display method, applied to an electronic device having a touchscreen. The method includes: displaying, by the electronic device, a second interface on the touchscreen, where the second interface includes text content and a smart reading mode control, detecting, by the electronic device, a second touch operation performed on the smart reading mode control; displaying, by the electronic device on the touchscreen in response to the second touch operation, m function controls corresponding to the smart reading mode control, where m is a positive integer; detecting, by the electronic device, a third touch operation performed on one function control in the m function controls; and displaying, by the electronic device on the touchscreen in response to the third touch operation, service information corresponding to the one function option, where the service information is obtained after the electronic device processes the text content.

The service information is obtained after the electronic device processes a character in the text content.

According to another aspect, a technical solution of this application provides a character recognition method, including: obtaining, by an electronic device, a target image in a RAW format; and then determining, by the electronic device, a standard character corresponding to a to-be-recognized character in the target image.

In this way, the electronic device may directly process an original image that is in the RAW format and that is output by a camera, without a need to perform, before character recognition, ISP processing on the original image to generate a picture. A picture preprocessing operation (including some inverse processes of ISP processing) performed during character recognition in some other methods is omitted, so that computing resources are saved, noise introduced due to preprocessing can be avoided, and recognition accuracy can be improved.

In a possible implementation, the target image is a preview image obtained during a photographing preview.

In another possible implementation, the determining, by the electronic device, a standard character corresponding to a to-be-recognized character in the target image includes: performing, by the electronic device, binary processing on the target image, to obtain a target image including a black pixel and a bite pixel; determining, based on a location relationship between adjacent black pixels in the target image, at least one target black pixel included in the to-be-recognized character; performing encoding based on coordinates of the target black pixel, to obtain a first encoding vector of the to-be-recognized character; calculating a similarity between the first encoding vector and a preset second encoding vector of at least one standard character in a standard library; and determining, based on the similarity, the standard character corresponding to the to-be-recognized character.

In another possible implementation, a size range of the standard character is a preset size range, and the performing, by the electronic device, encoding based on coordinates of the target black pixel, to obtain an encoding vector of the to-be-recognized character includes: scaling, by the electronic device, down/up a size range of the to-be-recognized character to the preset size range; and performing, by the electronic device, encoding based on coordinates of the target black pixel in the scaled-down/up to-be-recognized character, to obtain the first encoding vector.

In another possible implementation, a size range of the standard character is a preset size range, and the performing, by the electronic device, encoding based on coordinates of the target black pixel, to obtain an encoding vector of the to-be-recognized character includes: performing, by the electronic device, encoding based on the coordinates of the target black pixel in the to-be-recognized character, to obtain a third encoding vector; calculating, by the electronic device, a ratio Q of the preset size range to a size range of the to-be-recognized character; and calculating, by the electronic device based on the third encoding vector, the ratio Q, and an image scaling algorithm, the first encoding vector corresponding to the to-be-recognized character that is scaled down/up by Q times.

In another possible implementation, a size range of a character is a size range of an area enclosed by a first straight line tangent to a left side of a leftmost black pixel of the character, a second straight line tangent to a right side of a rightmost black pixel of the character, a third straight line tangent to an upper side of an uppermost black pixel of the character, and a fourth straight line tangent to a bottom side of a bottom black pixel of the character.

In another possible implementation, the standard library includes a reference standard character and a first similarity between a second encoding vector of each of other standard characters and a second encoding vector of the reference standard character, and the calculating, by the electronic device, a similarity between the first encoding vector and a preset second encoding vector of at least one standard character in a standard library includes: calculating, by the electronic device, a second similarity between the first encoding vector and the reference standard character; determining at least one target first similarity, where an absolute value of a difference between the target first similarity and the second similarity is less than or equal to a preset threshold; and calculating a third similarity between the first encoding vector and a second encoding vector of a standard character corresponding to each of the at least one target first similarity; and the determining, by the electronic device based on the similarity, the standard character corresponding to the to-be-recognized character includes: determining, by the electronic device based on the third similarity, the standard character corresponding to the to-be-recognized character.

According to another aspect, an embodiment of this application provides an electronic device, including a detection unit and a display unit. The detection unit is configured to detect a first touch operation used to start a camera application. The display unit is configured to display a first photographing preview interface on a touchscreen in response to the first touch operation. The first preview interface includes a smart reading mode control. The detection unit is further configured to detect a second touch operation performed on the smart reading mode control. The display unit is further configured to separately display, on a second preview interface in response to the second touch operation, p function controls and q function controls corresponding to the smart reading mode control. A preview object exists on the second preview interface. The preview object includes a first sub-object and a second sub-object, the first sub-object is of a text type, the second sub-object is of an image type, the p function controls correspond to the first sub-object, the q function controls correspond to the second sub-object, p and q are natural numbers, and the p function controls are different from the q function controls. The detection unit is further configured to detect a third touch operation performed on a first function control in the p function controls. The display unit is further configured to display, on the second preview interface in response to the third touch operation, first service information corresponding to a first function option. The first service information is obtained after the electronic device processes the first sub-object on the second preview interface. The detection unit is further configured to detect a fourth touch operation performed on a second function control in the q function controls. The display unit is further configured to display, on the second preview interface in response to the fourth touch operation, second service information corresponding to a second function option. The second service information is obtained after the electronic device processes the second sub-object on the second preview interface.

In a possible implementation, the electronic device further includes a processing unit, configured to: before the first service information corresponding to the first function option is displayed on the second preview interface on the touchscreen, obtain a preview image in a RAW format of the preview object; determine, based on the preview image, a standard character corresponding to a to-be-recognized character in the preview object; and determine, based on the standard character corresponding to the to-be-recognized character, the first service information corresponding to the first function option.

In another possible implementation, the processing unit is specifically configured to: perform binary processing on the preview image, to obtain a preview image including a black pixel and a white pixel; determine, based on a location relationship between adjacent black pixels in the preview image, at least one target black pixel included in the to-be-recognized character; perform encoding based on coordinates of the target black pixel, to obtain a first encoding vector of the to-be-recognized character; calculate a similarity between the first encoding vector and a preset second encoding vector of at least one standard character in a standard library; and determine, based on the similarity, the standard character corresponding to the to-be-recognized character.

In another possible implementation, a size range of the standard character is a preset size range, and the processing unit is specifically configured to: scale down/up a size range of the to-be-recognized character to the preset size range; and perform encoding based on coordinates of the target black pixel in the scaled-down/up to-be-recognized character, to obtain the first encoding vector.

In another possible implementation, a size range of the standard character is a preset size range, and the processing unit is specifically configured to: perform encoding based on the coordinates of the target black pixel in the to-be-recognized character, to obtain a third encoding vector; calculate a ratio Q of the preset size range to a size range of the to-be-recognized character; and calculate, based on the third encoding vector, the ratio Q. and an image scaling algorithm, the first encoding vector corresponding to the to-be-recognized character that is scaled down/up by Q times.

In another possible implementation, the standard library includes a reference standard character and a first similarity between a second encoding vector of each of other standard characters and a second encoding vector of the reference standard character, and the processing unit is specifically configured to: calculate a second similarity between the first encoding vector and the second encoding vector of the reference standard character; determine at least one target first similarity, where an absolute value of a difference between the target first similarity and the second similarity is less than or equal to a preset threshold; and calculate a third similarity between the first encoding vector and a second encoding vector of a standard character corresponding to each of the at least one target first similarity; and determine, based on the third similarity, the standard character corresponding to the to-be-recognized character.

In another possible implementation, the display unit is specifically configured to display a function interface on the second preview interface in a superimposing manner, where the function interface includes the first service information corresponding to the first function option; or display, in a marking manner on the preview object displayed on the second preview interface, the first service information corresponding to the first function option.

In another possible implementation, the first service information includes abstract information, keyword information, entity information, opinion information, classification information, emotion information, association information, or product remark information.

According to another aspect, an embodiment of this application provides an electronic device, including a touchscreen, a memory, and a processor. The touchscreen, the at least one memory, and the at least one processor are coupled. The touchscreen is configured to detect a first touch operation used to start a camera application. The processor is configured to instruct, in response to the first touch operation, the touchscreen to display a first photographing preview interface. The touchscreen is further configured to display the first preview interface according to an instruction of the processor. The first preview interface includes a smart reading mode control. The touchscreen is further configured to detect a second touch operation performed on the smart reading mode control. The processor is further configured to instruct, in response to the second touch operation, the touchscreen to display a second preview interface. The touchscreen is further configured to display the second preview interface according to an instruction of the processor, where p function controls and q function controls corresponding to the smart reading mode control are separately displayed on the second preview interface, and a preview object exists on the second preview interface. The preview object includes a first sub-object and a second sub-object, the first sub-object is of a text type, the second sub-object is of an image type, the p function controls correspond to the first sub-object, the q function controls correspond to the second sub-object, p and q are natural numbers, p and q may be the same or different, and the p function controls are different from the q function controls. The touchscreen is further configured to detect a third touch operation performed on a first function control in the p function controls. The processor is further configured to instruct, in response to the third touch operation, the touchscreen to display, on the second preview interface, first service information corresponding to the first function option. The touchscreen is further configured to display the first service information according to an instruction of the processor. The first service information is obtained after the electronic device processes the first sub-object on the second preview interface. The touchscreen is further configured to detect a fourth touch operation performed on a second function control in the q function controls. The processor is further configured to instruct, in response to the fourth touch operation, the touchscreen to display, on the second preview interface, second service information corresponding to the second function option. The touchscreen is further configured to display, on the second preview interface according to an instruction of the processor, the second service information corresponding to the second function option. The second service information is obtained after the electronic device processes the second sub-object on the second preview interface. The memory is configured to store the first preview interface and the second preview interface.

In a possible implementation, the processor is further configured to: before the first service information corresponding to the first function option is displayed on the second preview interface on the touchscreen, obtain a preview image in a RAW format of the preview object; determine, based on the preview image, a standard character corresponding to a to-be-recognized character in the preview object; and determine, based on the standard character corresponding to the to-be-recognized character, the first service information corresponding to the first function option.

In another possible implementation, the processor is specifically configured to: perform binary processing on the preview image, to obtain a preview image including a black pixel and a white pixel; determine, based on a location relationship between adjacent black pixels in the preview image, at least one target black pixel included in the to-be-recognized character; perform encoding based on coordinates of the target black pixel, to obtain a first encoding vector of the to-be-recognized character; calculate a similarity between the first encoding vector and a preset second encoding vector of at least one standard character in a standard library; and determine, based on the similarity, the standard character corresponding to the to-be-recognized character.

In another possible implementation, a size range of the standard character is a preset size range, and the processor is specifically configured to: scale down/up a size range of the to-be-recognized character to the preset size range; and perform encoding based on coordinates of the target black pixel in the scaled-down/up to-be-recognized character, to obtain the first encoding vector.

In another possible implementation, the processing unit is specifically configured to: perform encoding based on the coordinates of the target black pixel in the to-be-recognized character, to obtain a third encoding vector; calculate a ratio Q of the preset size range to a size range of the to-be-recognized character; and calculate, based on the third encoding vector, the ratio Q, and an image scaling algorithm, the first encoding vector corresponding to the to-be-recognized character that is scaled down/up by Q times.

In another possible implementation, the standard library includes a reference standard character and a first similarity between a second encoding vector of each of other standard characters and a second encoding vector of the reference standard character, and the processor is specifically configured to: calculate a second similarity between the first encoding vector and the second encoding vector of the reference standard character; determine at least one target first similarity, where an absolute value of a difference between the target first similarity and the second similarity is less than or equal to a preset threshold; calculate a third similarity between the first encoding vector and a second encoding vector of a standard character corresponding to each of the at least one target first similarity; and determine, based on the third similarity, the standard character corresponding to the to-be-recognized character.

In another possible implementation, the touchscreen is specifically configured to: display a function interface on the second preview interface in a superimposing manner according to an instruction of the processor, where the function interface includes the first service information corresponding to the first function option; or display, in a marking manner on the preview object displayed on the second preview interface according to an instruction of the processor, the first service information corresponding to the first function option.

In another possible implementation, the first service information includes abstract information, keyword information, entity information, opinion information, classification information, emotion information, association information, or product remark information.

According to another aspect, a technical solution of this application provides an electronic device, including one or more processors and one or more memories. The one or more memories are coupled to the one or more processors, the one or more memories are configured to store computer program code, the computer program code includes a computer instruction, and when the one or more processors execute the computer instruction, the electronic device performs the preview display method, the picture display method, or the character recognition method in any possible implementation of any one of the foregoing aspects.

According to another aspect, a technical solution of this application provides a computer storage medium, including a computer instruction. When the computer instruction is run on an electronic device, the electronic device is enabled to perform the preview display method, the picture display method, or the character recognition method in any possible implementation of any one of the foregoing aspects.

According to another aspect, a technical solution of this application provides a computer program product. When the computer program product is run on an electronic device, the electronic device is enabled to perform the preview display method, the picture display method, or the character recognition method in any possible implementation of any one of the foregoing aspects.

### BRIEF DESCRIPTION OF DRAWINGS

FIG. 1 is a schematic structural diagram of hardware of an electronic device according to an embodiment of this application;

FIG. 2 is a schematic structural diagram of software of an electronic device according to an embodiment of this application;

FIG. 3a and FIG. 3b are schematic diagrams of a group of display interfaces according to an embodiment of this application;

FIG. 4a to FIG. 23d are schematic diagrams of a series of interfaces existing during a photographing preview according to an embodiment of this application;

FIG. 24a to FIG. 24c are schematic diagrams of another group of display interfaces according to an embodiment of this application;

FIG. 25a to FIG. 25h are schematic diagrams of a series of interfaces existing during a photographing preview according to an embodiment of this application;

FIG. 26a to FIG. 27b are schematic diagrams of a series of interfaces existing when a shot picture is displayed according to an embodiment of this application:

FIG. 28a to FIG. 28c are schematic diagrams of another group of display interfaces according to an embodiment of this application:

FIG. 29a to FIG. 30b are schematic diagrams of a series of interfaces existing when text content is displayed according to an embodiment of this application;

FIG. 31 is a schematic diagram of a to-be-recognized character according to an embodiment of this application;

FIG. 32a and FIG. 32b are schematic diagrams of an effect of scaling down/up a group of to-be-recognized characters according to an embodiment of this application:

FIG. 33 and FIG. 34 are flowcharts of a method according to an embodiment of this application; and

FIG. 35 is a schematic structural diagram of an electronic device according to an embodiment of this application.

### DESCRIPTION OF EMBODIMENTS

The following describes the technical solutions in the embodiments of this application with reference to the accompanying drawings in the embodiments of this application. In description of the embodiments of this application, “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists. In addition, in the descriptions in the embodiments of this application, “a plurality of” means two or more than two.

A method for displaying a personalized function of a text image provided in the embodiments of this application may be applied to an electronic device. The electronic device may be a portable electronic device that further includes another function such as a personal digital assistant and/or a music player function, for example, a mobile phone, a tablet, or a wearable device (for example, a smart watch) having a wireless communication function. An example embodiment of the portable electronic device includes but is not limited to a portable electronic device using iOS), Android), Microsoft®, or another operating system. The portable electronic device may also be another portable electronic device, for example, a laptop computer (Laptop) with a touch-sensitive surface (for example, a touch panel). It should be further understood that in some other embodiments of this application, the electronic device may alternatively be a desktop computer with a touch-sensitive surface (for example, a touch panel), but not a portable electronic device.

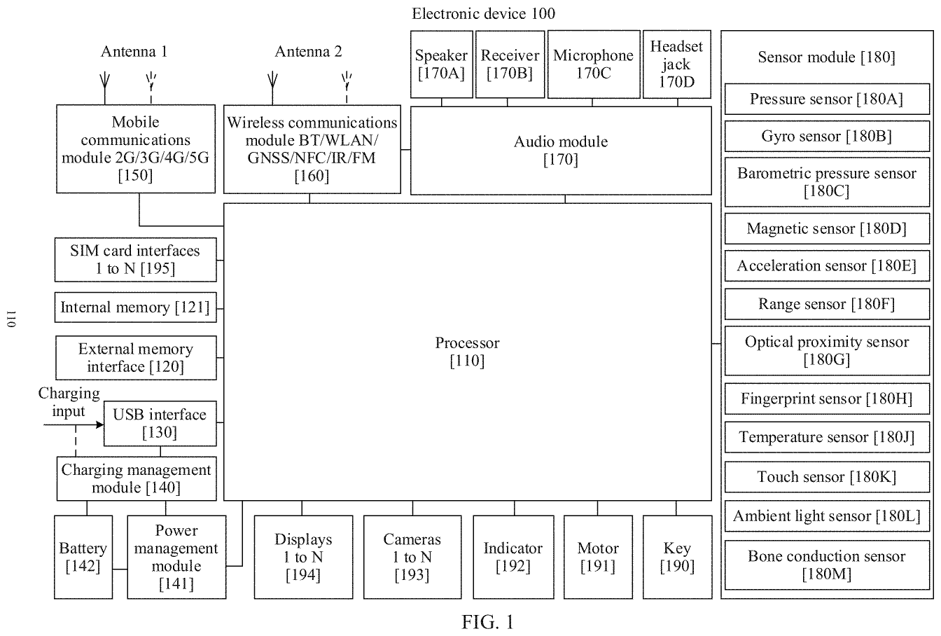

For example, FIG. 1 is a schematic structural diagram of an electronic device 100. The electronic device 100 may include a processor 110, an external memory interface 120, an internal memory 121, a USB interface 130, a charging management module 140, a power management module 141, a battery 142, an antenna 1, an antenna 2, a mobile communications module 150, a wireless communications module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (subscriber identification module, SIM) card interface 195, and the like. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this application does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, a neural processing unit (neural-network processing unit, NPU), and/or the like. Different processing units may be independent components, or may be integrated into one or more processors.

The controller may be a nerve center and a command center of the electronic device 100. The controller may generate an operation control signal based on an instruction operation code and a time sequence signal, to complete control of instruction reading and instruction execution.

A memory may be further disposed in the processor 110, and is configured to store an instruction and data. In some embodiments, the memory in the processor is a cache memory. The memory may store an instruction or data that has been used or cyclically used by the processor 110. If the processor 110 needs to use the instruction or the data again, the processor 110 may directly invoke the instruction or the data from the memory, to avoid repeated access and reduce a waiting time of the processor, thereby improving system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter. UART) interface, a mobile industry processor interface (mobile industry processor interface, MIPI), a general-purpose input/output (general-purpose input/output, GPIO) interface, a subscriber identity module (subscriber identity module. SIM) interface, a universal serial bus (universal serial bus, USB) interface, and/or the like.

The I2C interface is a two-way synchronization serial bus, and includes a serial data line (serial data line, SDA) and a serial clock line (derail clock line, SCL). In some embodiments, the processor may include a plurality of groups of I2C buses. The processor may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the electronic device 100.

The I2S interface may be configured to perform audio communication. In some embodiments, the processor 110 may include a plurality of groups of 2S buses. The processor 110 may be coupled to the audio module 170 through the I2S bus, to implement communication between the processor 110 and the audio module 170. In some embodiments, the audio module 170 may transmit an audio signal to the wireless communications module 160 through the I2S interface, to implement a function of answering a call by using a Bluetooth headset.

The PCM interface may also be configured to: perform audio communication, and sample, quantize, and code an analog signal. In some embodiments, the audio module 170 may be coupled to the wireless communications module 160 through a PCM bus interface. In some embodiments, the audio module 170 may also transmit an audio signal to the wireless communications module 160 through the PCM interface, to implement a function of answering a call by using a Bluetooth headset. Both the I2S interface and the PCM interface may be configured to perform audio communication, and sampling rates of the two interfaces may be different or may be the same.

The UART interface is a universal serial data bus, and is configured to perform asynchronous communication. The bus may be a two-way communications bus, and converts to-be-transmitted data between serial communication and parallel communication. In some embodiments, the UART interface is usually configured to connect the processor 110 to the wireless communications module 160. For example, the processor 110 communicates with a Bluetooth module in the wireless communications module 160 through the UART interface, to implement a Bluetooth function. In some embodiments, the audio module 170 may transmit an audio signal to the wireless communications module 160 through the UART interface, to implement a function of playing music by using a Bluetooth headset.

The MIPI interface may be configured to connect the processor 110 to a peripheral component such as the display 194 or the camera 193. The MIPI interface includes a camera serial interface (camera serial interface, CSI), a display serial interface (display serial interface, DS), and the like. In some embodiments, the processor 110 communicates with the camera 193 through the CSI interface, to implement a photographing function of the electronic device 100. The processor 110 communicates with the display 194 through the DSI interface, to implement a display function of the electronic device 100.

The GPIO interface may be configured by using software. The GPIO interface may be configured as a control signal or a data signal. In some embodiments, the GPIO interface may be configured to connect the processor 110 to the camera 193, the display 194, the wireless communications module 160, the audio module 170, the sensor module 180, and the like. The GPIO interface may also be configured as the I2C interface, the I2S interface, the UART interface, the MIPI interface, or the like.

The USB interface 130 is an interface that conforms to a USB standard specification, and may be specifically a mini USB interface, a micro USB interface, a USB type-C interface, or the like. The USB interface may be configured to connect to the charger to charge the electronic device 100, or may be configured to perform data transmission between the electronic device 100 and a peripheral device, or may be configured to connect to a headset to play audio through the headset. The interface may be further configured to connect to another electronic device such as an AR device.

It may be understood that an interface connection relationship between the modules that is shown in this embodiment of the present invention is merely an example for description, and does not constitute a limitation on a structure of the electronic device 100. In some other embodiments of this application, the electronic device 100 may alternatively use an interface connection manner different from that in the foregoing embodiment, or a combination of a plurality of interface connection manners.

The charging management module 140 is configured to receive a charging input from the charger. The charger may be a wireless charger or a wired charger. In some embodiments of wired charging, the charging management module 140 may receive a charging input of a wired charger through the USB interface. In some embodiments of wireless charging, the charging management module 140 may receive a wireless charging input by using a wireless charging coil of the electronic device 100. The charging management module 140 supplies power to the electronic device 100 through the power management module 141 while charging the battery 142.

The power management module 141 is configured to connect the battery 142 and the charging management module 140 to the processor 110. The power management module 141 receives an input of the battery 142 and/or the charging management module 140, and supplies power to the processor 110, the internal memory 121, an external memory, the display 194, the camera 193, the wireless communications module 160, and the like. The power management module 141 may be further configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented by using an antenna module 1, an antenna module 2, the mobile communications module 150, the wireless communications module 160, the modem processor, the baseband processor, and the like.

The antenna 1 and the antenna 2 are configured to transmit and receive an electromagnetic wave signal. Each antenna in the electronic device 100 may be configured to cover one or more communications frequency bands. Different antennas may be further multiplexed, to improve antenna utilization. For example, a cellular network antenna may be multiplexed as a wireless local area network diversity antenna. In some other embodiments, the antenna may be used in combination with a tuning switch.

The mobile communications module 150 can provide a solution, applied to the electronic device 100, to wireless communication including 2G, 3G, 4G, 5G, and the like. Specifically, the mobile communications module 150 may include at least one filter, a switch, a power amplifier, a low noise amplifier (Low Noise Amplifier, LNA), and the like. The mobile communications module 150 may receive an electromagnetic wave through the antenna 1, perform processing such as filtering or amplification on the received electromagnetic wave, and transmit the electromagnetic wave to the modem processor for demodulation. The mobile communications module 150 may further amplify a signal modulated by the modem processor, and convert the signal into an electromagnetic wave for radiation by using the antenna 1. In some embodiments, at least some function modules in the mobile communications module 150 may be disposed in the processor 110. In some embodiments, at least some function modules in the mobile communications module 150 may be disposed in a same device as at least some modules in the processor 110.

The modem processor may include a modulator and a demodulator. The modulator is configured to modulate a to-be-sent low-frequency baseband signal into a medium or high-frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal by using an audio device (which is not limited to the speaker 170A, the receiver 170B, or the like), or displays an image or a video by using the display 194. In some embodiments, the modem processor may be an independent component. In some other embodiments, the modem processor may be independent of the processor 110, and is disposed in a same device as the mobile communications module 150 or another function module.

The wireless communications module 160 may provide a solution, applied to the electronic device 100, to wireless communication including a wireless local area network (wireless local area networks, WLAN), Bluetooth (Bluetooth, BT), a global navigation satellite system (global navigation satellite system, GNSS), frequency modulation (frequency modulation, FM), near field communication (near field communication. NFC), infrared (infrared, IR) technology, and the like. The wireless communications module 160 may be one or more components integrating at least one communications processor module. The wireless communications module 160 receives an electromagnetic wave through the antenna 2, performs frequency modulation and filtering processing on an electromagnetic wave signal, and sends a processed signal to the processor. The wireless communications module 160 may further receive a to-be-sent signal from the processor, perform frequency modulation and amplification on the signal, and convert the signal into an electromagnetic wave for radiation by using the antenna 2.

In some embodiments, the antenna 1 and the mobile communications module 150 of the electronic device 100 are coupled, and the antenna 2 and the wireless communications module 160 are coupled, so that the electronic device 100 can communicate with a network and another device by using a wireless communications technology. The wireless communications technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (beidou navigation satellite system, BDS), a quasi-zenith satellite system (quasi-zenith satellite system, QZSS), and/or a satellite based augmentation system (satellite based augmentation systems, SBAS).

The electronic device 100 implements a display function by using the GPU, the display 194, the application processor, and the like. The GPU is a microprocessor for image processing, and connects the display 194 to the application processor. The GPU is configured to: perform mathematical and geometric computation, and render an image. The processor 110 may include one or more GPUs, which execute a program instruction to generate or change display information.

The display 194 is configured to display an image, a graphical user interface (graphical user interface, GUI), a video, or the like. The display 194 includes a display panel. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flex light-emitting diode, FLED), a MiniLED, a MicroLED, a micro-oLED, a quantum dot light emitting diode (quantum dot light emitting diodes, QLED), or the like. In some embodiments, the electronic device 100 may include one or N displays, where N is a positive integer greater than 1.

The electronic device 100 may implement a photographing function by using the ISP, the camera 193, the video codec, the GPU, the display 194, the application processor, and the like.

The ISP is configured to process data fed back by the camera. For example, during photographing, a shutter is pressed, a ray of light is transmitted to a light-sensitive element of a camera through a lens, and an optical signal is converted into an electrical signal. The light-sensitive element of the camera transmits the electrical signal to the ISP for processing, and converts the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected to the light-sensitive element. The light-sensitive element may be a charge coupled device (charge coupled device, CCD) or a complementary metal-oxide-semiconductor (complementary metal-oxide-semiconductor, CMOS) phototransistor. The light-sensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 100 may include one or N camera 193, where N is a positive integer greater than 1.

The digital signal processor is configured to process a digital signal. In addition to a digital image signal, the digital signal processor may further process another digital signal. For example, when the electronic device 100 selects a frequency, the digital signal processor is configured to perform Fourier transform on frequency energy and the like.

The video codec is configured to compress or decompress a digital video. The electronic device 100 may support one or more video codecs. In this way, the electronic device 100 may play back or record videos in a plurality of coding formats, for example, MPEG1, MPEG2, MPEG3, and MPEG4.

The NPU is a neural-network (neural-network, NN) computing processor, quickly processes input information by referring to a structure of a biological neural network, for example, by referring to a transfer mode between human brain neurons, and may further continuously perform self-learning. Applications such as intelligent cognition of the electronic device 100 may be implemented by using the NPU, for example, image recognition, facial recognition, speech recognition, and text understanding.

The external memory interface 120 may be configured to connect to an external memory card, for example, a micro SD card, to extend a storage capability of the electronic device 100. The external memory card communicates with the processor 110 through the external memory interface 120, to implement a data storage function. For example, files such as music and a video are stored in the external memory card.

The internal memory 121 may be configured to store computer-executable program code, and the computer-executable program code includes an instruction. The processor 110 may run the foregoing instruction stored in the internal memory 121, to perform various function applications and data processing of the electronic device 100. The internal memory 121 may include a program storage area and a data storage area. The program storage area may store an operating system, an application required by at least one function (for example, a voice playing function or an image playing function), and the like. The data storage area may store data (such as audio data and an address book) created during use of the electronic device 100, and the like. In addition, the internal memory 121 may include a high-speed random access memory, and may further include a nonvolatile memory such as at least one disk storage device, a flash memory, or a universal flash storage (universal flash storage, UFS).

The electronic device 100 may implement an audio function, for example, music playback and recording, by using the audio module 170, the speaker 170A, the receiver 170B, the microphone 170C, the headset jack 170D, the application processor, and the like.

The audio module 170 is configured to convert digital audio information into an analog audio signal output, and is also configured to convert an analog audio input into a digital audio signal. The audio module 170 may be further configured to code and decode an audio signal. In some embodiments, the audio module 170 may be disposed in the processor 110, or some function modules in the audio module 170 are disposed in the processor 110.

The speaker 170A, also referred to as a “horn”, is configured to convert an audio electrical signal into a sound signal. The electronic device 100 may be used to listen to music or answer a call in a hands-free mode over the speaker 170A.

The receiver 170B, also referred to as an “earpiece”, is configured to convert an audio electrical signal into a sound signal. When a call is answered or audio information is listened to by using the electronic device 100, the receiver 170B may be put close to a human ear to listen to a voice.

The microphone 170C, also referred to as a “mike” or a “microphone”, is configured to convert a sound signal into an electrical signal. When making a call or sending a voice message, a user may make a sound near the microphone 170C through the mouth of the user, to input a sound signal to the microphone 170C. At least one microphone 170C may be disposed in the electronic device 100. In some other embodiments, two microphones may be disposed in the electronic device 100, to collect a sound signal and implement a noise reduction function. In some other embodiments, three, four, or more microphones may alternatively be disposed in the electronic device 100, to collect a sound signal, implement noise reduction, and identify a sound source, so as to implement a directional recording function, and the like.

The headset jack 170D is configured to connect to a wired headset. The headset jack may be a USB interface, or may be a 3.5 mm open mobile terminal platform (open mobile terminal platform. OMTP) standard interface or cellular telecommunications industry association of the USA (cellular telecommunications industry association of the USA, CTIA) standard interface.

The pressure sensor 180A is configured to sense a pressure signal, and can convert the pressure signal into an electrical signal. In some embodiments, the pressure sensor 180A may be disposed on the display 194. There are many types of pressure sensors 180A, for example, a resistive pressure sensor, an inductive pressure sensor, and a capacitive pressure sensor. The capacitive pressure sensor may include at least two parallel plates made of conductive materials. When a force is applied to the pressure sensor 180A, capacitance between electrodes changes. The electronic device 100 determines pressure intensity based on the change in the capacitance. When a touch operation is performed on the display 194, the electronic device 100 detects intensity of the touch operation by using the pressure sensor 180A. The electronic device 100 may also calculate a touch location based on a detection signal of the pressure sensor 180A. In some embodiments, touch operations that are performed at a same touch location but have different touch operation intensity may correspond to different operation instructions. For example, when a touch operation whose touch operation intensity is less than a first pressure threshold is performed on a messaging application icon, an instruction for viewing an SMS message is performed. When a touch operation whose touch operation intensity is greater than or equal to the first pressure threshold is performed on the messaging application icon, an instruction for creating a new SMS message is performed.

The gyro sensor 180B may be configured to determine a moving posture of the electronic device 100. In some embodiments, an angular velocity of the electronic device 100 around three axes (namely, axes x, y, and z) may be determined by using the gyro sensor 180B. The gyro sensor 180B may be configured to implement image stabilization during photographing. For example, when the shutter is pressed, the gyro sensor 180B detects an angle at which the electronic device R) jitters, calculates, based on the angle, a distance for which a lens module needs to compensate, and allows the lens to cancel the jitter of the electronic device 100 through reverse motion, to implement image stabilization. The gyro sensor 180B may also be used in a navigation scenario and a somatic game scenario.

The barometric pressure sensor 180C is configured to measure barometric pressure. In some embodiments, the electronic device 100 calculates an altitude by using the barometric pressure measured by the barometric pressure sensor 180C, to assist in positioning and navigation.

The magnetic sensor 180D includes a Hall sensor. The electronic device 100 may detect opening and closing of a flip leather case by using the magnetic sensor 180D. In some embodiments, when the electronic device 100 is a clamshell phone, the electronic device 100 may detect opening and closing of a flip cover based on the magnetic sensor 180D. Further, a feature such as automatic unlocking of the flip cover is set based on a detected opening or closing state of the leather case or a detected opening or closing state of the flip cover.

The acceleration sensor 180E may detect magnitude of accelerations in various directions (usually on three axes) of the electronic device 100, and may detect magnitude and a direction of the gravity when the electronic device 100 is still. The acceleration sensor 180E may be further configured to recognize a posture of the electronic device, and is applied to an application such as switching between landscape mode and portrait mode or a pedometer.

The distance sensor 180F is configured to measure a distance. The electronic device 100 may measure the distance in an infrared or a laser manner. In some embodiments, in a photographing scenario, the electronic device 100 may measure a distance by using the distance sensor to implement quick focusing.

The optical proximity sensor 180G may include, for example, a light emitting diode (light emitting diode, LED) and an optical detector, for example, a photodiode. The light emitting diode may be an infrared light emitting diode. The electronic device 100 emits infrared light by using the light emitting diode. The electronic device 100 detects infrared reflected light from a nearby object by using the photodiode. When detecting sufficient reflected light, the electronic device 100 may be determined that there is an object near the electronic device 100. When insufficient reflected light is detected, the electronic device 100 may determine that there is no object near the electronic device 100. The electronic device 100 may detect, by using the optical proximity sensor, that the user holds the electronic device 100 close to an ear to make a call, to automatically perform screen-off for power saving. The optical proximity sensor may also be used in a smart cover mode or a pocket mode to automatically perform screen unlocking or locking.

The ambient light sensor 180L is configured to sense ambient light brightness. The electronic device 100 may adaptively adjust brightness of the display based on the sensed ambient light brightness. The ambient light sensor may also be configured to automatically adjust white balance during photographing. The ambient light sensor may also cooperate with the optical proximity sensor to detect whether the electronic device 100 is in a pocket, to avoid an accidental touch.

The fingerprint sensor 180H is configured to collect a fingerprint. The electronic device 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the electronic device 100 executes a temperature processing policy by using the temperature detected by the temperature sensor 180J. For example, when the temperature reported by the temperature sensor 180J exceeds a threshold, the electronic device 100 lowers performance of a processor nearby the temperature sensor 180J, to reduce power consumption for thermal protection. In some other embodiments, when the temperature is lower than another threshold, the electronic device 100 heats the battery 142 to prevent the electronic device 100 from being shut down abnormally because of a low temperature. In some other embodiments, when the temperature is lower than still another threshold, the electronic device 100 boosts an output voltage of the battery 142 to avoid abnormal shutdown caused by a low temperature.

The touch sensor 180K, also be referred to as a “touch panel”, may be disposed on the display 194. The touch sensor 180K is configured to detect a touch operation on or near the touch sensor 180K. The touch sensor 180K may transfer the detected touch operation to the application processor, to determine a type of the touch event, and to provide corresponding visual output by using the display. In some other embodiments, the touch sensor 180K may also be disposed on a surface of the electronic device 100 at a location different from that of the display 194. A combination of the touch panel and the display 194 may be referred to as a touchscreen.

The bone conduction sensor 180M may obtain a vibration signal. In some embodiments, the bone conduction sensor 180M may obtain a vibration signal of a vibration bone of a human vocal-cord part. The bone conduction sensor 180M may also contact a body pulse to receive a blood pressure beating signal. In some embodiments, the bone conduction sensor 180M may also be disposed in the headset. The audio module 170 may obtain a speech signal through parsing based on the vibration signal that is of the vibration bone of the vocal-cord part and that is obtained by the bone conduction sensor 180M, to implement a speech function. The application processor may parse heart rate information based on the blood pressure beating signal obtained by the bone conduction sensor 180M, to implement a heart rate detection function.

The button 190 includes a power button, a volume button, and the like. The button 190 may be a mechanical button, or may be a touch button. The electronic device 100 may receive a key input, and generate a key signal input related to a user setting and function control of the electronic device 100.

The motor 191 may generate a vibration prompt. The motor 191 may be configured to provide an incoming call vibration prompt and a touch vibration feedback. For example, touch operations performed on different applications (for example, photographing and audio playback) may correspond to different vibration feedback effects. The motor 191 may also correspond to different vibration feedback effects for touch operations performed on different areas of the display. Different application scenarios (for example, a time reminder, information receiving, an alarm clock, and a game) may also correspond to different vibration feedback effects. A touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect to a subscriber identity module (subscriber identity module, SIM). The SIM card may be inserted into the SIM card interface or detached from the SIM card interface 195, to implement contact with or separation from the electronic device 100. The electronic device 100 may support one or N SIM card interfaces 195, where N is a positive integer greater than 1. The SIM card interface 195 may support a nano-SIM card, a micro-SIM card, a SIM card, and the like. A plurality of cards may be inserted into a same SIM card interface 195 at the same time. The plurality of cards may be of a same type or different types. The SIM card interface 195 may be compatible with different types of SIM cards. The SIM card interface may further be compatible with an external memory card. The electronic device 100 interacts with a network by using the SIM card, to implement functions such as conversation and data communication. In some embodiments, the electronic device 100 uses an eSIM, namely, an embedded SIM card. The eSIM card may be embedded into the electronic device 100, and cannot be separated from the electronic device 100.

A software system of the electronic device 100 may use a layered architecture, an event-driven architecture, a microkernel architecture, a micro service architecture, or a cloud architecture. In this embodiment of this application, an Android system of a layered architecture is used as an example to illustrate a software structure of the electronic device 100.

In the layered architecture, software is divided into several layers, and each layer has a clear role and task. The layers communicate with each other through a software interface. In some embodiments, the Android system is divided into four layers: an application layer, an application framework layer, an Android runtime (Android runtime) and system library, and a kernel layer from top to bottom.

The application layer may include a series of application packages.

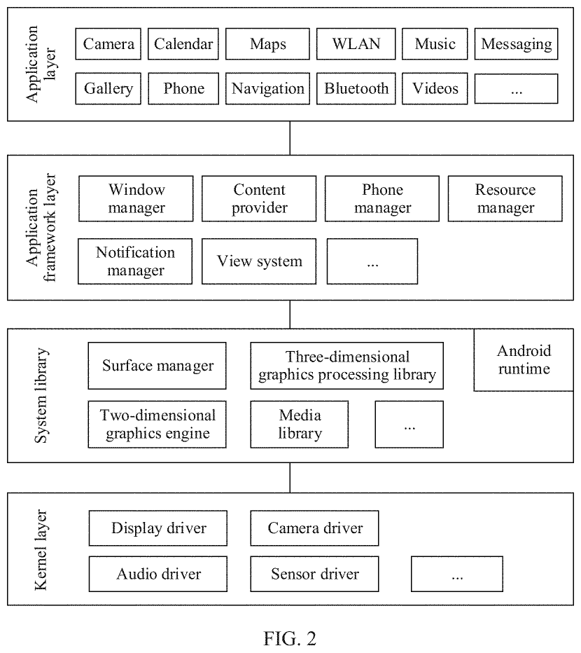

As shown in FIG. 2, the application package may include applications such as “camera”, “gallery”, “calendar”, “calls”, “maps”, “navigation”, “WLAN”, “Bluetooth”, “music”, “videos”, and “messaging”.

The application framework layer provides an application programming interface (application programming interface, API) and a programming framework for an application at the application layer. The application framework layer includes some predefined functions.

As shown in FIG. 2, the application framework layer may include a window manager, a content provider, a view system, a phone manager, a resource manager, a notification manager, and the like.

The window manager is configured to manage a window program. The window manager may obtain a size of the display, determine whether there is a status bar, perform screen locking, take a screenshot, and the like.

The content provider is configured to: store and obtain data, and enable the data to be accessed by an application. The data may include a video, an image, an audio, calls that are made and received, a browsing history and bookmarks, an address book, and the like.

The view system includes visual controls such as a control for displaying a character and a control for displaying a picture. The view system may be configured to construct an application. A display interface may include one or more views. For example, a display interface including an SMS message notification icon may include a character display view and a picture display view.

The phone manager is configured to provide a communication function for the terminal 100, for example, management of a call status (including answering or declining).

The resource manager provides various resources such as a localized character string, an icon, an image, a layout file, and a video file for an application.

The notification manager enables an application to display notification information in a status bar, and may be configured to convey a notification message. The notification manager may automatically disappear after a short pause without requiring a user interaction. For example, the notification manager is configured to notify download completion, give a message notification, and the like. The notification manager may be a notification that appears in a top status bar of the system in a form of a graph or a scroll bar text, for example, a notification of an application running on the background, or may be a notification that appears on the interface in a form of a dialog window. For example, text information is displayed in the status bar, an alert sound is played, the electronic device vibrates, or the indicator light blinks.

The Android runtime includes a core library and a virtual machine. The Android runtime is responsible for scheduling and management of the Android system.

The core library includes two parts: a function that needs to be invoked in java language, and a core library of Android.

The application layer and the application framework layer run on the virtual machine. The virtual machine executes java files of the application layer and the application framework layer as binary files. The virtual machine is configured to implement functions such as object lifecycle management, stack management, thread management, security and exception management, and garbage collection.

The system library may include a plurality of function modules, for example, a surface manager (surface manager), a media library (Media Libraries), a three-dimensional graphics processing library (for example, OpenGL ES), and a 2D graphics engine SGL.

The surface manager is configured to manage a display subsystem and provide fusion of 2D and 3D layers for a plurality of applications.

The media library supports playback and recording in a plurality of commonly used audio and video formats, and static image files. The media library may support a plurality of audio and video coding formats such as MPEG4. H.264. MP3, AAC, AMR, JPG, and PNG.

OpenGL ES is configured to implement three-dimensional graphics drawing, image rendering, composition, layer processing, and the like.

The SGL is a drawing engine for 2D drawing.

The kernel layer is a layer between hardware and software. The kernel layer includes at least a display driver, a camera driver, an audio driver, and a sensor driver.

All the following embodiments may be implemented by an electronic device having the hardware structure shown in FIG. 1 and the software structure shown in FIG. 2.

For ease of description, the graphical user interface is briefly referred to as an interface below.

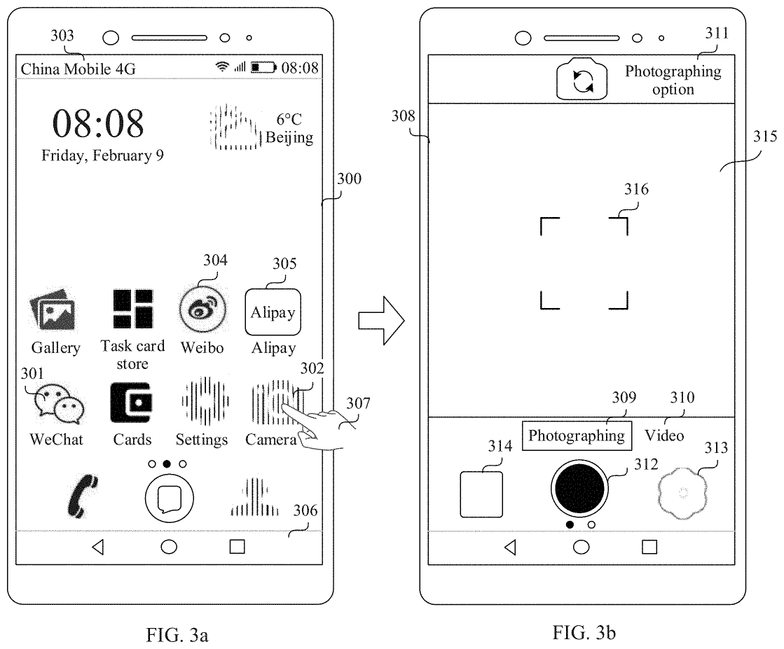

FIG. 3a shows an interface 300 displayed on a touchscreen of an electronic device 100 having a specific hardware structure shown in FIG. 1 and a software structure shown in FIG. 2. The touchscreen includes the display 194 and the touch panel. The interface is configured to display a control. The control is a GUI element, and is also a software component. The control is included in an application, and controls data processed by the application and an interaction operation on the data. A user may interact with the control through direct manipulation (direct manipulation), to read or edit related information of the application. Usually, controls may include visual interface elements such as an icon, a button, a menu, a tab, a text box, a dialog box, a status bar, a navigation bar, and a widget.

As shown in FIG. 3a, the interface 300 may include a status bar 303, a collapsible navigation bar 306, a time widget, a weather widget, and icons of a plurality of applications such as a Weibo icon 304, an Alipay icon 305, a camera icon 302, and a WeChat icon 301. The status bar 303 may include a name of an operator (for example, China Mobile), time, a wireless fidelity (wireless-fidelity, Wi-Fi) icon, signal strength, and a current remaining quantity of electricity. The navigation bar 306 may include a back (back) button icon, a home screen button icon, a forward button icon, and the like. In addition, it may be understood that in some other embodiments, the status bar 303 may further include a Bluetooth icon, a mobile network (for example, 4G) icon, an alarm clock icon, an external device icon, and the like. It may be further understood that, in some other embodiments, the interface 300 may further include a dock bar, and the dock bar may include an icon of a common application (application, App) and the like.

In some other embodiments, the electronic device 100 may further include a home screen button. The home screen button may be a physical button, or may be a virtual button (or referred to as a soft button). The home screen button is configured to return, based on an operation of the user, to a home screen from a GUI displayed on the touchscreen, so that the user can conveniently view the home screen and perform an operation on a control (for example, an icon) on the home screen at any time. The operation may be specifically that the user presses the home screen button, or the user presses the home screen button twice in a short time period, or the user presses and holds the home screen button. In some other embodiments of this application, the home screen button may be further integrated with a fingerprint sensor 302. In this way, when the user presses the home screen button, the electronic device may collect a fingerprint to confirm an identity of the user.

After the electronic device 100 detects a touch operation performed by a finger (or a stylus, or the like) of the user on an app icon on the interface 300, in response to the touch operation, the electronic device may open a user interface of an app corresponding to the app icon. For example, after detecting an operation of touching the camera icon 302 by the finger of the user, the electronic device opens a camera application in response to the operation of touching the camera icon 302 by the finger 307 of the user, to enter a photographing preview interface. For example, the preview interface displayed by the electronic device may be specifically a preview interface 308 shown in FIG. 3b.

A working process of software and hardware of the electronic device 100 is described by using an example with reference to a photographing scenario. When the touch sensor 180K receives a touch operation, a corresponding hardware interruption is sent to the kernel layer. The kernel layer processes the touch operation into a raw input operation (including information such as touch coordinates and a time stamp of the touch operation). The raw input operation is stored at the kernel layer. The application framework layer obtains the raw input operation from the kernel layer, and identifies a control corresponding to the raw input operation. For example, the touch operation is a single-tap operation, and a control corresponding to the single-tap operation is an icon of a camera application. The camera application invokes an interface at the application framework layer to enable the camera application, then enables a camera driver by invoking the kernel layer, and captures a static image or a video by using the camera 193.

As shown in FIG. 3b, the preview interface 308 may include one or more of controls such as a photographing mode control 309, a video recording mode control 310, a shooting option control 311, a photographing button 312, a hue style control 313, a thumbnail box 314, a preview box 315, and a focus box 316. The photographing mode control 310 is configured to enable the electronic device to enter a photographing mode, namely, a picture shooting mode. The video recording mode control 310 is configured to enable the electronic device 100 to enter a video shooting mode. As shown in FIG. 3b, if the electronic device 100 is currently in the photographing mode, the preview interface 308 is a photographing preview interface. The shooting option control 311 is configured to set a specific shooting mode in the photographing mode or a video recording mode, for example, an age prediction mode, a professional photographing mode, a beautification mode, a panorama mode, an audio photo mode, a time-lapse mode, a night mode, a single-lens reflex mode, a smile snapshot mode, a light painting mode, or a watermark mode. The photographing button 312 is configured to trigger the electronic device 100 to shoot a picture in a current preview box, or is configured to trigger the electronic device 100 to start or stop video shooting. The hue style control 313 is configured to set a style of the to-be-shot picture, for example, clearness, enthusiasm, scorching, classicality, sunrise, movie, dreamland, or black and white. The thumbnail box 314 is configured to display a thumbnail of a recently shot picture or recorded video. The preview box 315 is configured to display a preview object. The focus box 316 is configured to indicate whether a current state is a focus state.

In a conventional photographing mode, in a preview scenario, after the electronic device detects an operation of tapping the shooting button 312 by the user, the camera 193 of the electronic device 100 collects a preview image of a preview object. The preview image is an original image, and a format of the original image may be a RAW format. The preview image is also referred to as a RAW image, is original image data output by a light-sensitive element (or referred to as an image sensor) of the camera 193. Then, the electronic device 100 performs processing such as automatic exposure control, black level correction (black level correction, BLC), lens shading correction, automatic white balance, color matrix correction, and definition and noise adjustment on the original image by using the ISP, to generate a picture seen by the user, and stores the picture. After obtaining a picture through photographing, the electronic device 100 may further recognize a character (characters) in the picture when the user needs to obtain the character in the picture.

For example, in a conventional classification and recognition method, a shot picture is preprocessed to remove color, saturation, noise, and the like from the picture and deformation of a text in aspects such as a size, a location, and a shape is processed. Preprocessing may be understood as some inverse processes including processing performed by the ISP on the original image, such as balancing and color processing. Preprocessed data has a large quantity of dimensions. Usually, the quantity of dimensions can reach tens of thousands. Then, feature extraction is performed to compress text image data and reflect essence of the original image. Then, in feature space, a recognized object is classified into a specified category in a statistical decision method or a syntax analysis method, so as to obtain a text recognition result.

In another conventional character recognition method, the electronic device 100 may perform an operation on a feature of a character in an obtained picture and a standard feature of a character by using a classifier or a clustering policy in machine learning, to determine a character result based on a similarity.

In another conventional character recognition method, the electronic device 100 may further perform character recognition on a character in a picture by using a genetic algorithm and a neural network.

The following describes, by using an example in which the electronic device 100 is a mobile phone, the method for displaying a personalized function of a text image provided in the embodiments of this application.

An embodiment of this application provides a method for displaying a personalized function of a text image, to display a text function of a text object in a photographing preview state.

After the electronic device enables a camera function and displays a photographing preview interface, the electronic device enters a photographing preview state. In the photographing preview state, a preview object of the electronic device may include a scene object, a figure object, a text object, and the like. The text object is an object on which a character (character) is presented, for example, a newspaper, a poster, a leaflet, a book page, or a piece of paper, a blackboard, a curtain, or a wall on which a character is written, a touchscreen on which a character is displayed, or any other entity on which a character is presented. Characters in the text object may include characters of various countries, for example, a Chinese character, an English character, a Russian character, a German character, a French character, and a Japanese character, and may further include a number, a letter, a symbol, and the like. The following embodiments of this application are mainly described by using an example in which the character is a Chinese character. It may be understood that content presented in the text object may include other content in addition to the character, for example, may further include a picture.

In some embodiments of this application, in the photographing preview state, if the electronic device determines that the preview object is a text object, the electronic device may display a text function for the text object in the photographing preview state.

In the photographing preview state, the electronic device may collect a preview image of the preview object. The preview image is an original image in a RAW format, and is original image data that is not processed by an ISP. The electronic device determines, based on the collected preview image, whether the preview object is a text object. That the electronic device determines, based on the preview image, whether the preview object is a text object may include: If the electronic device determines that the preview image includes a character, the electronic device may determine that the preview object is a text object; if the electronic device determines that a quantity of characters included in the preview image is greater than or equal to a first preset value, the electronic device may determine that the preview object is a text object; if the electronic device determines that an area covered by a character in the preview image is greater than or equal to a second preset value, the electronic device may determine that the preview object is a text object; if the electronic device determines, based on the preview image, that the preview object is an object such as a newspaper, a book page, or a piece of paper, the electronic device may determine that the preview object is a text object; or if the electronic device sends the preview image to a server, and receives, from the server, indication information indicating that the preview object is a text object, the electronic device may determine that the preview object is a text object. It may be understood that in this application, a method for determining whether the preview object is a text object includes but is not limited to the foregoing manners.

For example, when a user sees a recruitment announcement in a newspaper, or on a leaflet, a bulletin panel, a wall, a computer, or the like, the user may enable the camera function of the mobile phone, to display a photographing preview interface shown in FIG. 3b. In this case, the user may preview the recruitment announcement through the mobile phone in the photographing preview state, and the recruitment announcement is a text object.

For another example, when the user sees a piece of news in a newspaper or on a computer, the user may enable the camera function of the mobile phone, to display a photographing preview interface shown in FIG. 3b. In this case, the user may preview the newspaper or the news on the computer through the mobile phone in the photo preview state, and the news in the newspaper or on the computer is a text object.

For another example, when the user sees a poster including a character in a place such as a shopping center, a cinema, or an amusement park, the user may enable the camera function of the mobile phone, to display a photographing preview interface shown in FIG. 3b. In this case, the user may preview the poster through the mobile phone in the photographing preview state, and the poster is a text object.

For another example, when the user sees “tour strategy” or “introduction to attractions” on a bulletin board in a park or a tourist destination, the user may enable the camera function of the mobile phone, to display a photographing preview interface shown in FIG. 3b. In this case, the user may view “tour strategy” or “introduction to attractions” on a preview bulletin board through the mobile phone in the photographing preview state, and “tour strategy” or “introduction to attractions” on the bulletin board is a text object.

For another example, when the user sees a novel “The Little Prince” on a book, the user may enable the camera function of the mobile phone, to display a photographing preview interface shown in FIG. 3b. In this case, the user may preview content of the novel “The Little Prince” through the mobile phone in the photographing preview state, and a page of the novel “The Little Prince” is a text object.

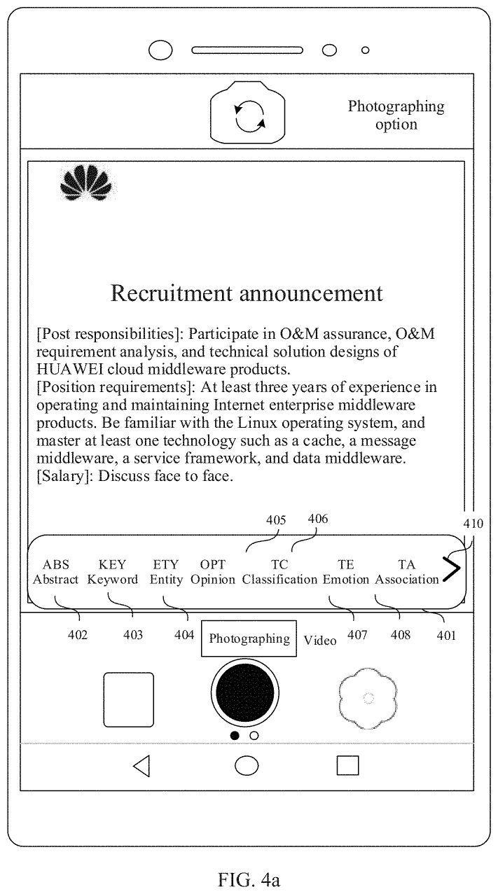

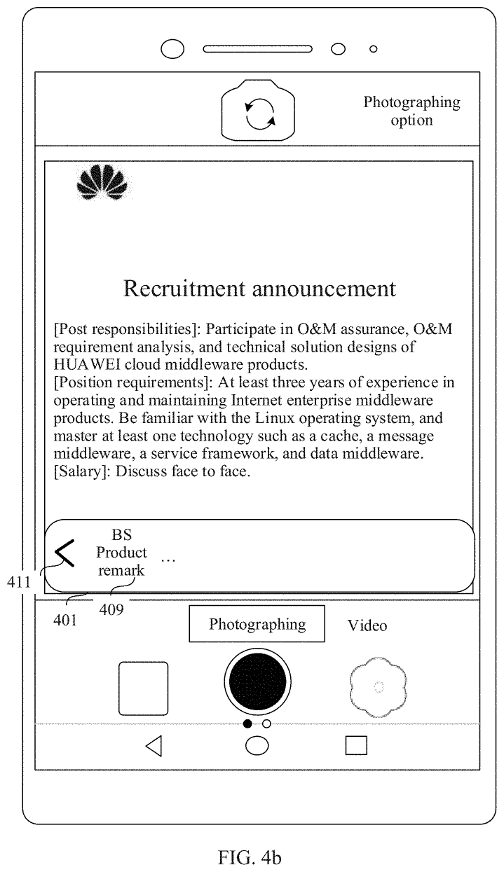

If the electronic device determines that the preview object is a text object, as shown in FIG. 4a, the electronic device may automatically display a function list 401. The function list 401 may include function options of at least one preset text function. The function option may be used to correspondingly process a character in the text object, so that the electronic device displays service information associated with character content in the text object, and converts unstructured character content in the text object into structured character content, so as to reduce an information amount, reduce time spent by the user in reading a large amount of character information in the text object, help the user read a small amount of information that the user cares most, and facilitate reading and information management of the user.

As shown in FIG. 4a, the function list 401 may include function options such as an abstract (abstract, ABS) option 402, a keyword (KEY) option 403, an entity (entity, ETY) option 404, an opinion (Option, OPT) option 405, a classification (text classification, TC) option 406, an emotion (text emotion, TE) option 407, and an association (text association, TA) option 408.

It should be noted that the function options included in the function list 401 shown in FIG. 4a are merely examples for description, and the function list may further include another function option, for example, a product remark (product remark, PR) option. In addition, the function list may further include a previous-page control and/or a next-page control, configured to switch between the function options in the function list for displaying. For example, as shown in FIG. 4a, the function list 401 includes a next-page control 410. When the electronic device detects that the user taps the next-page control 410 on an interface shown in FIG. 4a, as shown in FIG. 4b, the electronic device displays, in the function list 401, another function option that is not displayed in FIG. 4a, for example, displays the product remark option 409. As shown in FIG. 4b, the function list 401 includes a previous-page control 411. When the electronic device detects that the user taps the previous-page control 411 on an interface shown in FIG. 4b, the electronic device displays the function list 401 shown in FIG. 4a.

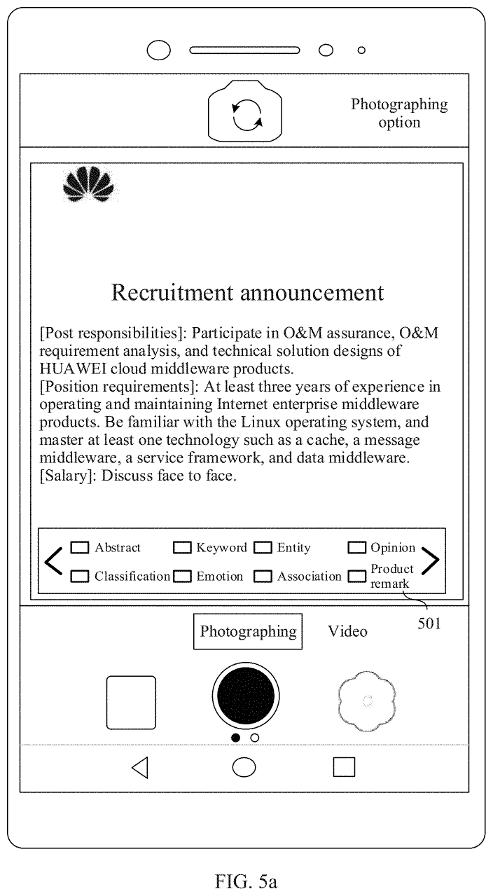

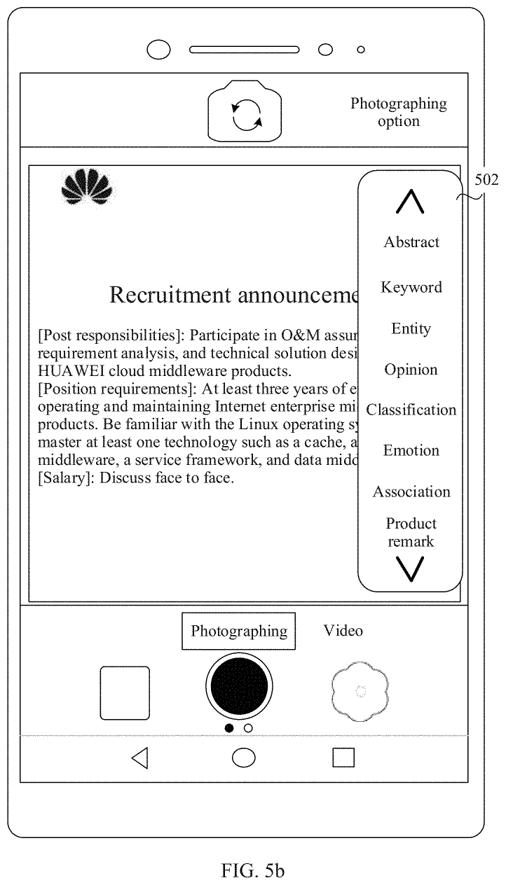

It may be understood that the function list 401 shown in FIG. 4a is merely an example for description. The function list may alternatively be in another form, or may be located in another position. For example, in an alternative solution of the function list 401 in FIG. 4a, the function list provided in this embodiment of this application may alternatively be a function list 501 shown in FIG. 5a or a function list 502 shown in FIG. 5b.

When one or more target function options in the function list are selected, the electronic device may display a function area. The function area is used to display service information of the selected target function option.

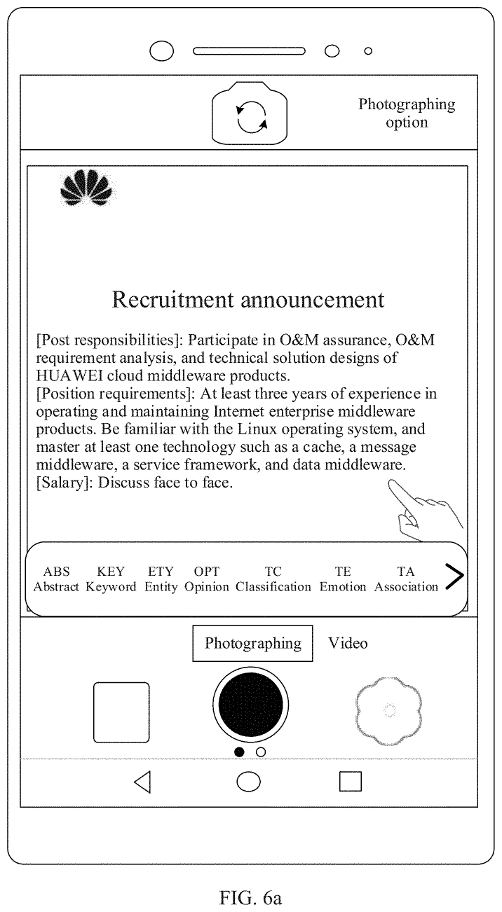

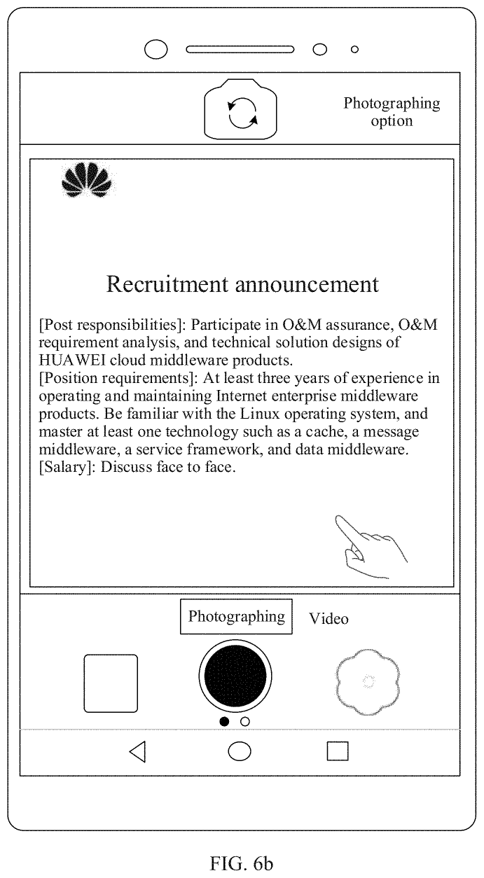

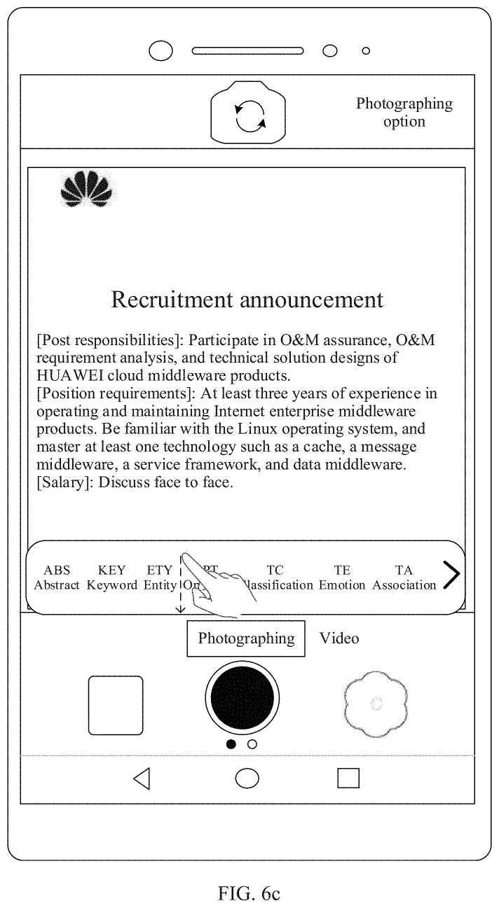

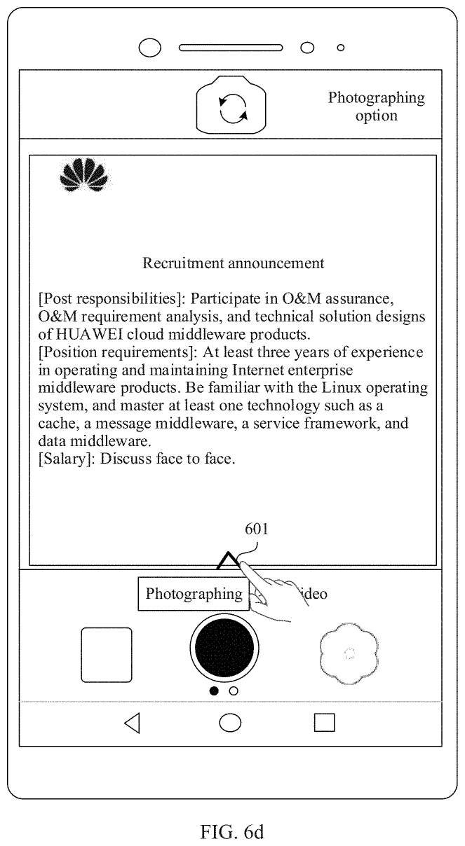

In one case, as shown in FIG. 4a to FIG. 5b, when the electronic device opens the preview interface, the function list is displayed on the preview interface, and all text functions in the function list are in an unselected state. In addition, in response to a first operation of the user, the function list displayed on the preview interface may be hidden. For example, referring to FIG. 6a, after the electronic device detects a tapping operation (namely, the first operation) performed by the user outside the function list and inside the preview box, as shown in FIG. 6b, the electronic device may hide the function list; and after the electronic device detects again the tapping operation performed by the user inside the preview box shown in FIG. 6b, the electronic device may resume displaying the function list shown in FIG. 4a in the preview box. For another example, as shown in FIG. 6c, when the electronic device detects an operation (namely, the first operation), performed by the user, of pressing and holding the function list and swiping downward, as shown in FIG. 6d, the electronic device may hide the function list and display a resume tag 601. When the user taps the resume tag 601 or presses and holds the resume tag 601 and swipes upward, the electronic device resumes displaying the function list shown in FIG. 4a. Alternatively, in a case shown in FIG. 6c, the electronic device hides the function list. After detecting an operation of swiping upward from the bottom of the preview box, the electronic device may resume displaying the function list shown in FIG. 4a.

When the electronic device displays the function list, after the electronic device detects that the user selects (for example, the user manually selects by using a gesture or by entering a voice) one or more target function options in the function list, the electronic device displays a function area, and displays, in the function area, service information of the target function option selected by the user.

In another case, when the electronic device opens the preview interface, the function list and a function area are displayed on the preview interface. A target function option in the function list is selected, and the selected target function option may be a function option selected by the user last time, or may be a default function option (for example, an abstract). Service information of the selected function option is displayed in the function area.

Specifically, a process in which the electronic device obtains and displays the service information of the target function option may include: The electronic device processes the target function option based on the text object, to obtain the service information of the target function option, and displays the service information of the target function option in the function area; or the electronic device requests the server to process the target function option, obtains the service information of the target function option from the server to save resources of the electronic device, and the electronic device displays the service information of the target function option in the function area.

In the following embodiments of this application, the function list 401 shown in FIG. 4a and the function options included in the function list 401 are used as an example to describe each function option in detail.

(1) Abstract Function

The abstract function may briefly summarize described character content of a text object, so that original redundant and complex character content becomes clear and brief.

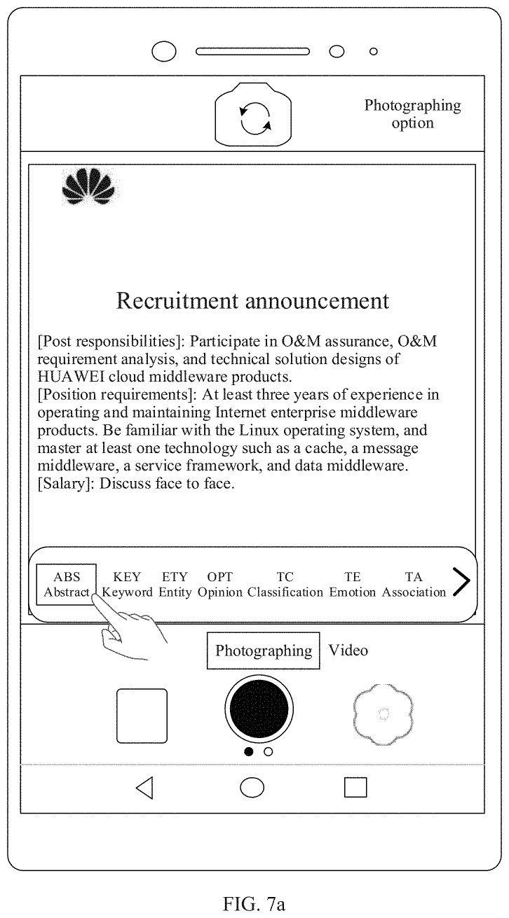

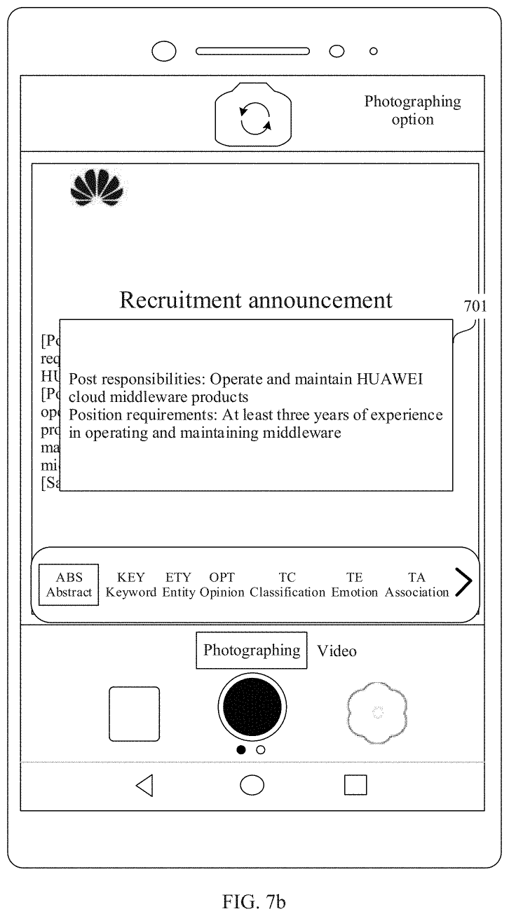

For example, as shown in FIG. 7a, the text object is the foregoing recruitment announcement previewed on the preview interface. When the electronic device detects that the user selects an abstract function option from the function list, as shown in FIG. 7b, the electronic device displays a function area 701, and an abstract of the recruitment announcement is shown in the function area 701. Alternatively, for example, the text object is the recruitment announcement previewed on the preview interface. When the electronic device opens the preview interface, as shown in FIG. 7b, a function list and a function area are displayed on the preview interface, an abstract function option in the function list is selected by default, and an abstract of the recruitment announcement is displayed in the function area 701. It may be understood that the displayed abstract may be content that is related to the text object and that is obtained by the electronic device by using a network side, or may be content generated by the electronic device based on an understanding of the text object through artificial intelligence.

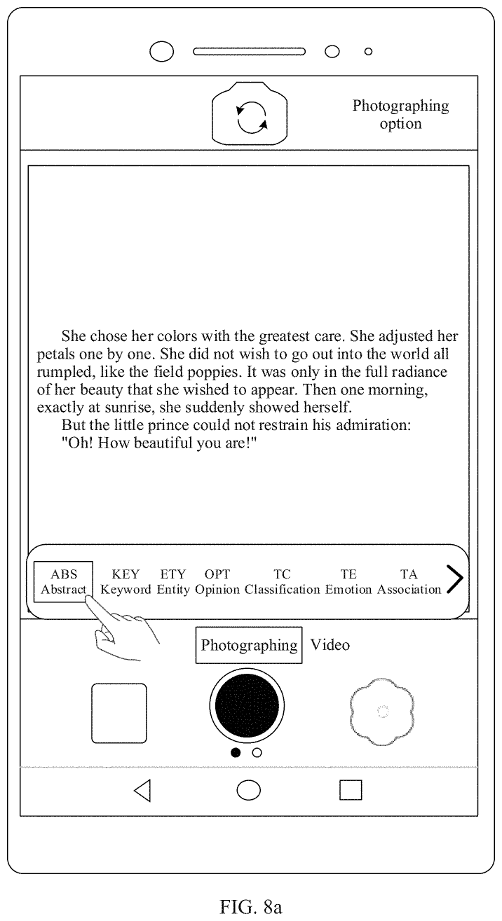

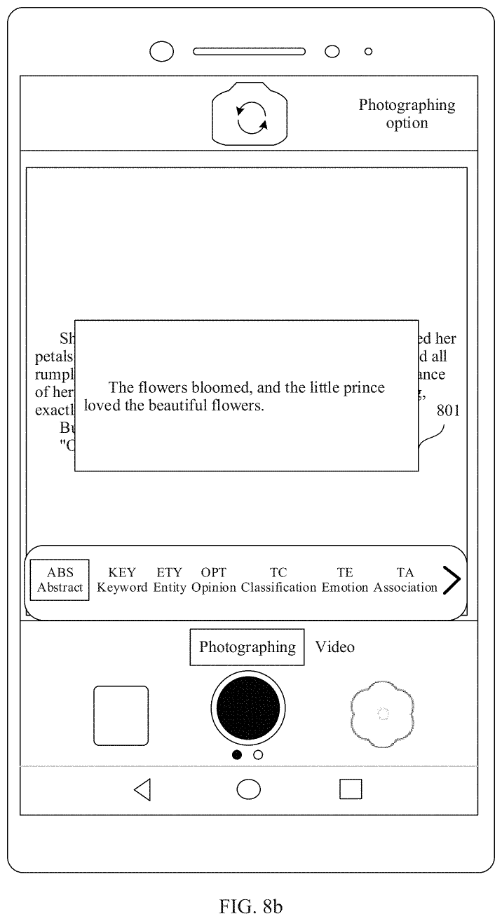

For another example, as shown in FIG. 8a, the text object is an excerpt from the novel “The Little Prince” previewed on the preview interface. When the electronic device detects that the user selects an abstract function option from a function list, as shown in FIG. 8b, the electronic device displays a function area 801, and an abstract of the excerpt is shown in the function area 801. Alternatively, for example, the text object is the excerpt from the novel “The Little Prince” previewed on the preview interface. When the electronic device opens the preview interface, as shown in FIG. 8b, a function list and a function area 801 are displayed on the preview interface, an abstract function option in the function list is selected by default, and an abstract of the excerpt is displayed in the function area 801.

In a scenario, when there is a relatively large amount of to-be-read character information, and the user wants to find and record important information that the user cares about, because the user cannot quickly read all content at once, the user usually shoots a picture of all characters, and then the user reads pictures one by one to search for a picture in which important information that the user cares about is located. This process is relatively complex and consumes a lot of time. In addition, most of the shot pictures are useless pictures that are not used, and occupy a large amount of storage space.

However, in this embodiment of this application, when the user wants to extract some important information from a large amount of character information, the user may preview, in a photographing preview state, the large amount of character information by using an abstract function, to quickly determine, based on a small amount of abstract information in the function area, whether a currently previewed segment of characters is important information that the user cares about. If the currently previewed segment of characters is important information that the user cares about, the user may shoot a picture for recording, to quickly and conveniently extract important information from a large amount of information and shoot a picture. Therefore, user operations and a quantity of shot pictures are reduced, and storage space for useless pictures is saved.

In another scenario, when there is a relatively large amount of to-be-read character information, and the user wants to quickly learn of main content of the to-be-read character information, the user may preview, in a photographing preview state, a large amount of character information by using an abstract function, to quickly understand a main idea of the character information based on displayed simplified abstract information in the function area. That is, users may obtain more information in less time.

In the abstract function processing process, there may be a plurality of algorithms for obtaining an abstract of character information in the text object, for example, an extractive (extractive) algorithm and an abstractive algorithm.

The extractive algorithm is based on a hypothesis that main content of an article can be summarized by using one or more sentences in the article. A task of an abstract is to find most important sentences in the article, and then a sorting operation is performed to obtain the abstract of the article.

The abstractive algorithm is an artificial intelligence (artificial intelligence, AI) algorithm, and requires a system to understand a meaning expressed in an article, and then summarize the meaning in a human language with high readability. For example, the abstractive algorithm may be implemented based on frameworks such as an attention model and an RNN encoder-decoder.

In addition, the electronic device may further hide a function area displayed on the preview interface. For example, in the scenario shown in FIG. 7b, after detecting a tap operation performed by the user outside the function area and inside the preview box, the electronic device may hide the function area, and continue to display the function list. Then, after detecting a tap operation performed by the user inside the preview box, the electronic device may resume displaying the function area and abstract information in the function area or when detecting that the user taps any function option in a selection function list, the electronic device resumes displaying the function area, and displays, in the function area, service information corresponding to the function option selected by the user. The function option may be an abstract function option, or may be another function option.

For another example, in the scenario shown in FIG. 7b, when the electronic device detects an operation of swiping downward by the user in a range of the function list or the function area, the electronic device hides the function area and the function list. After detecting an operation of swiping upward from the bottom of the preview box by the user, the electronic device resumes displaying the function area and the function list. Alternatively, after hiding the function area and the function list, the electronic device may display a displaying resume tag. When the user taps the resume tag or presses and touches and holds the resume tag and swipes upward, the electronic device resumes displaying the function area and the function list.

It should be noted that when the user uses another function option other than the abstract function, the electronic device may also hide the function area and the function list. Details are not described again when the another function option is described subsequently.

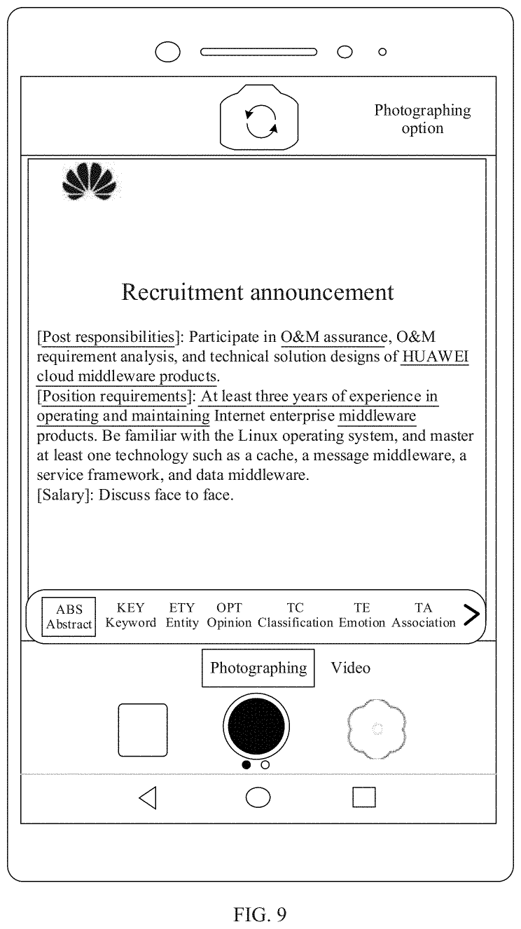

In addition, in an alternative manner of displaying the abstract information in the function area, the electronic device may also mark the abstract information on a character in the text object. For example, in the scenario shown in FIG. 7a, as shown in FIG. 9, the electronic device marks the abstract information on the character in the text object by using an underline.

(2) Keyword Function

The keyword function is to recognize, extract, and display a keyword in character information in a text object, to help a user quickly understand semantic information included in the text object from a perspective of the keyword.

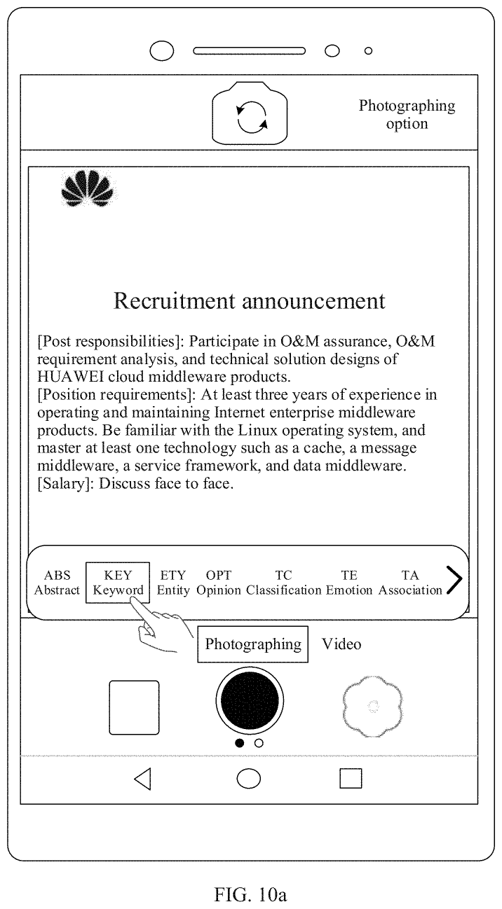

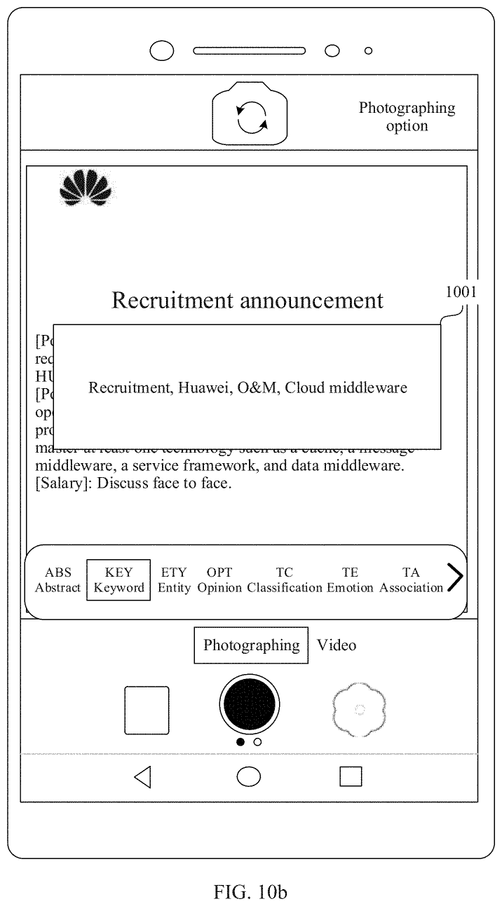

For example, as shown in FIG. 10a, the text object is the foregoing recruitment announcement previewed on the preview interface. When the electronic device detects that the user selects a keyword function option from the function list shown in FIG. 4a, as shown in FIG. 10b, the electronic device displays a function area 1001, and keywords of the recruitment announcement, for example, “Recruitment”, “Huawei”, “Operation and management”, and “Cloud middleware” are shown in the function area 1001. Alternatively, for example, the text object is the recruitment announcement previewed on the preview interface. When the electronic device opens the preview interface, as shown in FIG. 10b, a function list and a function area are displayed on the preview interface, a keyword function option in the function list is selected by default, and keywords of the recruitment announcement are displayed in the function area.

Compared with the abstract information, keyword information is more concise. Therefore, in some scenarios, the user may more quickly learn of main content of a current large quantity of characters in a photographing preview state by using a keyword function. In addition, after the user shoots a picture of the text object, the electronic device may further sort and classify the picture by using a keyword subsequently. Different from other sorting and classification methods, such sorting and classification already involves a content level of the picture.

In a keyword function processing process, there may be a plurality of algorithms for obtaining a keyword, for example, a term frequency-inverse document frequency (term frequency-inverse document frequency. TF-IDF) extraction method, a topic-model (Topic-model) extraction method, and a fast automatic keyword extraction (rapid automatic keyword extraction, RAKE) method.

In the TF-IDF keyword extraction method, a TF-IDF of a word is equal to a TF multiplied by an IDF, and a larger TF-IDF value indicates a higher probability that the word becomes a keyword. TF=(a quantity of times the word appears in the text object)/(a total quantity of words in the text object), and IDF=log(a total quantity of documents in a corpus/(a quantity of documents including the word+1)).

In the topic-model keyword extraction method, a document includes a topic, and a word in the document are selected from the topic in a specific probability. In other words, a topic set exists between the document and the word. A probability distribution of word occurrence varies with different topics. A topic word set of a document may be obtained by learning the topic model.

In the RAKE keyword extraction method, an extracted keyword may not be a single word (namely, a character or a word group), but may be a phrase. A score of each phrase is obtained by accumulating words that form the phrase, and a score of a word is related to a degree of the word and a word frequency. In other words, scores of words=degree/word frequency. When a word appears with more other words, the word has a higher degree.

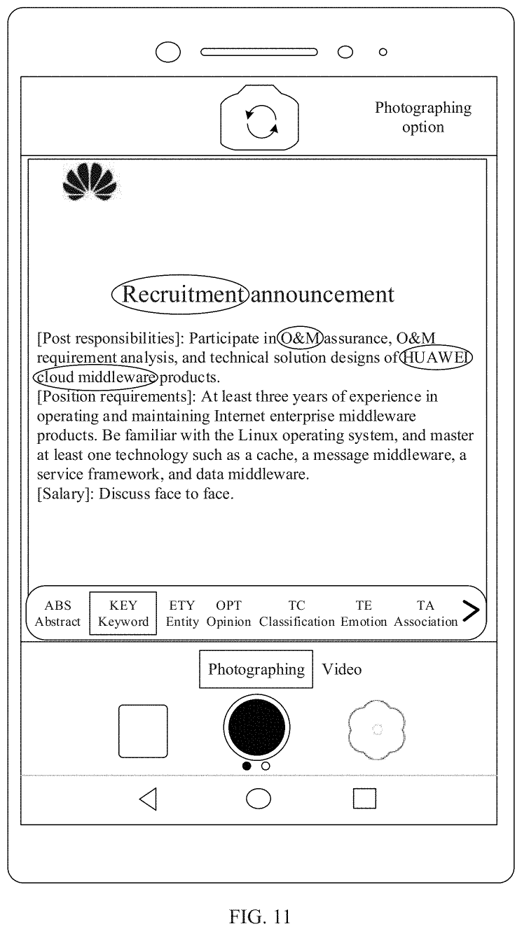

In addition, in an alternative manner of displaying the keyword information in the function area, the electronic device may also mark the keyword information on a character in the text object. For example, in a scenario shown in FIG. 10a, as shown in FIG. 11, the electronic device marks the keyword information on the character in the text object in a form of a circle.

(3) Entity Function

The entity function is to recognize, extract, and display an entity in character information in a text object, to help a user quickly understand semantic information included in the text object from a perspective of an entity.

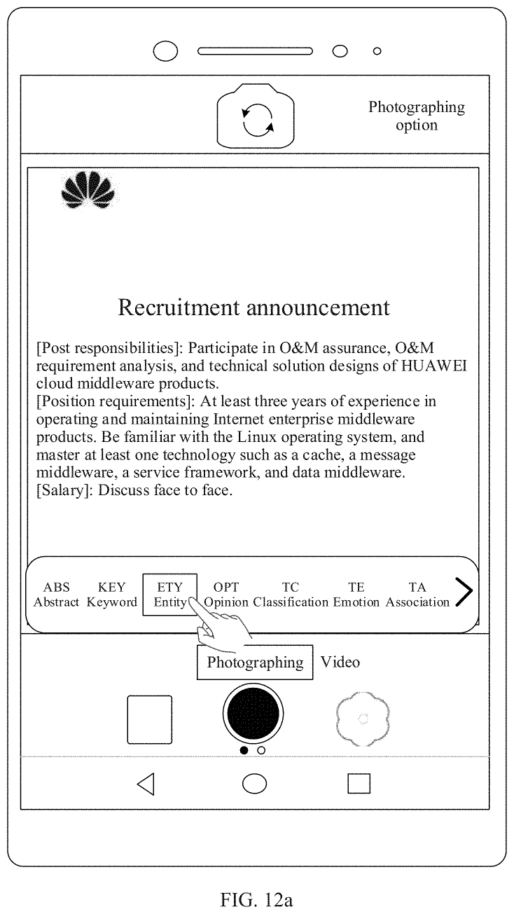

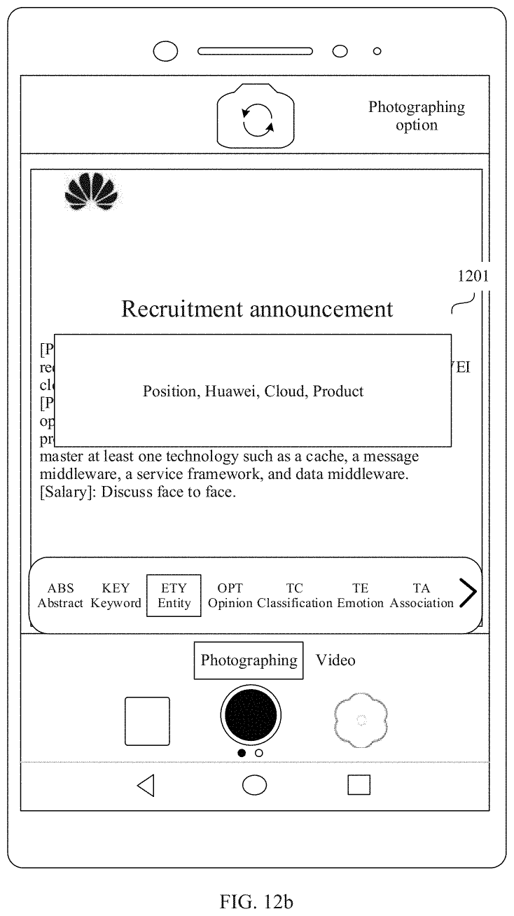

For example, as shown in FIG. 12a, the text object is the foregoing recruitment announcement previewed on the preview interface. When the electronic device detects that the user selects an entity function option from the function list shown in FIG. 4a, as shown in FIG. 12b, the electronic device displays a function area 1201, and entities of the recruitment announcement, for example, “Position”, “Huawei”, “Cloud”, “Product”, and “Cache” are shown in the function area 1201. Alternatively, for example, the text object is the recruitment announcement previewed on the preview interface. When the electronic device opens the preview interface, as shown in FIG. 12b, a function list and a function area are displayed on the preview interface, an entity function option in the function list is selected by default, and an entity of the recruitment announcement is displayed in the function area.

It should be noted that the entity may include a plurality of aspects such as a time, a name, a location, a position, and an organization. In addition, content included in the entity may vary with a type of the text object. For example, the content of the entity may further include a work name, and the like.

In addition, in a scenario shown in FIG. 12b, the user displays each entity in a text display box in a classified manner, so that information extracted from the text object is more organized and structured, to help the user manage and classify information.

When the user wants to focus on entity information such as a person, a time, and a location involved in the text object, the user can quickly obtain various entity information by using the entity function. In addition, this function may further help the user find some new entity terms and understand new things.

In an entity function processing process, there may be a plurality of algorithms for obtaining the entity in the character information in the text object, for example, a rule and dictionary-based method, a statistics-based method, and a combination of the rule and dictionary-based method and the statistics-based method.

In the rule and dictionary-based method, a rule template is usually manually constructed by a linguistics expert, and selected features include methods such as statistical information, a punctuation mark, a keyword, an indicator word and a direction word, a location word (such as a tail word), and a center word, and matching a pattern and a string is a main means. When an extracted rule can relatively accurately reflect a language phenomenon, the rule and dictionary-based method has better performance than the statistics-based method.

The statistics-based method mainly includes a hidden Markov model (hidden markov model, HMM), a maximum entropy (maximum entropy, ME), a support vector machine (support vector machine, SVM), a conditional random field (conditional random fields, CRF), and the like. In the four methods, a maximum entropy model has a compact structure and has relatively good commonality; the conditional random field provides a flexible and globally optimal labeling framework for named entity recognition; and the maximum entropy and the support vector machine are more accurate than the hidden Markov model. The hidden Markov model is faster in training and recognition because the hidden Markov model has higher efficiency in solving a named entity category sequence according to a Viterbi algorithm.

The statistics-based method has a relatively high requirement for feature selection. Various features that affect the task need to be selected from a text, and these features need to be added to a feature vector. Based on a main difficulty and a characteristic of specified named entity recognition, a feature set that can effectively reflect the entity characteristic is selected. A main method may be to mine a feature from a training corpus by collecting statistics about and analyzing language information included in the training corpus. Related features may be classified into a specific word feature, a context feature, a dictionary and part-of-speech feature, a stop word feature, a core word feature, a semantic feature, and the like.

Because text processing is not completely a random process, state search space is very large when only the statistics-based method is used, and filtering and pruning processing needs be performed in advance with the help of rule knowledge. Therefore, there is no named entity recognition system in which only a statistical model is used, but the rule knowledge is not used. In many cases, a combination of the statistical model and the rule knowledge is used.

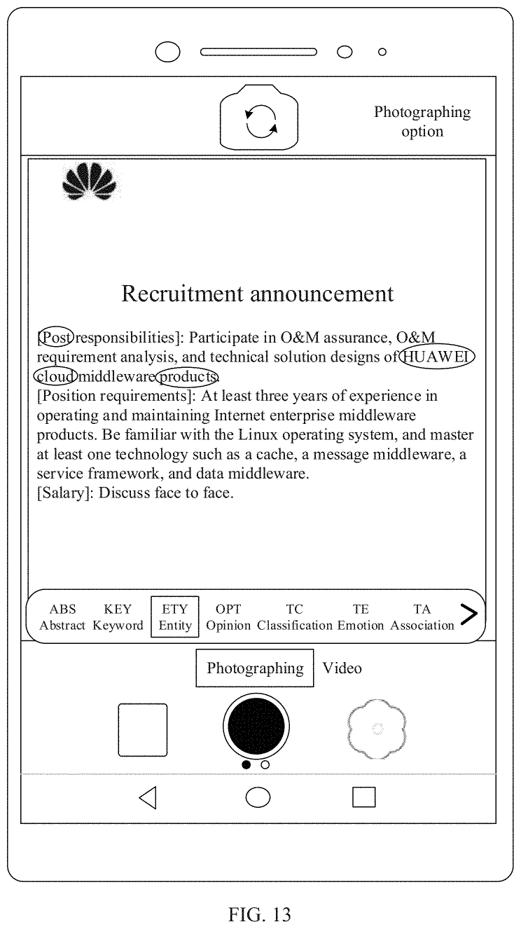

In addition, in an alternative manner of displaying the entity information in the function area, the electronic device may mark the entity information on a character in the text object. For example, in a scenario shown in FIG. 12a, as shown in FIG. 13, the electronic device marks the entity information on the character in the text object in a form of a circle.

(4) Opinion Function

The opinion function may analyze and summarize an opinion in described character content in a text object, to provide a reference for a user to make a decision.

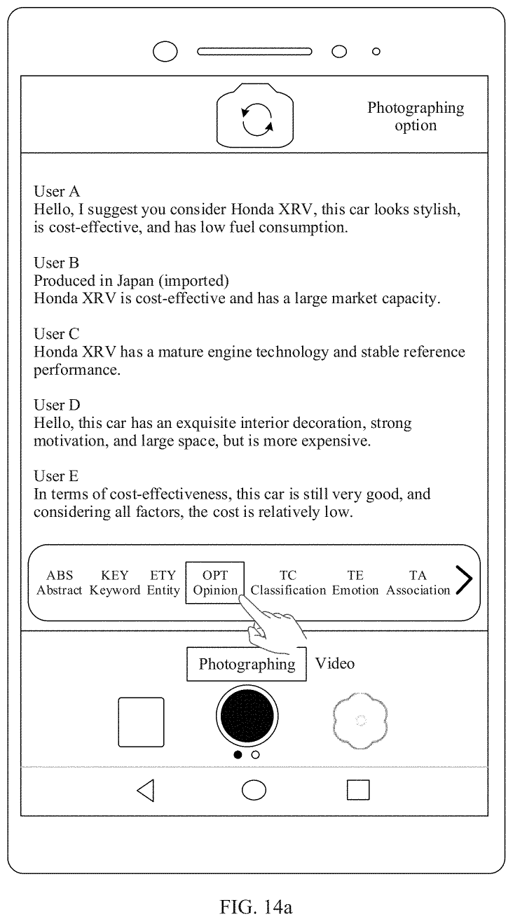

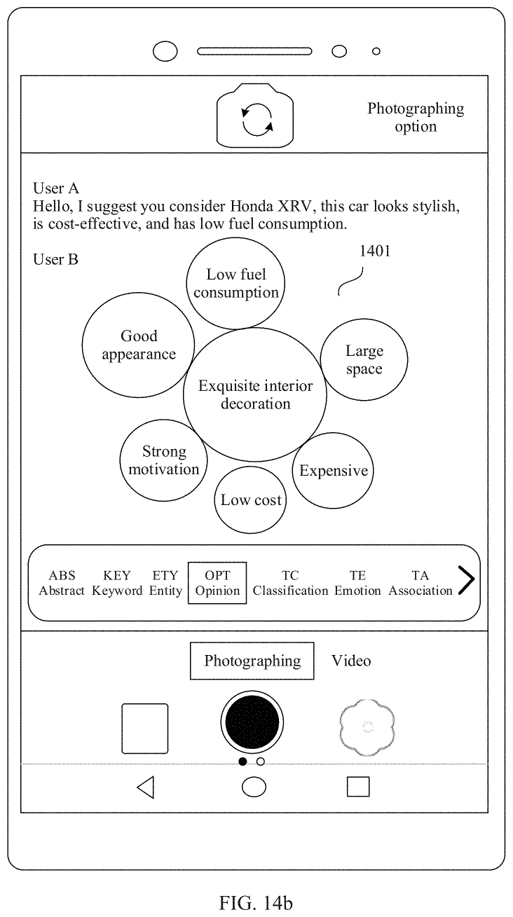

For example, when the user previews, by using a camera function of the electronic device, comment content that is in a user comment area and that is displayed on a paper document or a display of a computer, a preview object is a text object. As shown in FIG. 14a, when the electronic device detects that the user selects an opinion function option from a function list, as shown in FIG. 14b, the electronic device displays a function area 1401, and overall views that are of all users who make comments and that are reflected by content in a current comment area, for example, “Exquisite interior decoration”, “Low oil consumption”, “Good appearance”, “Large space”, and “High price”, are output in the function area 1401 in a visualized manner. Alternatively, when the electronic device opens the preview interface, as shown in FIG. 14b, a function list and a function area are displayed on the preview interface, an opinion function option in the function list is selected by default, and an overall opinion reflected by content in the current comment area is output in the function area 1401 in the visualized manner. In FIG. 14b, a larger circle in which an opinion is located indicates a larger quantity of comments that express the opinion.

In an electronic shopping scenario, when the user browses comments to determine a product to be bought, the user usually needs to spend a large amount of time in reading and making a summary to determine whether it is worth buying the product. A process of repeatedly reading and summarizing product comment data takes a lot of time of the user. However, the user may still not make a good decision. The opinion function provided in this embodiment of this application can help the user better integrate and summarize data, to reduce decision time of the user, and help the user make an optimal decision.

Because a dependency relationship exists between sentences and an emotion word has a specific location relationship in the dependency relationship, an opinion word shows a subjective feeling imposed on an entity. Therefore, in an opinion function processing process, after a comment word (for example, may be a noun or a pronoun) corresponding to a commented object is recognized, an opinion granted to the commented object may be further found based on a syntax dependency relationship.

(5) Classification Function

The classification function may perform classification based on character information in a text object, to help a user learn of a field to which content in the text object belongs.

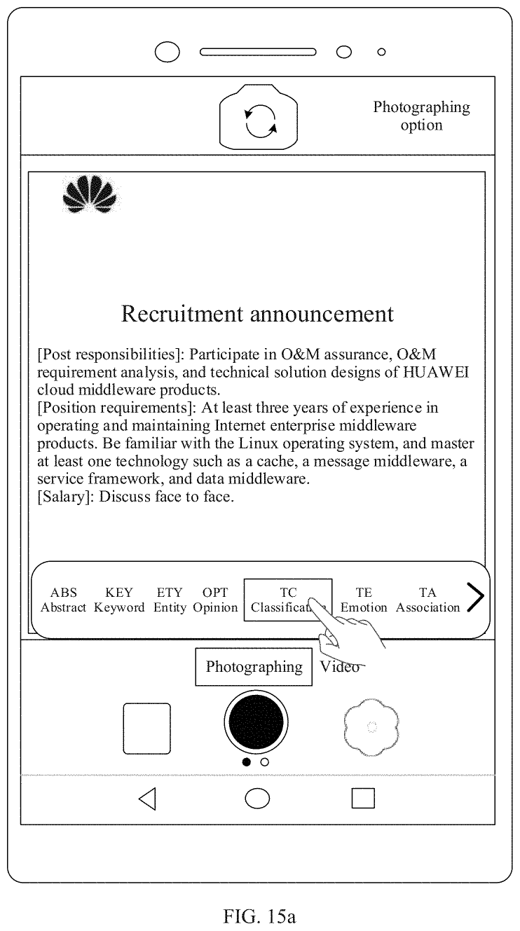

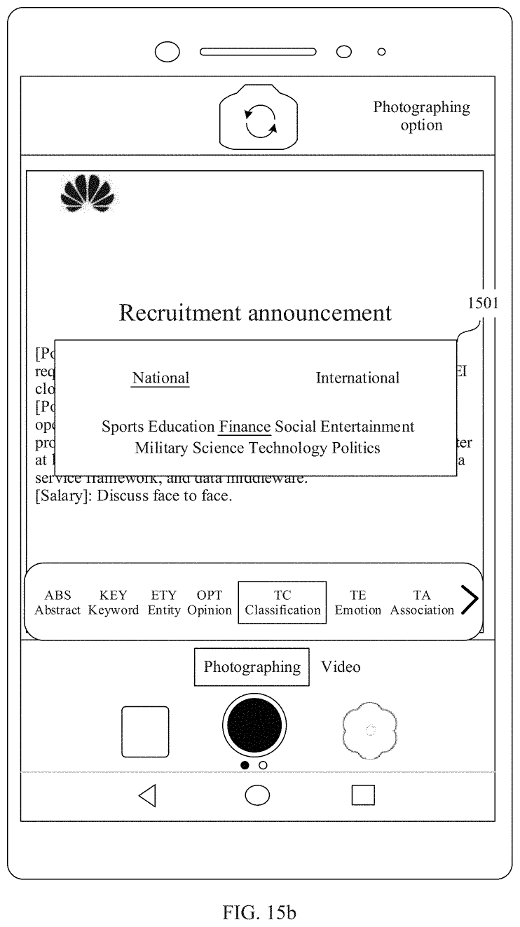

For example, as shown in FIG. 15a, the text object is the foregoing recruitment announcement previewed on the preview interface. When the electronic device detects that the user selects a classification function option from the function list shown in FIG. 4a, as shown in FIG. 15b, the electronic device displays a function area 1501, and a classification of the recruitment announcement, for example, “National finance” is shown in the function area 1501. Alternatively, for example, when the electronic device opens the preview interface, as shown in FIG. 15b, a function list and a function area are displayed on the preview interface, a classification function option in the function list is selected by default, and a classification of the recruitment announcement is displayed in the function area.

In FIG. 15b, a classification standard includes two levels: a first level includes two items: “National” and “International”, and a second level includes “Sports”, “Education”, “Finance”, “Society”, “Entertainment”, “Military”, “Science and technology”, “Internet”, “Real estate”, “Game”, “Politics”, and “Vehicle”. Image content in FIG. 2 to FIG. 6 is marked as “National+Politics”. It should be noted that the classification standard may alternatively be in another form. This is not specifically limited in this embodiment of this application.

Different users have different sensitivity and interest in different types of documents, or the user may be interested in only a specific type of document. This classification function helps the user identify a type of a current document in advance and then determine whether to read the document, so as to save time used by the user to read a document that the user is not interested in. In addition, after the user shoots a picture of the text object, the classification function may further help the electronic device or the user to classify the picture based on a type of an article, to greatly facilitate subsequent reading of the user.

In a classification function processing process, there may be a plurality of classification obtaining algorithms, for example, a statistical learning (machine learning) method. The statistical learning method divides text classification into two phases: a training phase (there is a rule used by a computer to automatically perform summarization and classification) and a classification phase (a new text is classified). All core classifier models of machine learning may be used for text classification. Common models and algorithms include a support vector machine (SVM), an edge perception machine, k-nearest neighbors (k-nearest neighbor, KNN) algorithm, a decision tree, naive Bayes (naive bayes, NB), a Bayesian network, an Adaboost algorithm, logistic regression, a neural network, and the like.

In the training phase, the computer performs feature extraction (including feature selection and feature extraction) to find a most representative dictionary vector (selecting a most representative word) based on a training set document, and converts the training set document into a vector representation based on the dictionary. A vector representation of text data is available, and then a classifier model can be used for learning.

(6) Emotion Function

The emotion function mainly obtains, by analyzing character information in a text object, an emotion expressed by an author. The emotion may include two or more types including commendatory connotation or derogatory connotation, so as to help a user determine whether the author expresses a positive or negative emotion at a document in the text object.

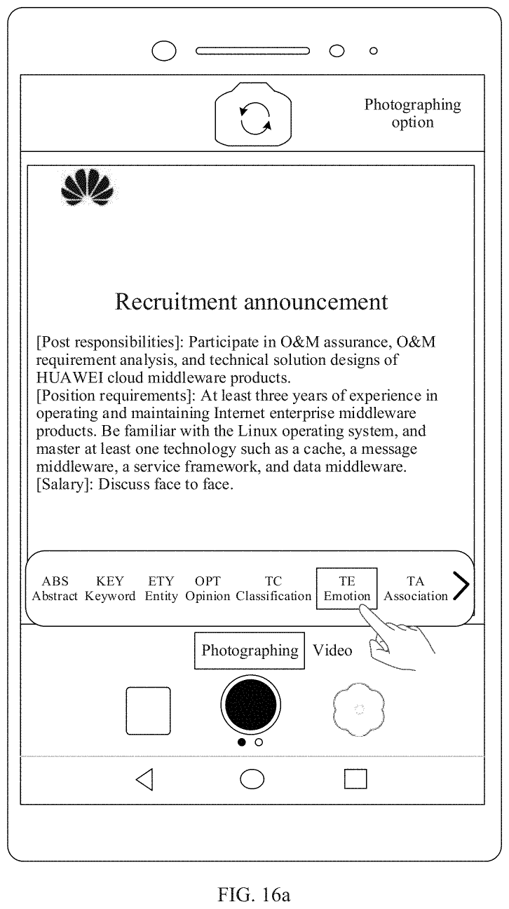

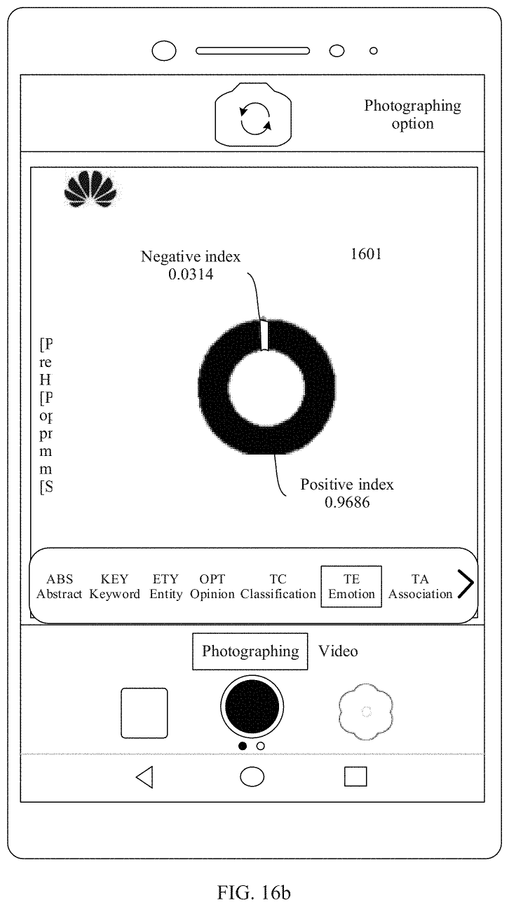

For example, as shown in FIG. 16a, the text object is the foregoing recruitment announcement previewed on the preview interface. When the electronic device detects that the user selects an emotion function option from the function list shown in FIG. 4a, as shown in FIG. 16b, the electronic device displays a function area 1601, and an emotion that is expressed by the author at the recruitment announcement, for example, “Positive index” and “Negative index” is shown in the function area 1601. Alternatively, for example, when the electronic device opens the preview interface, as shown in FIG. 16b, a function list and a function area are displayed on the preview interface, an emotion function option in the function list is selected by default, and an emotion expressed by the author at the recruitment announcement is displayed in the function area. In FIG. 16b, emotions are described by the positive index and the negative index. It can be learned from FIG. 16b that the author expresses a positive, active, and commendatory emotion at this recruitment incident.

It should be noted that positive and negative classification standards of emotions in FIG. 16b are merely examples for description, and another classification standard may alternatively be used. This is not specifically limited in this embodiment of this application.

In a classification function processing process, there may be a plurality of classification obtaining algorithms, for example, a dictionary-based method and a machine learning-based method.

The dictionary-based method mainly includes: formulating a series of emotion dictionaries and rules, splitting and analyzing a text and matching the text and a dictionary (there is usually part-of-speech analysis and syntax dependency analysis), calculating an emotion value, and finally using the emotion value as a basis for determining an emotion tendency of the text. Specifically, the method may include: performing a sentence splitting operation on a text greater than sentence strength, where a sentence is used as a minimum analysis unit; analyzing words appearing in sentences and performing matching based on an emotion dictionary; processing negative logic and transition logic; calculating a score of emotion words of an entire sentence (performing weighted summation based on factors such as different words, polarities, and degrees); and outputting an emotion tendency of the sentence based on an emotion score. If there is an emotion analysis task at a chapter level or a paragraph level, the task may be performed in a form of performing single emotion analysis on each sentence and performing fusion, or may be performed by extracting an emotion theme sentence and then performing sentence emotion analysis, to obtain a final emotion analysis result.

In the machine learning-based method, emotion analysis may be used as a supervised classification problem. For determining of emotion polarity, target emotions are classified into three categories: a positive emotion, a medium emotion, and a negative emotion. A training text is manually labeled, a supervised machine learning process is performed, and test data is modeled to predict a result.

(7) Association Function

The association function provides a user with content related to character content in a text object, to help the user understand and extend more related content, so that the user can extend reading, and the user does not need to specially search for related content.

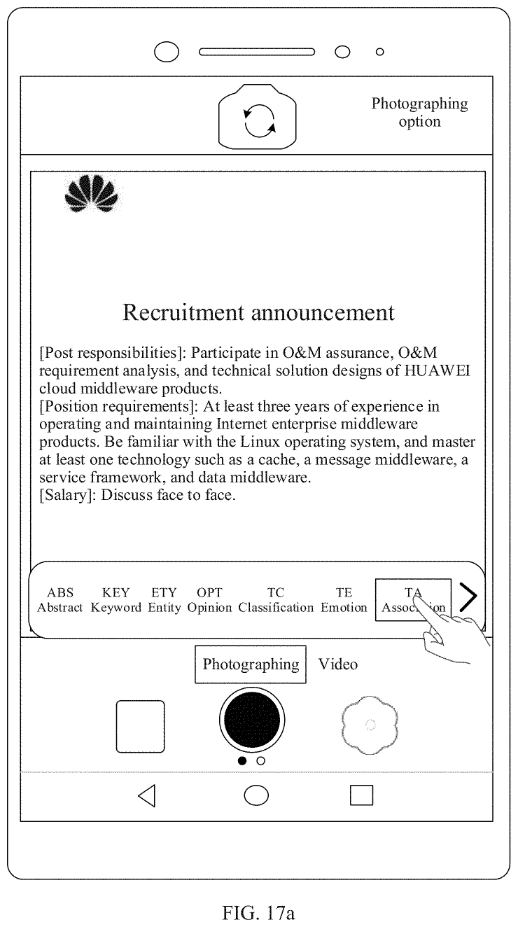

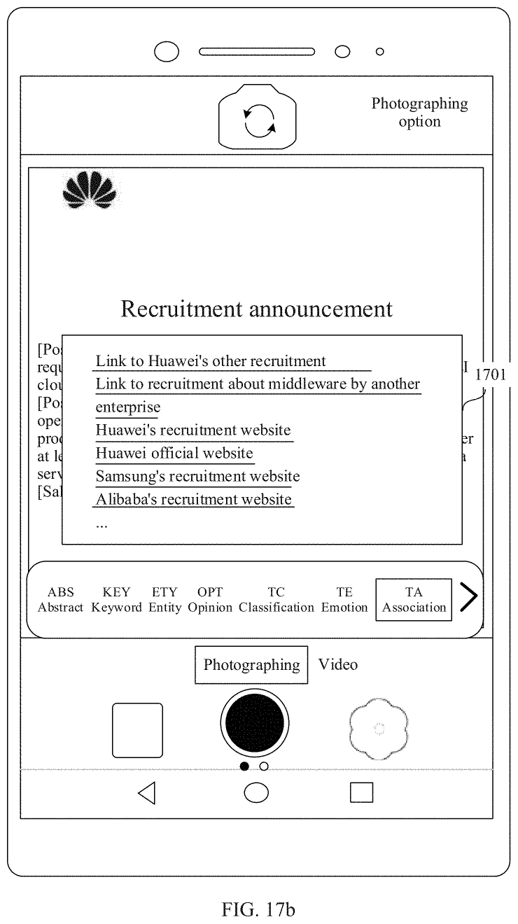

For example, as shown in FIG. 17a, the text object is the foregoing recruitment announcement previewed on the preview interface. When the electronic device detects that the user selects an association function option from the function list shown in FIG. 4a, as shown in FIG. 17b, the electronic device displays a function area 1701, and other content of the recruitment announcement, for example, “Link to Huawei's other recruitment”, “Link to recruitment about middleware by another enterprise”, “Huawei's recruitment website”, “Huawei official website”, “Samsung's recruitment website”, or “Alibaba's recruitment website” is shown in the function area 1701. Alternatively, for example, when the electronic device opens the preview interface, as shown in FIG. 17b, a function list and a function area are displayed on the preview interface, an association function option in the function list is selected by default, and other content related to the recruitment announcement is displayed in the function area.

Specifically, in an association function processing process, a link to another sentence that is highly similar to a sentence in the text object may be returned to the user based on a semantic similarity between sentences by accessing a search engine.

(8) Product Remark Function

The product remark function helps a user search for an item linked to or indicated by information content in a text object by using a huge Internet resource library in a shopping process or an item recognition process (a search tool is not limited to a common search tool such as a search engine, and may also be another search tool). This may help the user analyze a comprehensive feature of the linked or indicated item from different dimensions. In addition, deep processing may be performed in the background based on the obtained data, and final comprehensive evaluation of the item is output.

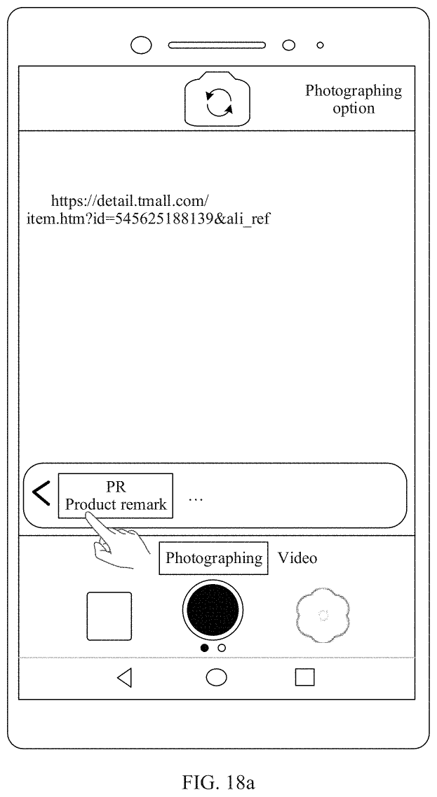

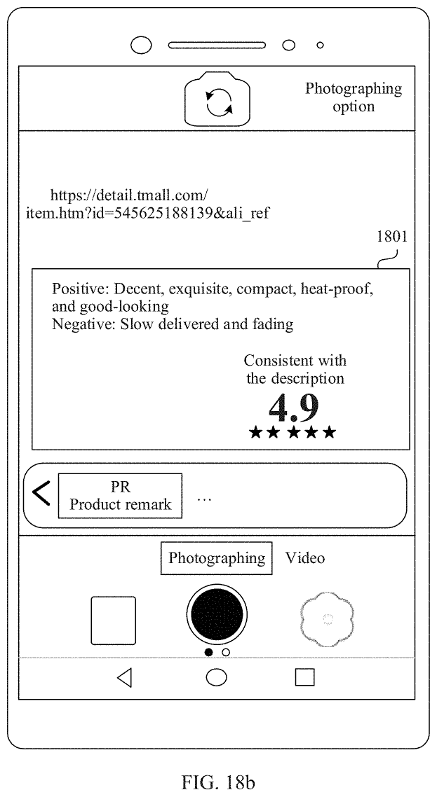

For example, when the user previews, by using a camera function of the electronic device, a link to a cup displayed on a leaflet, a magazine, or a display of a computer, a preview object is a text object. As shown in FIG. 18a, when the electronic device detects that the user selects the product remark function from a function list, as shown in FIG. 18b, the electronic device displays a function area 1801, and some evaluation information of a cup corresponding to the link, and positive and negative evaluation information are shown in the function area 1801. This function can greatly help the user understand a related feature of the cup before buying the cup. In addition, this function may help the user buy a cost-effective cup. Alternatively, when the electronic device opens the preview interface, as shown in FIG. 18b, a function list and a function area are displayed on the preview interface, a product remark function option in the function list is selected by default, and some evaluation information of a current cup and positive and negative evaluation information are displayed in the function area.

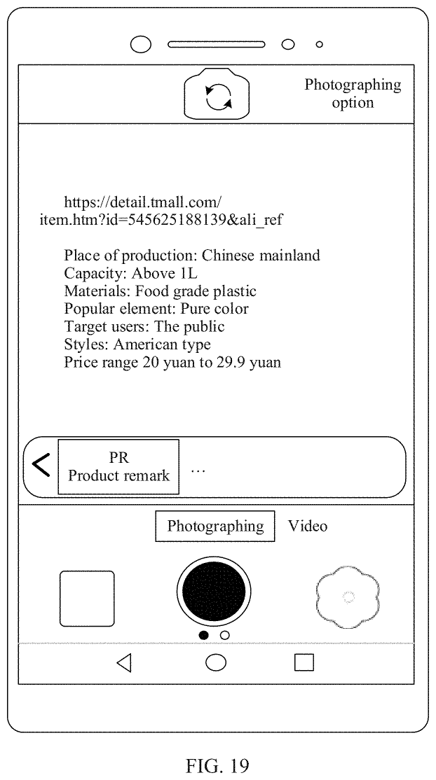

In addition, as shown in FIG. 19, the product remark information may further include specific content of a current link, for example, a place of production, a capacity, and a material of the cup.

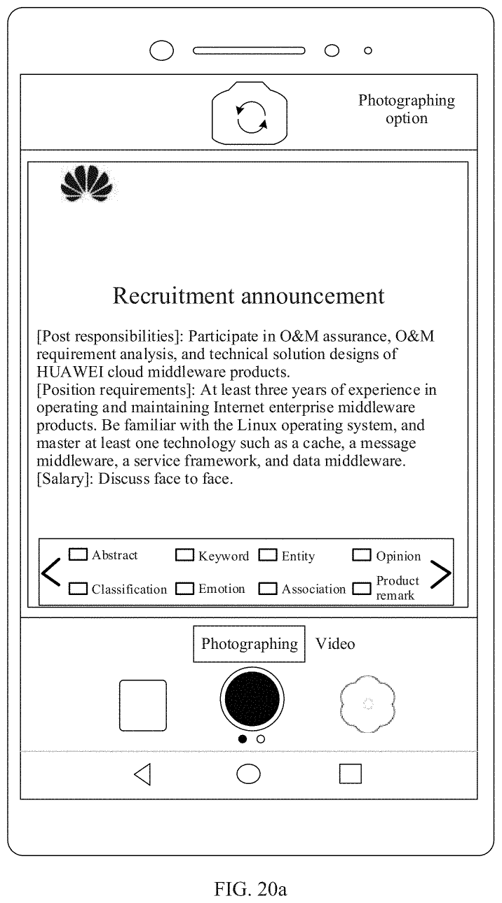

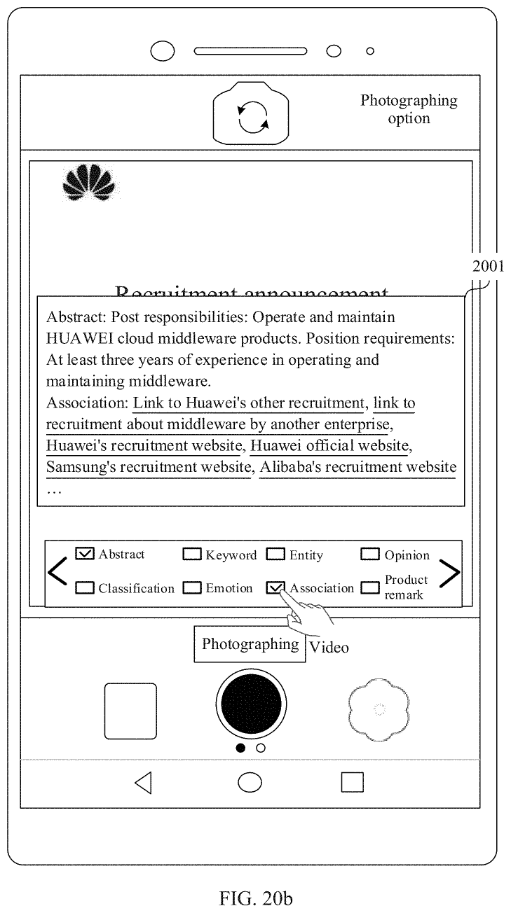

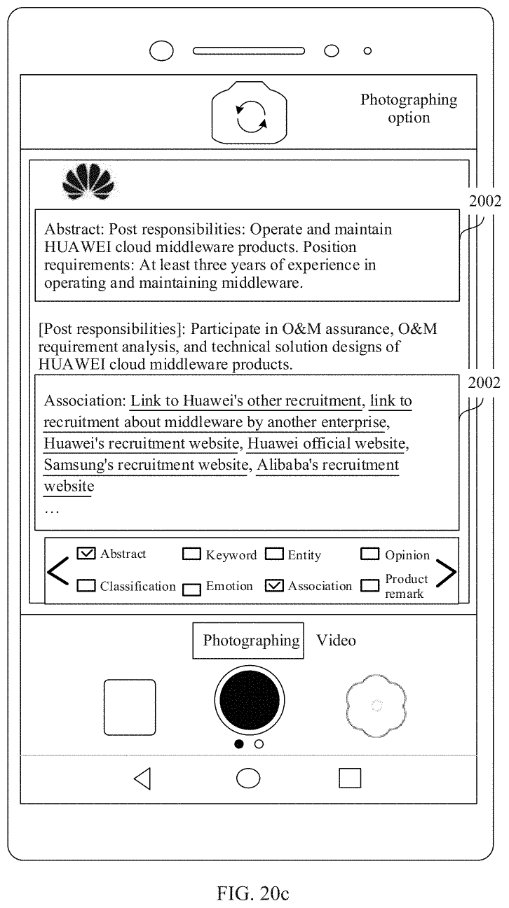

It should be noted that the foregoing description is provided by using an example in which the selected target function option is one function option. There may be a plurality of selected target function options, and the electronic device may display service information of the plurality of target function options in the function area. For example, as shown in FIG. 20a, the text object is the foregoing recruitment announcement previewed on the preview interface. When the electronic device detects that the user selects the abstract function option and the association function option from the function list shown in FIG. 4a, as shown in FIG. 20b, the electronic device displays a function area 2001, and abstract information and association information in the character information in the text object are displayed in the function area 2001. Alternatively, as shown in FIG. 20c, the function area 2002 includes two parts. One part is used to display the abstract information, and the other part is used to display association information. Further, if the user cancels selection of the association function option, the electronic device cancels displaying of the association information, and displays only the abstract information.

It should be further noted that, in the photographing preview state, a function option that can be executed by the electronic device for the text object is not limited to the several options listed above, for example, may further include a label function. When the electronic device performs the label function, the electronic device may perform deep analysis on a title and content of a text, and display a corresponding confidence level and multi-dimensional label information such as a subject, a topic, and an entity that can reflect key information of the text. This function option may be widely used in scenarios such as personalized recommendation, article aggregation, and content retrieval. Other function options that may be executed by the electronic device are not listed one by one herein.

In addition, in this embodiment of this application, the characters in the text object may include one or more languages, for example, may include a Chinese character, an English character, a French character, a German character, a Russian character, or an Italian character. Information in the function area and the character in the text object may use a same language. Alternatively, the information in the function area and the character in the text object may use different languages. For example, the character in the text object may be in English, and the abstract information in the function area may be in Chinese. Alternatively, the character in the text object may be in Chinese, and the keyword information in the function area may be in English, or the like.

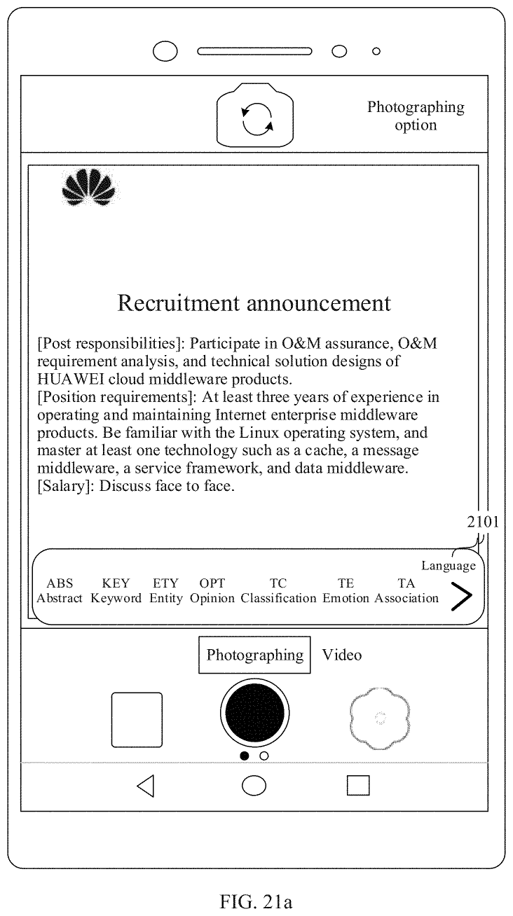

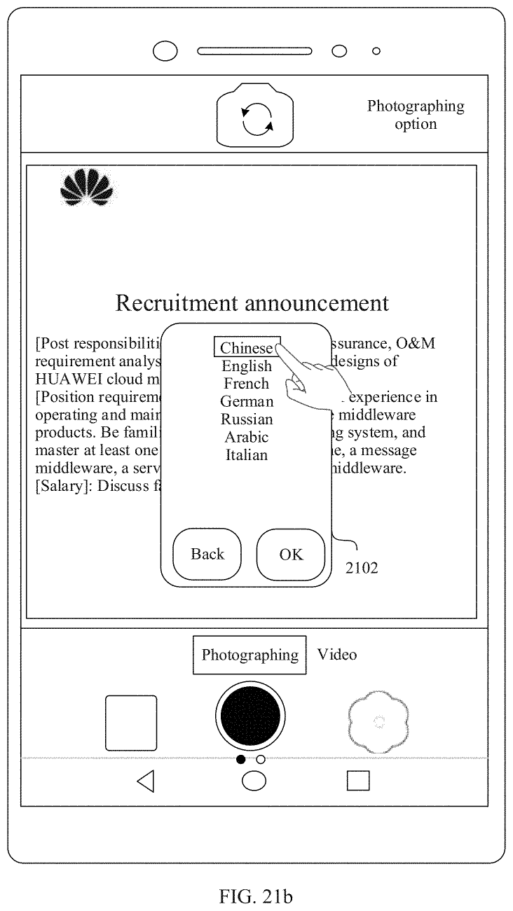

In some cases, the function list may further include a language setting control, configured to set a language type to which the service information in the function area belongs. For example, as shown in FIG. 21a, when the electronic device detects that the user taps a language setting control 2101, the electronic device displays a language list 2102. When the user selects Chinese, the electronic device displays information in Chinese (or referred to as a Chinese character) in a function box; and when the user selects English, the electronic device displays information in English in the function box.

In some embodiments of this application, in the photographing preview state, after the electronic device detects a fourth operation performed by the user, the electronic device may display a text function for the text object in the photographing preview state.

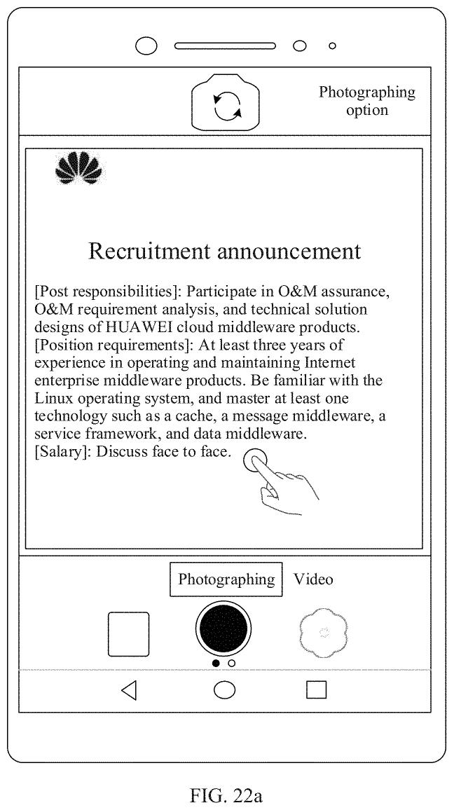

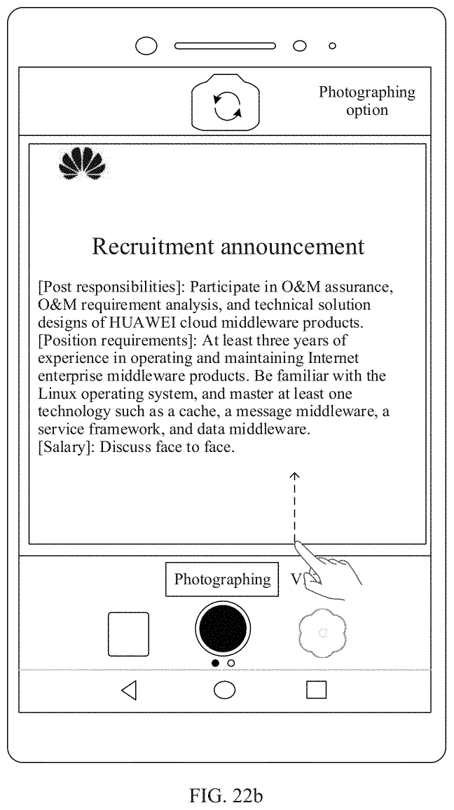

In a case, when the user needs to use the text function, the user may enter the fourth operation on the touchscreen, to trigger the electronic device to display the function list. For example, in the photographing preview state, as shown in FIG. 22a, after detecting a touch and hold operation performed by the user inside the preview box, the electronic device may display the function list shown in FIG. 4a. FIG. 5a. FIG. 5b, FIG. 7b, FIG. 10b, or the like, so as to display the text function for the text object in the methods described in FIG. 4a to FIG. 21b in the foregoing embodiment.

It should be noted that the touch and hold operation performed by the user inside the preview box is merely an example description of the fourth operation, and the fourth operation may alternatively be another operation. For example, the fourth operation may also be an operation of holding and dragging by using two fingers by the user inside the preview box. Alternatively, as shown in FIG. 22b, the fourth operation may be an operation of swiping upward on the preview interface by the user. Alternatively, the fourth operation may be an operation of swiping downward on the preview interface by the user. Alternatively, the fourth operation may be an operation of drawing a circle track on the preview interface by the user. Alternatively, the fourth operation may be an operation of pulling down by using three fingers by the user on the preview interface. Alternatively, the fourth operation may be a voice operation entered by the user, and the like. The operations are not listed one by one herein.

In another case, the electronic device may display prompt information on the preview interface, to prompt the user whether to choose to use the text function. When the user chooses to use the text function, the electronic device may display the text function for the text object in the photographing preview state.

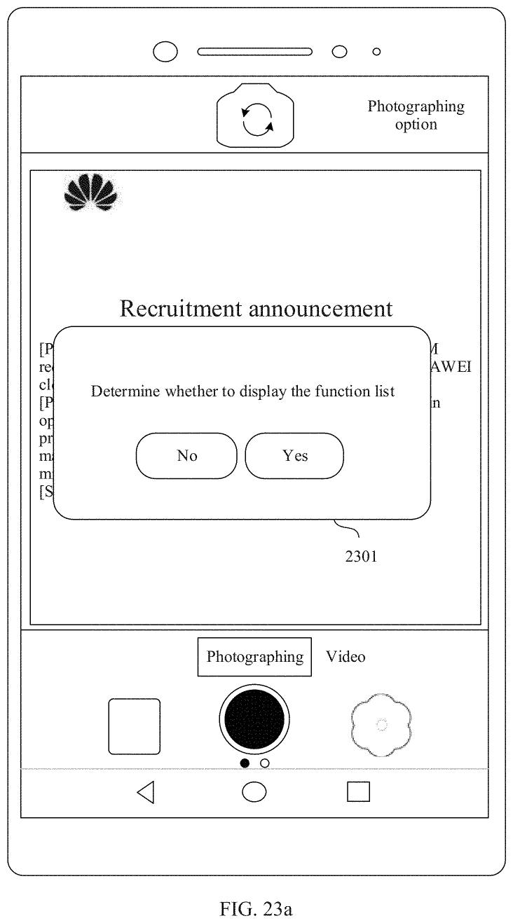

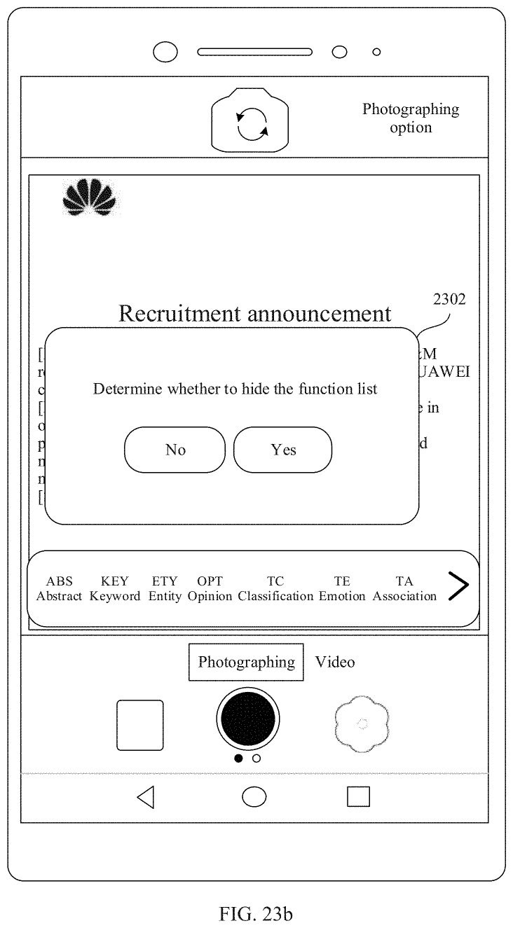

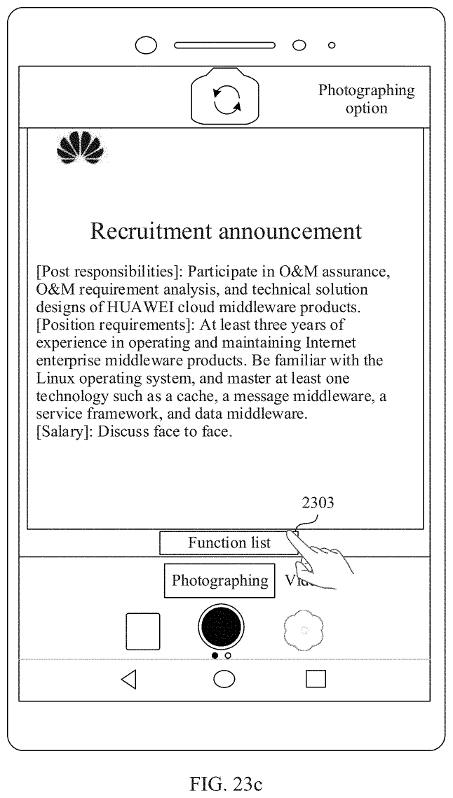

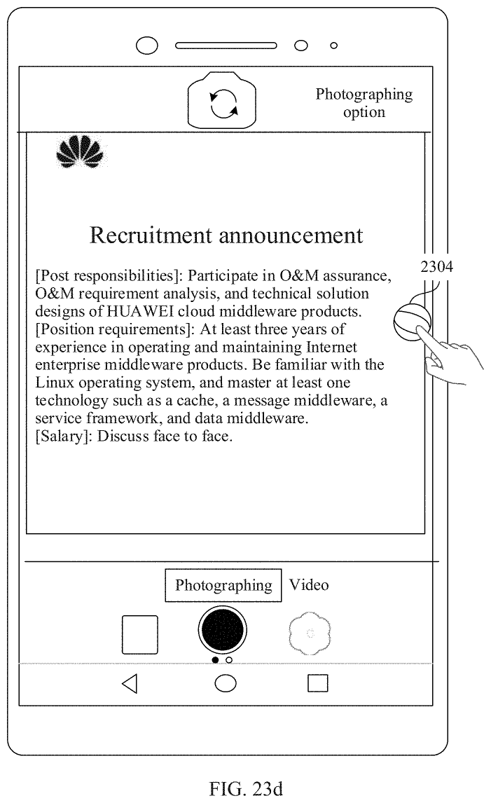

For example, as shown in FIG. 23a, a prompt box is displayed on the preview interface, to prompt the user whether to use the text function. When the user chooses to use the text function, the electronic device may display a function list, to display the text function for the text object in the methods described in FIG. 4a to FIG. 21b in the foregoing embodiment. Alternatively, as shown in FIG. 23b, a prompt box and a function list are displayed on the preview interface. The prompt box is used to prompt the user whether to use the text function. When the user chooses to use the text function, the function list continues to be displayed on the preview interface. When the user chooses not to use the text function, the electronic device hides the function list on the preview interface.

For another example, as shown in FIG. 23a, a prompt box is displayed on the preview interface, to prompt the user whether to display the function list. When the user selects “Yes”, the electronic device may display the function list shown in FIG. 4a, FIG. 5a, FIG. 5b, FIG. 7b, FIG. 10b, or the like, to display the text function for the text object in the methods described in FIG. 4a to FIG. 21b in the foregoing embodiment. Alternatively, as shown in FIG. 23b, a prompt box 2302 and a function list are displayed on the preview interface. The prompt box is used to prompt the user whether to hide the function list. When the user selects “No”, the function list continues to be displayed on the preview interface. When the user selects “Yes”, the electronic device hides the function list on the preview interface.

For another example, a text function control is displayed on the preview interface. When the electronic device detects a touch operation performed by the user on the text function control, the electronic device may display the function list shown in FIG. 4a, FIG. 5a, FIG. 5b, FIG. 7b, FIG. 10b, or the like, to display the text function for the text object in the methods described in FIG. 4a to FIG. 21b in the foregoing embodiment. For example, the text function control may be a function list button 2303 shown in FIG. 23c, may be a floating ball 2304 shown in FIG. 23d, or may be an icon or another control.

In some other embodiments of this application, the shooting mode includes a smart reading mode. In the smart reading mode, the electronic device may display the text function for the text object in the photographing preview state.

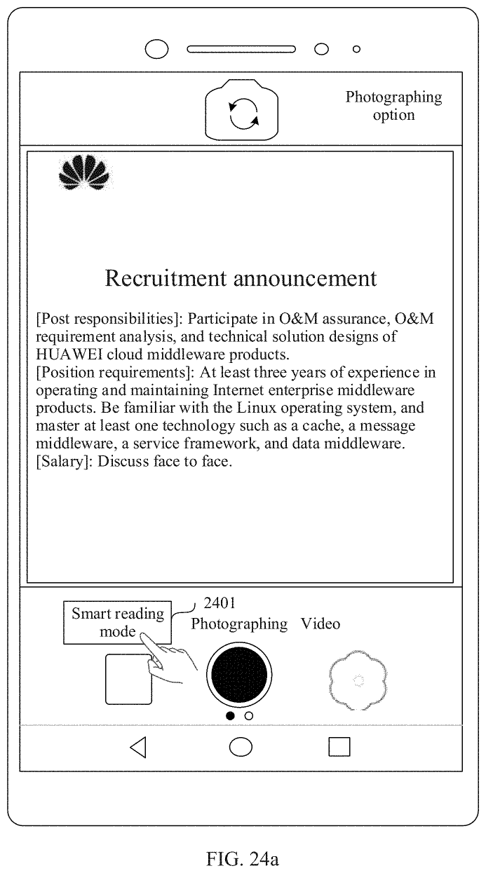

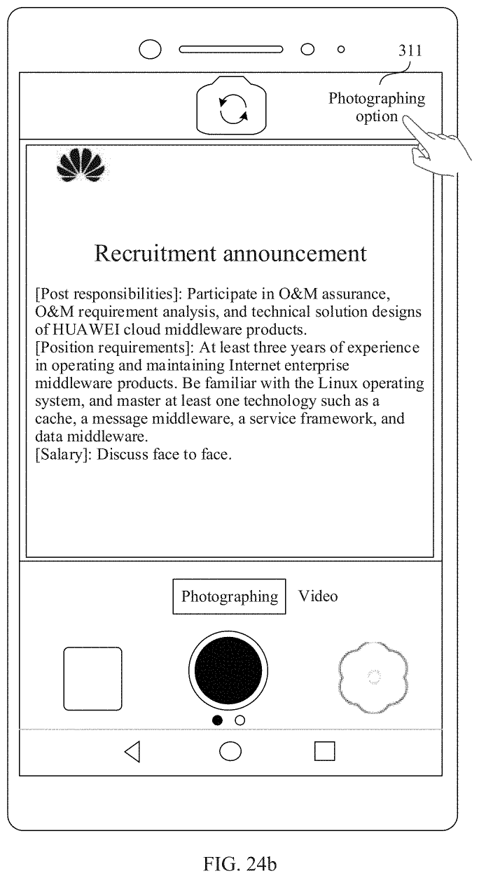

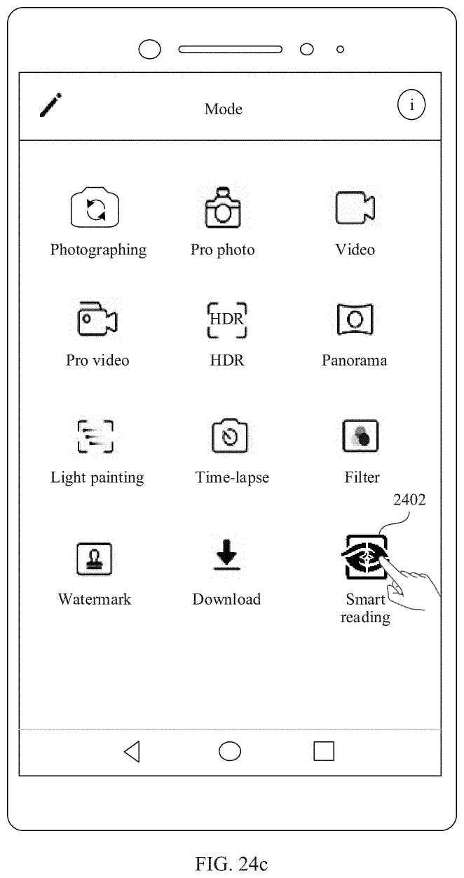

For example, after the camera application is opened, the electronic device may display a preview interface shown in FIG. 24a. A smart reading mode control 2401 is included on the preview interface. When the electronic device detects that the user taps and selects the smart reading mode control 2401, the electronic device may display the function list shown in FIG. 4a, FIG. 5a, FIG. 5b, FIG. 7b, FIG. 10b, or the like, to display the text function for the text object in the methods described in FIG. 4a to FIG. 21b in the foregoing embodiment.

For another example, as shown in FIG. 24b, after the user detects, on the preview interface, an operation that the user taps the shooting option control 311, as shown in FIG. 24c, the electronic device displays a shooting mode interface, and the shooting mode interface includes the smart reading mode control 2402. When the electronic device detects that the user taps and selects the smart reading mode control 2402, the electronic device may display the function list shown in FIG. 4a, FIG. 5a, FIG. 5b, FIG. 7b, FIG. 10b, or the like, to display the text function for the text object in the methods described in FIG. 4a to FIG. 21b in the foregoing embodiment. In addition, after the electronic device detects that the user taps and selects the smart reading mode control 2402, when the user subsequently opens the photographing preview interface again, the electronic device may automatically display the text function for the text object in the smart reading mode.

For another example, a smart reading mode control is included on the preview interface. If the electronic device determines that the preview object is a text object, the electronic device automatically switches to the smart reading mode, and displays the function list shown in FIG. 4a, FIG. 5a, FIG. 5b, FIG. 7b, FIG. 10b, or the like, to display the text function for the text object in the methods described in FIG. 4a to FIG. 21b in the foregoing embodiment.

For another example, a smart reading mode control is included on the preview interface, and the electronic device sets the shooting mode to the smart reading mode by default. After the user chooses to switch to another shooting mode, the electronic device performs photographing in the another shooting mode.

For another example, after the camera application is opened, the prompt box shown in FIG. 23a may be displayed on the preview interface, and the prompt box may be used to prompt the user whether to use the smart reading mode. When the user selects “Yes”, the electronic device may display the function list shown in FIG. 4a, FIG. 5a, FIG. 5b, FIG. 7b, FIG. 10b, or the like, to display the text function for the text object in the methods described in FIG. 4a to FIG. 21b in the foregoing embodiment.

It can be learned from the description of the foregoing embodiment that in the photographing preview state, the electronic device may display the text function for the text object. In some other embodiments of this application, when the electronic device determines that the preview object is switched from one text object to another text object, the electronic device may display a text function for the text object obtained after switching. When the electronic device determines that the preview object is switched from the text object to a non-text object, the electronic device may disable a related application for displaying the text function. For example, when the electronic device determines that a camera refocuses, it may indicate that the preview object moves, and the preview object may change. In this case, the electronic device may determine whether the preview object changes. For example, when the electronic device determines that the preview object is changed from a text object “newspaper” to a new text object “book page”, the electronic device displays a text function of the new text object “book page”. For another example, when the electronic device determines that the preview object is changed from a text object “newspaper” to a non-text object “person”, the electronic device may hide the function list, and does not enable a related application for displaying the text function.

In addition, in the photographing preview state, in a process in which the electronic device displays the text function for the text object, if the electronic device shakes or the preview object shakes, the electronic device may determine whether a current preview object and a preview object existing before shaking are a same text object. If the current preview object and the preview object existing before shaking are a same text object, the electronic device keeps current displaying of the text function for the text object; or if the current preview object and the preview object existing before shaking are not a same text object, the electronic device displays a text function of the new text object. Specifically, in the photographing preview state, when the electronic device determines, by using a sensor such as a gravity sensor, an acceleration sensor, or a gyroscope of the electronic device, that a moving distance of the electronic device is greater than or equal to a preset value, it may indicate that the electronic device moves, and the electronic device may determine whether the current preview object and the preview object existing before shaking are a same text object. Alternatively, when the electronic device determines that a camera refocuses in a preview process, it may indicate that the preview object or the electronic device moves. In this case, the electronic device may determine whether the current preview object and the previous preview object are a same text object.

In some other embodiments, a function option in the function list displayed by the electronic device on the preview interface may be related to the preview object. If there are different preview objects, function options displayed by the electronic device on the preview interface may also be different. Specifically, the electronic device may recognize the preview object on the preview interface, and then display, on the preview interface based on features such as a type and specific content of the recognized preview object, a function option corresponding to the preview object. After detecting an operation of selecting the target function option by the user, the electronic device may display service information corresponding to the target function option.

For example, when the electronic device previews a recruitment announcement, a newspaper, or a book page, the electronic device may identify, on the preview interface, that the preview object is a segment of characters. In this case, the electronic device may display, on the preview interface, function options such as “Abstract”. “Keyword”, “Entity”, “Opinion”, “Analysis”, “Emotion””, and “Association”.

For another example, when the electronic device previews an item such as a cup, a computer, a bag, or clothes, the electronic device may recognize, on the preview interface, that the preview object is an item. In this case, the electronic device may display the association function option and the product remark function option on the preview interface.

In addition, the function options are not limited to the foregoing several options, and may further include another option.

For example, when the electronic device previews a poster on which a captain Jack is displayed, the electronic device may recognize, on the preview interface, that the preview object is the captain Jack. In this case, the electronic device may display, on the preview interface, function options such as a director, a plot introduction, a role, a release time, and a leading actor.

For another example, when the electronic device previews a logo identifier of Huawei, the electronic device may recognize the logo of Huawei, and display function options such as “Introduction to Huawei”, “Huawei official website”, “Huawei Vmall”, “Huawei cloud”, and “Huawei recruitment” on the preview interface.

For another example, when the electronic device previews a rare animal, the electronic device may recognize the animal, and display function options such as “Subject”, “Morphological characteristic”, “Living habit”, “Distribution range”, and “Habitat” on the preview interface.

Specifically, a function option in the function list displayed by the electronic device on the preview interface may be related to a type of the preview object. If the preview object is of a text type, the electronic device may display a function list on the preview interface; or if the preview object is of an image type, the electronic device may display another function list on the preview interface. The two function lists include different function options. The preview object of the text type is a preview object including a character. The preview object of the image type is a preview object including an image, a portrait, a scene, and the like.

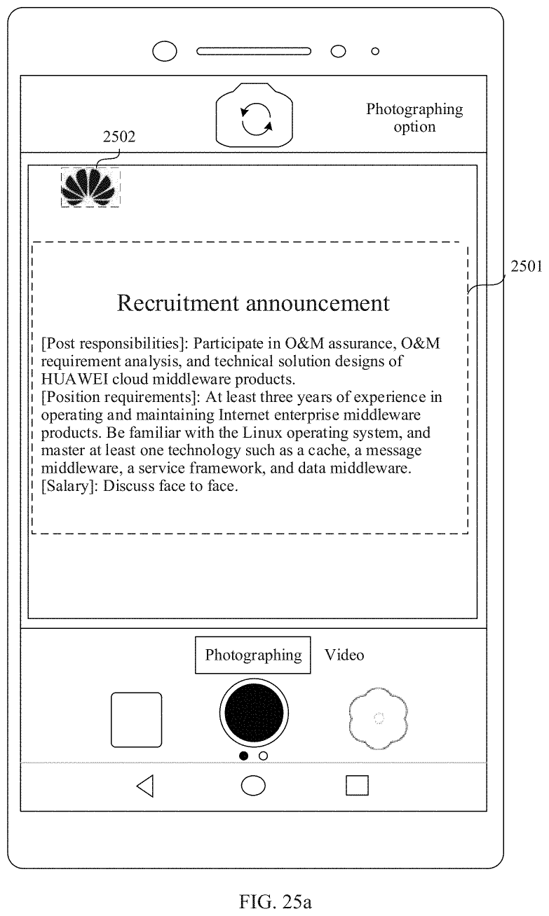

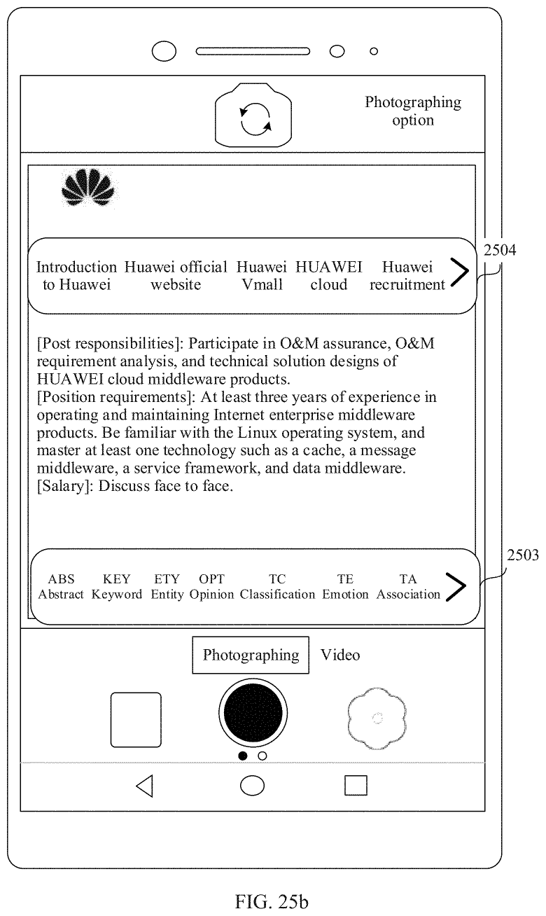

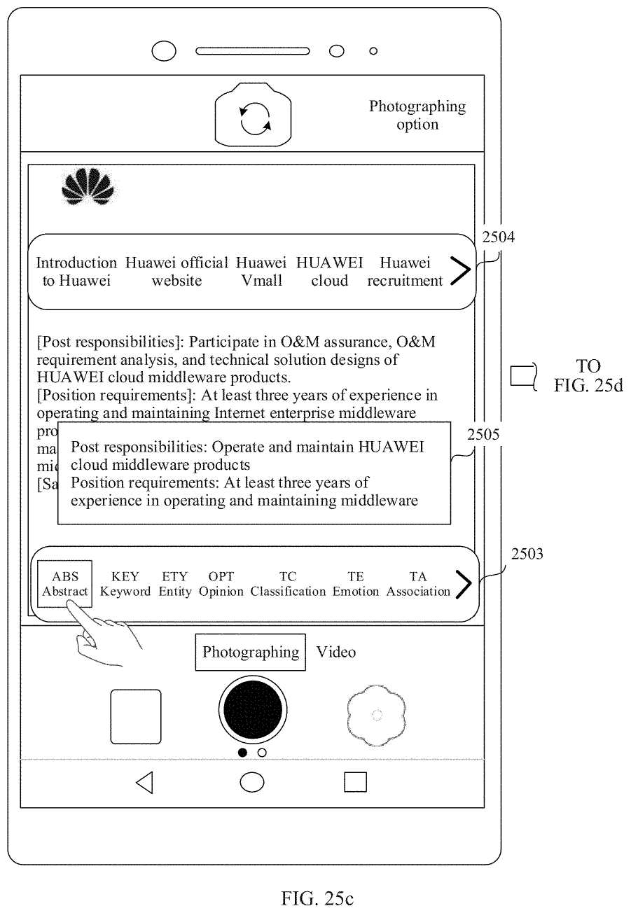

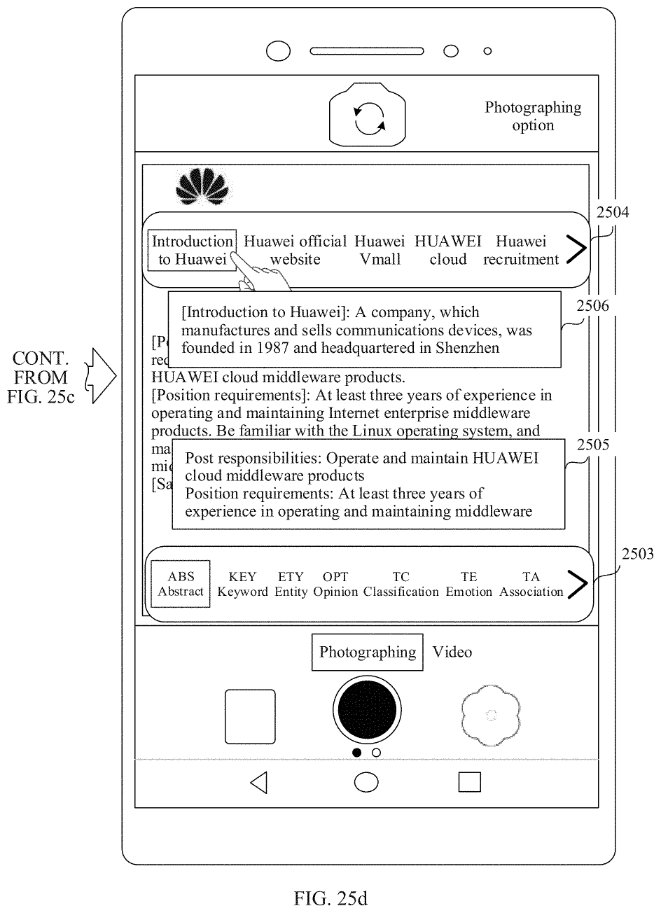

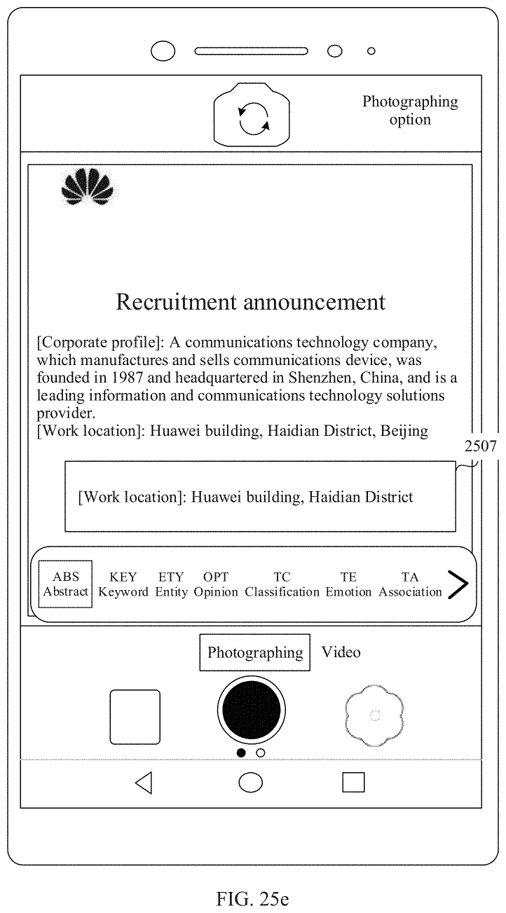

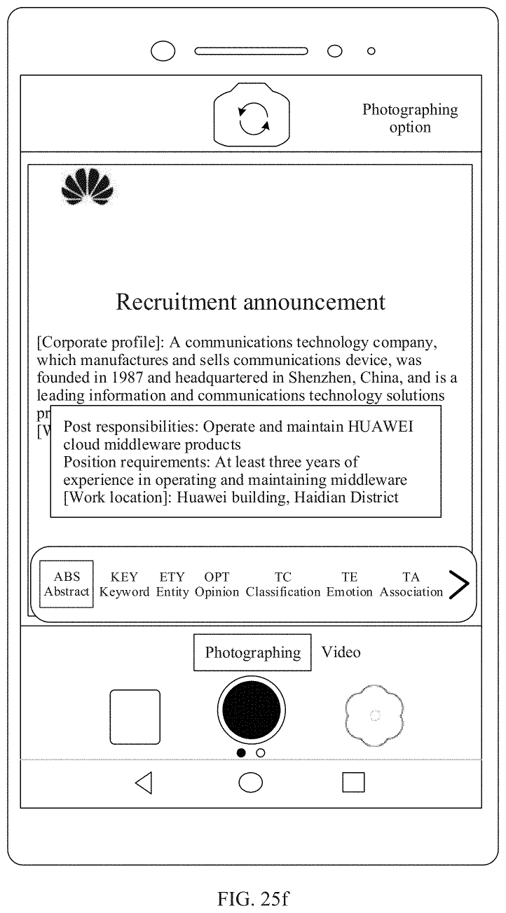

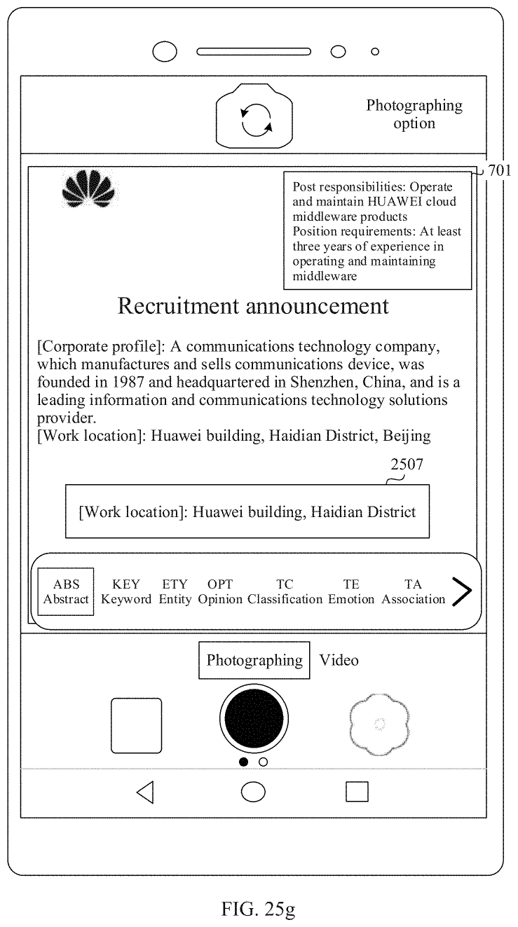

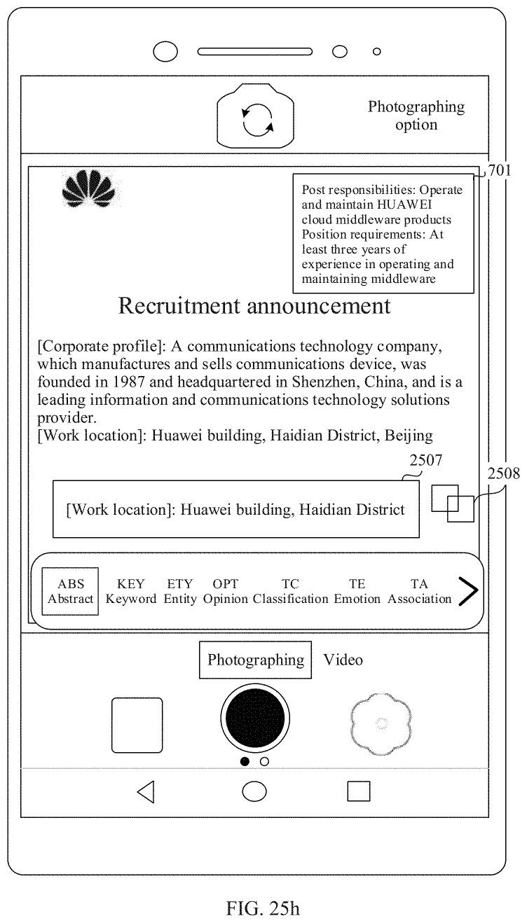

In some other embodiments, the preview object on the preview interface may include a plurality of types of a plurality of sub-objects, and the function list displayed by the electronic device on the preview interface may correspond to the types of the sub-objects. The type of the sub-object in the preview object may include a text type and an image type. The sub-object of the text type is a character part of the preview object. The sub-object of the image type is an image part of the preview object, for example, an image on a previewed picture or a previewed person, animal, or scene. For example, the preview object shown in FIG. 25a includes a first sub-object 2501 of the text type and a second sub-object 2502 of the image type. The first sub-object 2501 is a character part of the recruitment announcement, and the second sub-object 2502 is a Huawei logo part of the recruitment announcement.

Specifically, when the electronic device previews the recruitment announcement in the photographing preview state, the electronic device may display, on the preview interface, a function list 2503 corresponding to the first sub-object 2501 of the text type, the function list 2503 may include function options such as “Abstract”, “Keyword”. “Entity”, “Opinion”, “Classification”, “Emotion”, and “Association”. In addition, the electronic device may display, on the preview interface, another function list 2504 corresponding to the second sub-object 2502 of the image type. The function list 2504 may include function options such as “Introduction to Huawei”, “Huawei official website”, “Huawei Vmall”, “Huawei cloud”, and “Huawei recruitment”. The function list 2504 and the function list 2503 have different content and locations. As shown in FIG. 25c, when the user taps the “Abstract” option in the function list 2503, the electronic device may display abstract information 2505 on the preview interface. As shown in FIG. 25d, when the user taps the “Introduction to Huawei” option in the function list 2504, the electronic device may display information 2506 about “Introduction to Huawei” on the preview interface.

In some other embodiments, in the photographing preview state, when the preview object on the preview interface of the electronic device is switched from a preview object 1 to a preview object 2, in a case, the electronic device may stop displaying service information of the preview object 1, and display service information of the preview object 2. For example, if the entire recruitment announcement includes two parts, and the preview object 1 is a first part of the recruitment announcement (namely, content of an upper part of the entire recruitment announcement) shown in FIG. 7b, as shown in FIG. 7b, the electronic device displays abstract information of the preview object 1. When the user moves the electronic device to preview a second part of the recruitment announcement (namely, content of a lower part of the entire recruitment announcement), the preview object is switched to the preview object 2. As shown in FIG. 25e, the electronic device stops displaying the abstract information of the preview object 1, and displays abstract information 2507 of the preview object 2.

When the preview object on the photographing preview interface of the electronic device is switched from the preview object 1 to the preview object 2, in another case, the electronic device may display the service information 2 of the preview object 2, and continue to display the service information 1 of the preview object 1. For example, if the entire recruitment announcement includes two parts, and the preview object 1 is a first part of the recruitment announcement (namely, content of an upper part of the entire recruitment announcement) shown in FIG. 7b, as shown in FIG. 7b, the electronic device displays abstract information of the preview object 1. When the user moves the electronic device to preview a second part of the recruitment announcement (namely, content of a lower part of the entire recruitment announcement), the preview object is switched to the preview object 2. The electronic device may display the abstract information 2507 of the preview object 2, and continue to display the abstract information 701 of the preview object 1.

For example, as shown in FIG. 25f, the electronic device may display the abstract information of the preview object 1 and the abstract information of the preview object 2 in a same display box.

For another example, the electronic device may display the abstract information 701 of the preview object 1 in a shrinking manner when displaying the abstract information of the preview object 2. For example, as shown in FIG. 25g, the electronic device may display the abstract information 2507 of the preview object 1 in the shrinking manner in an upper right corner (or a lower right corner, an upper left comer, or a lower left comer) of the preview interface. Further, when the electronic device receives a third operation performed by the user, the electronic device may display the abstract information of the preview object 1 and the abstract information of the preview object 2 on the preview interface in a combined manner. For example, the third operation may be an operation of combining the abstract information 701 and the abstract information 2507 by the user. For another example, as shown in FIG. 25h, a combination control 2508 may be displayed on the preview interface. When the user taps the combination control 2508, as shown in FIG. 25f, the electronic device may display the abstract information of the preview object 1 and the abstract information of the preview object 2 on the preview interface in the combined manner, to help the user integrate related service information corresponding to a plurality of preview objects.

Further, in the photographing preview state, after the electronic device detects an operation of tapping a shooting button by the user, the electronic device may shoot a picture. After a picture is shot, and the electronic device detects an operation of opening the picture by the user, the electronic device may display the picture, and may further display a text function of the picture.

In a case, in the photographing preview state, the electronic device may process service information of a target function option selected by the user or obtain the service information from the server, and display and store the service information. After the electronic device opens the shot picture (for example, from an album or from the thumbnail box), the electronic device may display the service information of the target function option based on stored content. When the user wants to display service information that is of another target function and that is not stored, the electronic device may display a text function after the electronic device process the service information of the another target function or obtains the service information of the another target function from the server.

In another case, in the photographing preview state, the electronic device may process service information of all target functions or obtain the service information from the server, and store the service information. After the electronic device opens the shot picture, the electronic device may display a text function based on the stored service information of all target functions. After the electronic device opens the picture, content in the function area may be service information of a target function option selected by the user in the photographing preview state, or may be service information of a default target function, or may be service information of a target function option reselected by the user, or may be service information of all target functions.

In another case, the electronic device does not store service information that is of the target function and that is processed by the electronic device or obtained from the server in the photographing preview state. After the electronic device opens the shot picture, the electronic device re-processes service information of the target function option selected by the user or service information of all target functions, or obtains, from the server, service information of the target function option selected by the user or service information of all target functions, and displays a text function. After the electronic device opens the picture, content displayed in the function area may be service information of a default target function, or may be service information of a target function selected by the user, or may be service information of all target functions.

Specifically, in some embodiments of this application, after the shot picture is opened, a manner in which the electronic device displays the text function of the picture may be the same as the manner in which the electronic device displays the text function for the text object in the photographing preview state and that is shown in FIG. 4a to FIG. 21b. A difference lies in that: In addition to a case in which both image content and related information of a text function may be displayed, shooting controls such as a photographing mode control, a video recording mode control, a shooting option control, a shooting button, a hue style control, a thumbnail box, and a focus box in the photographing preview state are not included on an interface of the touchscreen of the electronic device. In addition, some controls for processing the shot picture, for example, a sharing control, an editing control, a setting control, and a deletion control may be further displayed on the touchscreen of the electronic device.

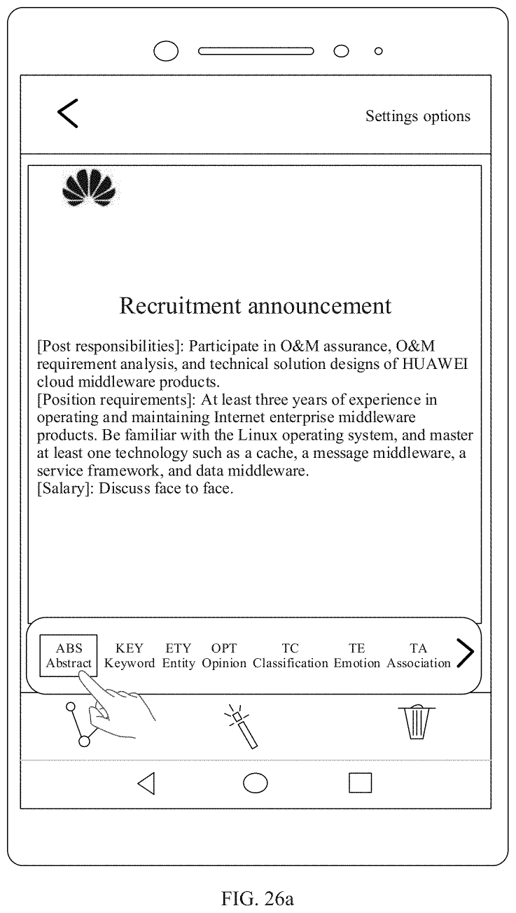

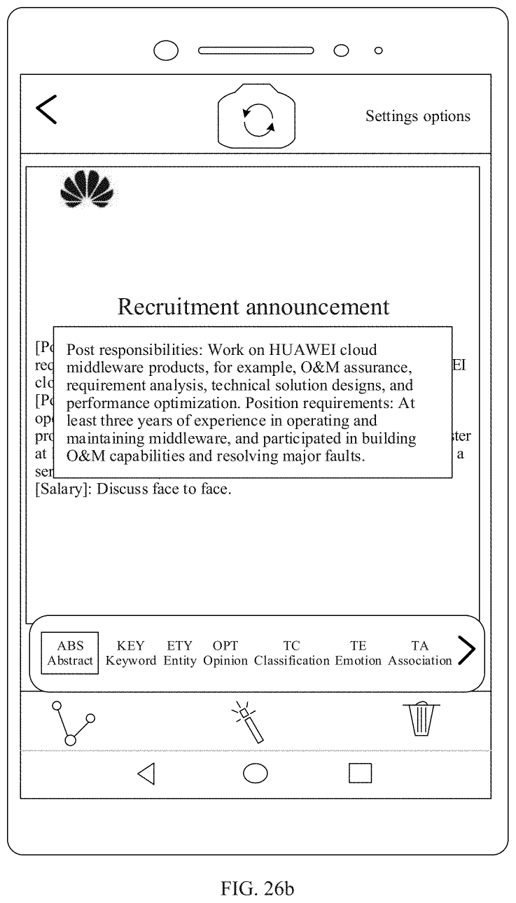

For example, display manners are the same as those shown in FIG. 7a and FIG. 7b. After opening a shot picture of the recruitment announcement, referring to FIG. 26a, the electronic device displays the shot picture and a function list. When the electronic device detects that the user selects an abstract function option from the function list, as shown in FIG. 26b, the electronic device displays a function area, and an abstract of the recruitment announcement is displayed in the function area. Alternatively, after the electronic device opens the shot picture of the recruitment announcement, as shown in FIG. 26b, the electronic device displays a function list and a function area, an abstract function option in the function list is selected by default, and an abstract of the recruitment announcement is displayed in the function area. Herein, only the display manners shown in FIG. 7a and FIG. 7b are used as an example for description. For a display manner that is the same as another manner in FIG. 4a to FIG. 21b, details are not described herein again.

In addition, it should be further noted that a manner is the same as a manner of displaying a text function in the preview box in the photographing preview state. After the shot picture is opened, the electronic device may further hide and resume displaying the function list and the function area.

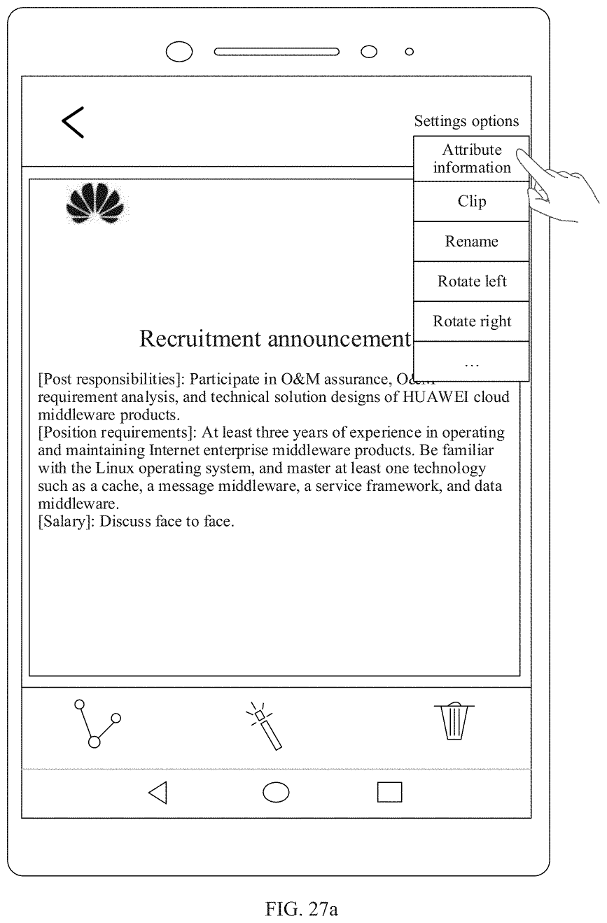

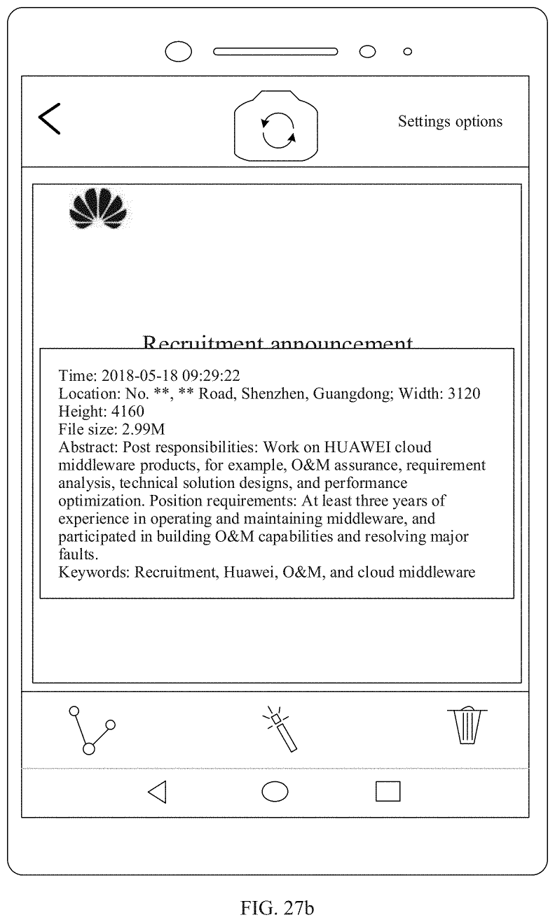

In addition, in some other embodiments of this application, after opening the shot picture, the electronic device may further display the text function in a manner different from the manners shown in FIG. 4a to FIG. 21b. For example, referring to FIG. 27a and FIG. 27b, after opening the picture, the electronic device may display the service information of the target function option or service information of all target functions in attribute information of the picture.

After opening the shot picture, the electronic device displays a text function of the picture, and can convert unstructured character content in the picture into structured character content, so as to reduce an information amount, reduce time spent by the user in reading a large amount of character information in the picture, and help the user quickly learn of main content of the picture by reading a small amount of information that they cares most. In addition, other information related to content of the picture may be provided for the user, and this facilitates reading and information management of the user.

Another embodiment of this application further provides a picture display method. An electronic device may not display a text function in a photographing preview state, but display the text function when shooting a picture and opening a shot picture. For example, on the preview interface 308 shown in FIG. 3b, when the electronic device detects an operation of tapping the shooting button 312 by a user, the electronic device shoots a picture. After the electronic device opens the shot picture (for example, from an album or from a thumbnail box), the electronic device may further process service information of a function option or obtain service information of a function option from a server, to display a text function of the picture.

Specifically, after shooting the picture, the electronic device may process service information of all target functions or obtain service information of all target functions from the server, to display the text function after opening the picture. After the electronic device opens the picture, content in a function area may be service information of a default target function, or may be service information of a target function selected by the user, or may be service information of all target functions.

Alternatively, after opening the picture, the electronic device may process service information of all target functions or obtain service information of all target functions from the server, to display the text function.

Alternatively, after opening the picture and detecting an operation of selecting a target function option by the user, the electronic device may process service information of all target functions or obtain service information of all target functions from the server, to display the text function.

In a case, a manner in which the electronic device displays the text function of the shot picture may be the same as the manner in which the electronic device displays the text function for the text object in the photographing preview state and that is shown in FIG. 4a to FIG. 21b. A difference lies in that: In addition to a case in which both image content and related information of a text function may be displayed, shooting controls such as a photographing mode control, a video recording mode control, a shooting option control, a shooting button, a hue style control, a thumbnail box, and a focus box in the photographing preview state are not included on an interface of the touchscreen of the electronic device. In addition, some controls for processing the shot picture, for example, a sharing control, an editing control, a setting control, and a deletion control may be further displayed on the touchscreen of the electronic device.

For example, display manners are the same as those shown in FIG. 7a and FIG. 7b. After opening a shot picture of a recruitment announcement, referring to FIG. 26a, the electronic device displays the shot picture and a function list. When the electronic device detects that the user selects an abstract function option from a function list, as shown in FIG. 26b, the electronic device displays a function area, and an abstract of the recruitment announcement is displayed in the function area. Alternatively, after the electronic device opens the shot picture of the recruitment announcement, as shown in FIG. 26b, the electronic device displays a function list and a function area, an abstract function option in the function list is selected by default, and an abstract of the recruitment announcement is displayed in the function area. Herein, only the display manners shown in FIG. 7a and FIG. 7b are used as an example for description. For a display manner that is the same as another manner in FIG. 4a to FIG. 21b, details are not described herein again.

In another case, after opening the shot picture, the electronic device may further display the text function in a manner different from the manners shown in FIG. 4a to FIG. 21b. For example, referring to FIG. 27a and FIG. 27b, after opening the picture, the electronic device may display the service information of the target function option or service information of all target functions in attribute information of the picture.

After opening the shot picture, the electronic device displays a text function of the picture, and may convert unstructured character content in the picture into structured character content, to reduce an information amount, reduce time spent by the user in reading a large amount of character information in the picture, and help the user quickly learn of main content of the picture by reading a small amount of information that they cares most. In addition, other information related to content of the picture may be provided for the user, and this facilitates reading and information management of the user.

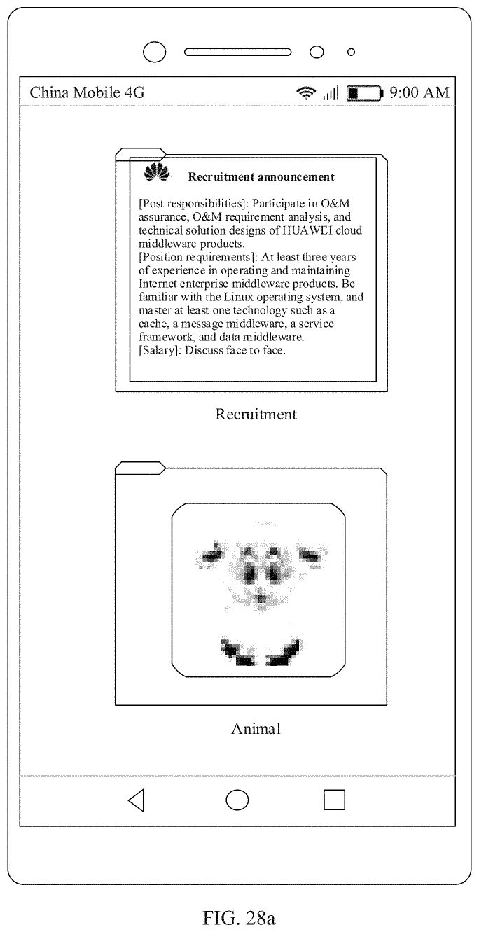

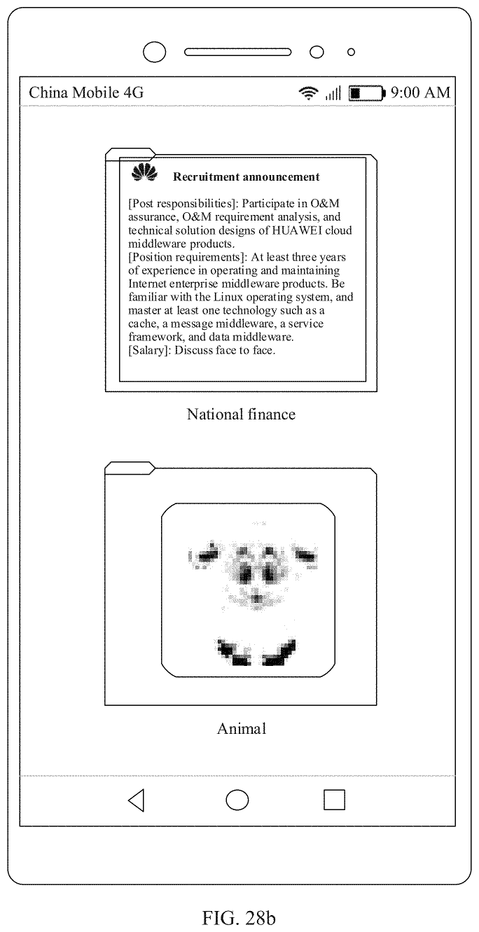

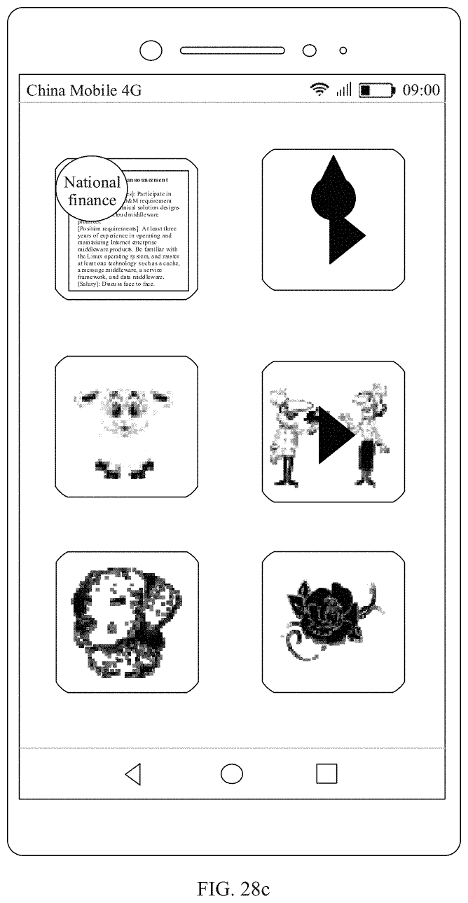

Further, after shooting the picture, the electronic device may further classify the picture in the album based on the service information of the function option, so as to classify or identify the picture from a perspective of the picture. For example, based on the keyword information shown in FIG. 10b, after shooting a picture of the text object in FIG. 10b, the electronic device may establish a group based on a keyword “recruitment”. In addition, as shown in FIG. 28a, the electronic device may classify the picture into a “recruitment” group. For another example, based on the classification information shown in FIG. 15b, after shooting a picture of the text object in FIG. 15b, the electronic device may establish a group based on a classification “National finance”. In addition, as shown in FIG. 28a, the electronic device may classify the picture into a “National finance” group. For another example, based on the classification information shown in FIG. 15b, after the electronic device shoots a picture of the text object in FIG. 15b, as shown in FIG. 28c, the electronic device may apply a label “National news” to the picture. For another example, the electronic device may apply label information to an opened picture based on label information in service information of a function option.

Another embodiment of this application further provides a method for displaying a personalized function of a text, to display a personalized function of text content directly displayed by an electronic device on a touchscreen. Personalized functions may include function options such as “Abstract”. “Keyword”, “Entity”, “Opinion”, “Classification”, “Emotion”. “Association”, and “Product remark” in the foregoing embodiments. The function options may be used to correspondingly process a character in text content, to convert unstructured character content in the text object into structured character content, reduce an information amount, reduce time spent by the user in reading a large amount of character information in the text content, help the user read a small amount of information that the user cares most, and facilitate reading and information management of the user.

The text content displayed by the electronic device through the touchscreen is text content directly displayed by the electronic device on the touchscreen through a browser or an app. The text content is different from a text object previewed by the electronic device in a photographing preview state, and is also different from a picture that has been shot by the electronic device.

Specifically, the electronic device may display the text function in a method that is the same as the method for displaying the personalized function of the text image in the photographing preview state and the method for displaying the personalized function of the shot picture. For example, when the electronic device opens a press release through the browser, the electronic device may display a personalized function such as “Abstract”, “Classification”, or “Association” of the press release. For another example, when the electronic device browses a novel through the app, the electronic device may display a personalized function such as “Keyword”, “Entity”, or “Emotion” of text content displayed on a current page. For another example, when the electronic device opens a file locally, the electronic device may display a personalized function such as “Abstract”, “Keyword”, “Entity”, “Emotion”, or “Association” of text content of the file.

In a case, the electronic device may automatically display a function list when determining that displayed content includes text content. In another case, the electronic device does not display a function list by default, and when detecting a third operation, the electronic device may display the function list in response to the third operation. The third operation may be the same as the foregoing fourth operation, or may be different from the foregoing third operation. This is not specifically limited in this embodiment of this application. In another case, the electronic device may display a function list by default. When the electronic device detects an operation that the user indicates to hide the function list (for example, drags the function list to a frame position of the touchscreen), the electronic device no longer displays the function list.

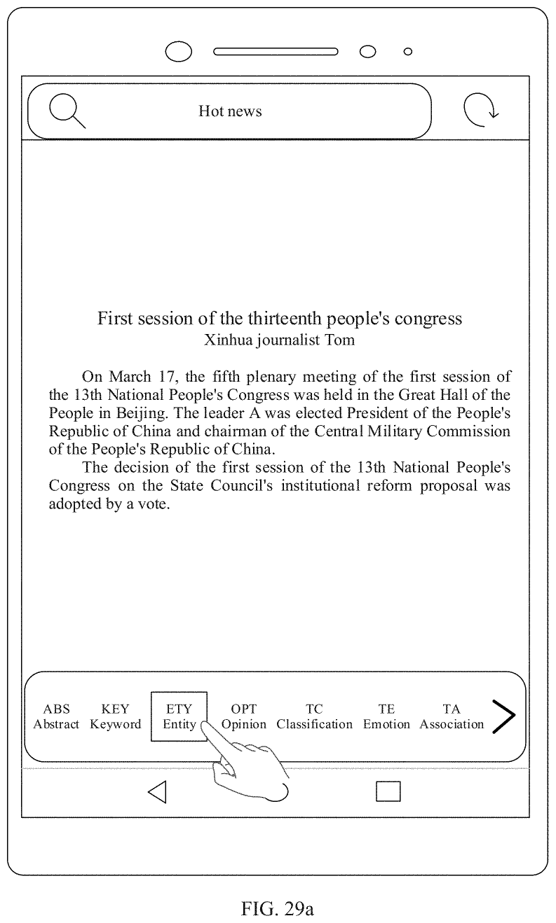

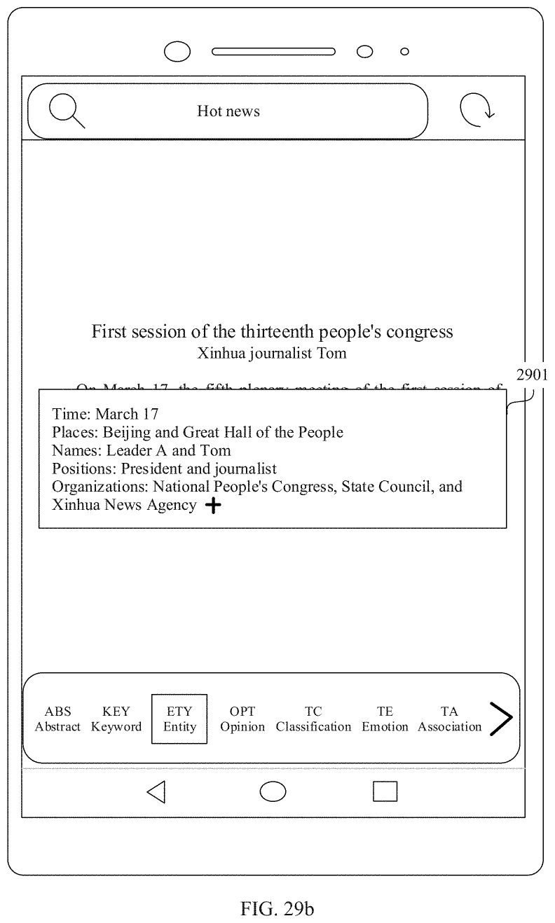

For example, as shown in FIG. 29a, the electronic device opens a press release by using a browser, and a function list is displayed on the touchscreen of the electronic device. When the electronic device detects that the user selects an entity function option from the function list, as shown in FIG. 29b, the electronic device displays a function area 2901, and an entity of the press release is displayed in the function area 2901. Alternatively, for example, when the electronic device opens a preview interface, as shown in FIG. 29b, the electronic device opens a press release by using a browser, a function list and a function area are displayed on the touchscreen of the electronic device, an entity function option in the function list is selected by default, and an entity of the press release is displayed in the function area.

It should be noted that in FIG. 29b, entities such as time, a person name, a place, a position, and an organization are used as an example for display, and the entities may further include other content. In addition, content included in the entity may vary with a type of the text object. For example, the content of the entity may further include a work name, and the like.

In addition, an interface shown in FIG. 29b further includes a control “+” 2902. When the user taps the control “+” 2902, the electronic device may display another organization involved in the text object.

In addition, in a scenario shown in FIG. 29b, the user displays each entity in a text display box in a classified manner, so that information extracted from the text object is more organized and structured, to help the user manage and classify information.

In this way, when the user browses the text content by using the electronic device, the entity function can help the user quickly obtain various types of entity information, help the user find some new entity nouns, and further help the user understand new things.

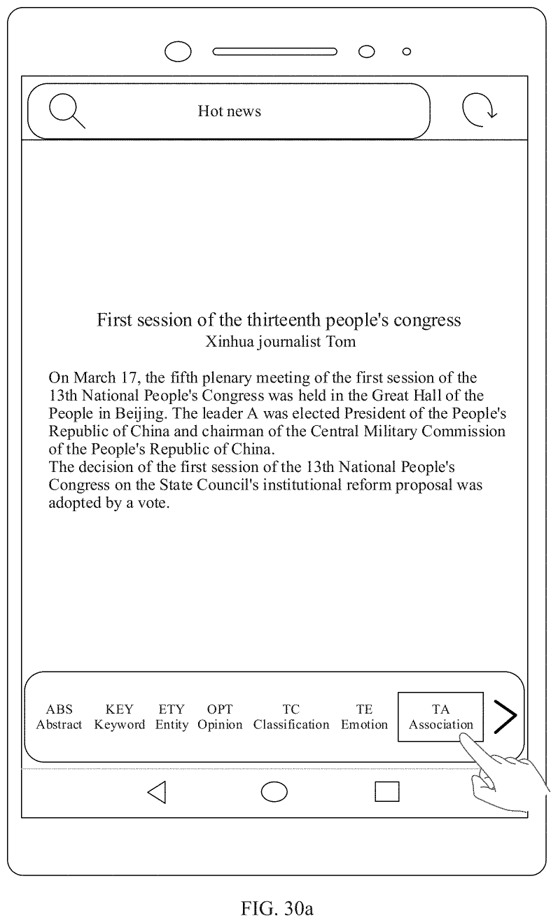

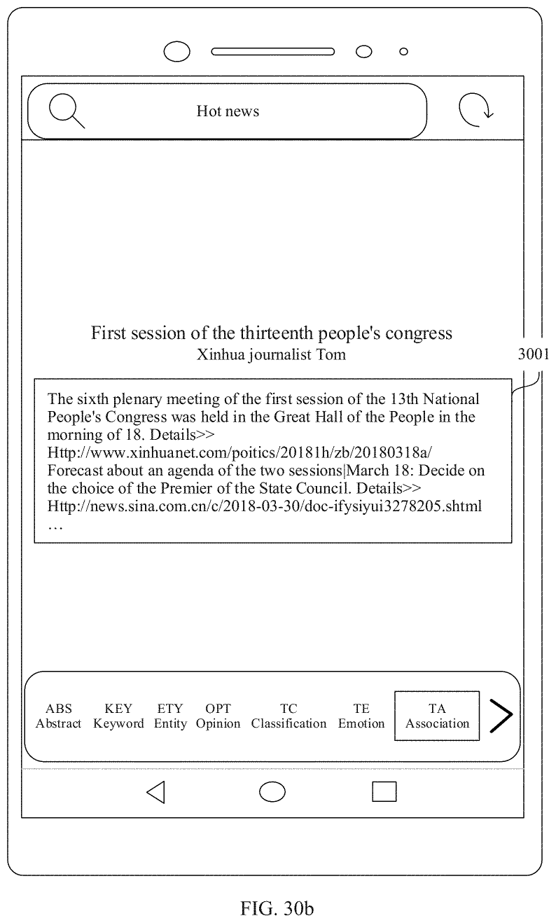

For another example, as shown in FIG. 30a, the electronic device opens a press release by using a browser, and a function list is displayed on the touchscreen of the electronic device. When the electronic device detects that the user selects an association function option from the function list, as shown in FIG. 30b, the electronic device displays a function area 3001, and other content related to the press release is displayed in the function area 3001, for example, a link to related news of the first session of the thirteenth national people's congress, or a link to a forecast about an agenda of the two sessions. Alternatively, for example, when the electronic device opens a preview interface, as shown in FIG. 30b, the electronic device opens a press release by using a browser, a function list and a function area are displayed on the touchscreen of the electronic device, an association function option in the function list is selected by default, and other content related to the press release is displayed in the function area.

In this way, when the user browses the text content by using the electronic device, the association function may provide the user with content related to the text content, to help the user understand and extend more related content, so that the user can extend reading, and the user does not need to specially search for related content.

It should be noted that a text function that can be performed by the electronic device for the text content displayed on the touchscreen is not limited to the entity function and the association function shown in FIG. 29a to FIG. 30b, and may further include a plurality of other text functions. This is not listed one by one herein.

Another embodiment of this application provides a character recognition method. The method may include: An electronic device or a server obtains a target image in a RAW format; and then the electronic device or the server determines a standard character corresponding to a to-be-recognized character in the target image.

For example, the target image may be a preview image obtained during a photographing preview. In the foregoing embodiment of this application, before displaying a text function of a text object in a photographing preview state, the electronic device may further recognize a character in the text object, and then display service information of a function option based on a recognized standard character. In addition, in the foregoing embodiment of this application, before opening a picture and displaying a text function, the electronic device may further recognize a character in a text object corresponding to the picture, and then display a text function based on a recognized standard character. Specifically, that the electronic device recognizes the character in the text object may include: performing recognition through processing performed by the electronic device, or performing recognition by using the server, and obtaining a character recognition result from the server. In the following embodiment, description is provided by using an example in which the server recognizes a character. A method for recognizing a character by the electronic device is the same as a method for recognizing a character by the server. Details are not described again in this embodiment of this application.

In a character recognition method, the electronic device collects a preview image in the photographing preview state, and sends the preview image to the server, and the server recognizes a character based on the preview image; or the electronic device collects a preview image when shooting a picture, and sends the preview image to the server, and the server recognizes a character based on the preview image. The preview image is an original image on which ISP processing is not performed. The electronic device performs ISP processing on the preview image to generate a picture finally presented to a user. In this character recognition method, processing may be directly performed based on an original image output by a camera of the electronic device, without a need to perform, before character recognition, ISP processing on the original image to generate a picture. Preprocessing (an operation includes some inverse processes of ISP processing) performed on a picture during character recognition in some other methods is omitted, so that computing resources are saved, noise introduced due to preprocessing can be avoided, and recognition accuracy can be improved. In addition, a character recognition process and a preview process are performed simultaneously, to bring more convenient use experience to the user.

In another character recognition method, the electronic device may alternatively collect a preview image in the photographing preview state, process the preview image to generate a picture, and then send the picture to the server. The server may perform recognition in the foregoing conventional character recognition manner based on a shot picture. Alternatively, the electronic device may shoot a picture, and then send the picture to the server, and the server may perform recognition in the foregoing mentioned conventional character recognition manner based on the shot picture. Specifically, the server may preprocess the picture to remove noise and useless information from the picture, and then recognize a character based on preprocessed data. It may be understood that in this embodiment of this application, a character may be recognized in another method. Details are not described herein again.

Specifically, in a character recognition process, the server may obtain brightness of each pixel in the preview image, where the brightness is also referred to as a gray level value or a grayscale value (for example, when the preview image is in a YUV format, the brightness is a Y component of the pixel), and the server may perform character recognition processing based on the brightness. However, chromaticity of each pixel in the preview image (for example, when the preview image is in the YUV format, the chromaticity is a U component and a V component of the pixel) may not participate in character recognition processing. In this way, a data amount in a character recognition processing process can be reduced, a calculation time can be reduced, a calculation resource can be saved, and processing efficiency can be improved.

Specifically, the server may perform binary processing and image sharpening processing on the grayscale value of each pixel in the preview image, to generate a black and white image. The binarization means that a grayscale value of a pixel in the preview image is set to 0 or 255, so that the pixel in the preview image is a white pixel (that is, the grayscale value is 0) or a black pixel (that is, the grayscale value is 255). In this way, the preview image can present an obvious black and white effect, and a contour of a to-be-recognized character in the preview image is highlighted. Image sharpening is to compensate a contour of a preview image, enhance an edge of a to-be-recognized character and a gray level jump part in the preview image, highlight the edge and a contour of the to-be-recognized character in the preview image, and sharpen a contrast between the edge of the to-be-recognized character and a surrounding pixel.

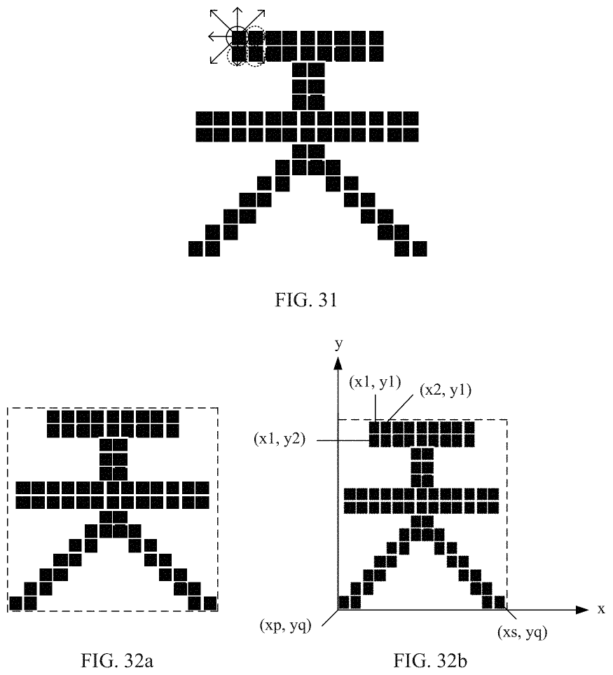

Then, the server determines, based on the black and white image, a black pixel included in the to-be-recognized character. Specifically, in the black and white image, for a black pixel, as shown in FIG. 31, the server may determine whether another pixel whose distance from the black pixel is less than or equal to a preset value exists around the black pixel. If n (a positive integer) other pixels whose distances from the black pixel are less than or equal to a preset value exist around the pixel, the n other pixels and the pixel belong to a same character. The server records the black pixel and the n other pixels, uses each of the n other pixels as a target, and continues to find whether a black pixel that belongs to a same character as the target exists around the target. If no other pixel whose distance from the black pixel is less than or equal to a preset value exists around the pixel, the n other pixels and the pixel does not belong to a same character. The server uses another black pixel as a target, and finds whether a black pixel that belongs to a same character as the target exists around the target. A principle that is for determining the black pixel included in the to-be-recognized character and that is provided in this embodiment of this application may be referred to as “characters are highly correlated internally, and characters are very sparse externally”.

After determining the black pixel included in the to-be-recognized character, the server may match the to-be-recognized character against a character in a standard library based on the black pixel included in the to-be-recognized character. If a standard character matching the to-be-recognized character exists in the standard library, the server determines the to-be-recognized character as the standard character; or if a standard character matching the to-be-recognized character does not exist in the standard library, recognition of the to-be-recognized character fails.

Because the to-be-recognized character and the standard character may have different size ranges, the to-be-recognized character usually needs to be processed before being matched against the standard character.

In a processing method, the server may scale down/up the to-be-recognized character, so that a size range of the to-be-recognized character is consistent with a preset size range of the standard character, and then the scaled-down/up to-be-recognized character is compared with the standard character. As shown in FIG. 32a or FIG. 32b, a size range of a character is a size range of an area enclosed by a first straight line tangent to a left side of a leftmost black pixel of the character, a second straight line tangent to a right side of a rightmost black pixel of the character, a third straight line tangent to an upper side of an uppermost black pixel of the character, and a fourth straight line tangent to a bottom side of a bottom black pixel of the character. A size range shown in FIG. 32a is a size range of a to-be-recognized character that is not scaled-down/up. A size range shown in FIG. 32b is a size range of a scaled-down/up to-be-recognized character, namely, the size range of the standard character.

When the size range of the to-be-recognized character is scaled-down/up to be the same as the preset size range of the standard character, the server may encode the to-be-recognized character based on coordinates of the black pixel included in the scaled-down/up to-be-recognized character. For example, an encoding result may be a set of coordinates of black pixels from the first row to the last row, and in each row, encoding is performed for black pixels in order from left to right. When this encoding method is used, an encoding result of the to-be-recognized character shown in FIG. 32b may be an encoding vector [(x1, y1), (x2, y1), . . . (x1, y2), . . . , (xp, yq), (xs, yq)]. For another example, an encoding result may be a set of coordinates of black pixels (for example, black pixels included in the to-be-recognized character) from the first row to the last row, and in each row, encoding is performed for black pixels in order from right to left. For another example, an encoding result may be a set of coordinates of black pixels from the first column to the last column, and for each column, encoding is performed for black pixels in order from top to bottom.

It should be noted that a coding scheme used for the to-be-recognized character is the same as a coding scheme used for the standard character in the standard library, so that whether the to-be-recognized character matches the standard character may be determined by comparing encoding of the to-be-recognized character and encoding of the standard character.

After obtaining an encoding vector of the to-be-recognized character, the server may determine, based on a value of a similarity (for example, a vector space cosine value and a Pearson correlation coefficient) between the encoding vector of the to-be-recognized character and an encoding vector of the standard character in the standard library, whether the to-be-recognized character matches the standard character. When the similarity is greater than or equal to a preset value, the server may determine that the to-be-recognized character matches the standard character.

In another processing method, the server may encode the to-be-recognized character based on the coordinates of the black pixel included in the to-be-recognized character, to obtain a first encoding vector of the to-be-recognized character, obtain a size range of the to-be-recognized character, and calculate a ratio Q of the preset size range of the standard character to the size range of the to-be-recognized character. When Q is greater than 1. Q may be referred to as an amplification multiple; and when Q is less than 1, Q may be referred to as a minification multiple. Then, the server may calculate, based on an encoding vector 1 of the to-be-recognized character, the ratio Q, and an image scaling down/up algorithm (for example, a sampling algorithm or an interpolation algorithm), an encoding vector 2 corresponding to the to-be-recognized character that is scaled down/up based on the ratio Q. Then, the server may determine, based on a value of a similarity between the encoding vector 2 of the to-be-recognized character and the encoding vector of the standard character in the standard library, whether the to-be-recognized character matches the standard character. When the similarity is greater than or equal to a preset value, the electronic device may determine that the to-be-recognized character matches the standard character. The to-be-recognized character is the standard character.

Compared with a classification recognition method in a conventional character recognition method, the method in which a similarity is calculated based on an encoding vector including coordinates of a pixel and then a character is recognized and that is provided in this embodiment of this application is more accurate.

There may be a plurality of methods in which the server determines, based on a value of the similarity between the encoding vector of the to-be-recognized character and the encoding vector of the standard character in the standard library, whether the to-be-recognized character matches the standard character. For example, the server may compare the encoding vector of the to-be-recognized character with an encoding vector of each standard character in the standard library, and a standard character that has a highest similarity and that is obtained through comparison is the standard character corresponding to the to-be-recognized character.

For another example, the server may sequentially compare the encoding vector of the to-be-recognized character with encoding vectors of standard characters in the standard library in a preset sequence of the standard characters in the character library. The first obtained standard character whose similarity is greater than or equal to a preset value is the standard character corresponding to the to-be-recognized character.

For another example, a first similarity between a second encoding vector of each standard character and a second encoding vector of a preset reference standard character is stored in the standard library, and the standard characters are arranged in order of values of the first similarities. The server calculates a second similarity between the first encoding vector of the to-be-recognized character and the second encoding vector of the reference standard character. In a case, the server determines a target first similarity that is in the standard library and that is closest to a value of the second similarity. A standard character corresponding to the target first similarity is the standard character corresponding to the to-be-recognized character. In this way, the server does not need to sequentially compare the to-be-recognized character with each standard character in the standard library, so that a similarity calculation range can be narrowed down, a process of calculating a similarity between the to-be-recognized character and Chinese characters in the standard library one by one is effectively avoided, and a time for calculating a similarity is greatly reduced.

In another case, the server determines at least one target first similarity (that is, an absolute value of a difference between the at least one target first similarity and the second similarity is less than or equal to a preset threshold) whose value is close to a value of the second similarity and that is in the standard library, and at least one standard character corresponding to the at least one target first similarity. Then, the server determines whether a standard character that matches the to-be-recognized character exists in the at least one standard character corresponding to the at least one target first similarity, without a need to sequentially compare the to-be-recognized character with each standard character in the standard library, so that a similarity calculation range can be narrowed down, a process of calculating a similarity between the to-be-recognized character and Chinese characters in the standard library one by one is effectively avoided, and a time for calculating a similarity is greatly reduced.

For example, the reference standard character is “ [symbol] ”, and an encoding vector of “ [symbol] ” is [a1, a2, a3 . . . ]. Referring to Table 1, encoding vectors in the standard library are arranged in descending order of similarities between the encoding vectors and the encoding vector of the reference standard character.

TABLE 1

| Standard | Encoding | Similarity with the reference standard |
|---|---|---|
| character | vector | character |
| [symbol] | [a1, a2, a3, . . .] | 1 |
| [symbol] | [b1, b2, b3, . . .] | 0.936 |
| [symbol] | [c1, c2, c3, . . .] | 0.929 |
| [symbol] | [d1, d2, d3, . . .] | 0.851 |
| [symbol] | [e1, e2, e3, . . .] | 0.677 |
| . . . | . . . | . . . |

After the encoding vector of the to-be-recognized character is obtained in a recognition process, a similarity between the encoding vector of the to-be-recognized character and the encoding vector of the reference character “ [symbol] ” is calculated according to a similarity algorithm such as a vector space cosine value and a Pearson correlation coefficient, to obtain a second similarity of 0.933. In a case, the server may determine that a first similarity that is in the standard library and that is closest to 0.933 is 0.936, a standard character corresponding to 0.936 is “ [symbol] ”, and the standard character “ [symbol] ” is the standard character corresponding to the to-be-recognized character. In another case, the server determines that target first similarities in the standard library that are near 0.933 are 1, 0.936, and 0.929, and standard characters corresponding to 1, 0.936, and 0.929 are respectively “ [symbol] ”, “ [symbol] ”, and “ [symbol] ”. Then, the server separately compares the to-be-recognized character with “ [symbol] ”, “ [symbol] ” and “ [symbol] ”. When determining that a third similarity between the encoding vector of the to-be-recognized character and the character “ [symbol] ” is the greatest, the server may determine that the to-be-recognized character is the character “ [symbol] ”.

In addition, when information in a function area and a character in a text object do not belong to a same language, after identifying the character in the text object, the electronic device may translate the character into another language, and then display service information of a function option in the function area in the another language. Details are not described herein.

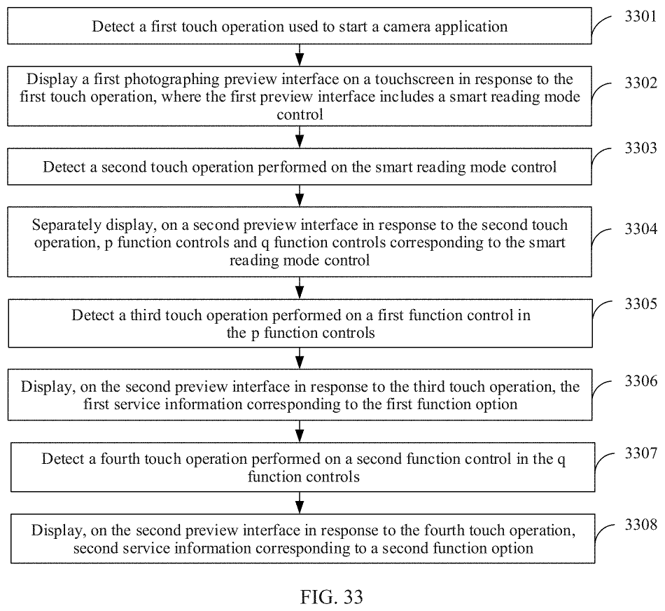

With reference to the foregoing embodiments and corresponding accompanying drawings, another embodiment of this application provides a method for displaying service information on a preview interface. The method may be implemented by an electronic device having the hardware structure shown in FIG. 1 and the software structure shown in FIG. 2. As shown in FIG. 33, the method may include the following steps.

S3301: The electronic device detects a first touch operation used to start a camera application.

For example, the first touch operation used to start the camera application may be the operation of tapping the camera icon 302 by the user as shown in FIG. 3a.

S3302: The electronic device displays a first photographing preview interface on a touchscreen in response to the first touch operation, where the first preview interface includes a smart reading mode control.

For example, the first preview interface may be the interface shown in FIG. 24a, and the smart reading mode control may be the smart reading mode control 2401 shown in FIG. 24a: the first preview interface may be the interface shown in FIG. 23c, and the smart reading mode control may be the function list control 2303 shown in FIG. 23c; the first preview interface may be the interface shown in FIG. 23d, and the smart reading mode control may be the floating ball 2304 shown in FIG. 23d, or the like.

S3303: The electronic device detects a second touch operation performed on the smart reading mode control.

For example, the touch operation performed by the user on the smart reading mode control may be the tap operation performed on the smart reading mode control 2401 shown in FIG. 24a, or the tap operation performed on the function list control 2303 shown in FIG. 23c, or the tap or drag operation performed on the floating ball control 2304 shown in FIG. 23d.

S3304: The electronic device separately displays, on a second preview interface in response to the second touch operation, p function controls and q function controls corresponding to the smart reading mode control, where a preview object exists on the second preview interface, the preview object includes a first sub-object and a second sub-object, the first sub-object is of a text type, the second sub-object is of an image type, the p function controls correspond to the first sub-object, the q function controls correspond to the second sub-object, p and q are natural numbers, and the p function controls are different from the q function controls.

Herein, p and q may be the same or may be different.

For example, the second preview interface may be the interface shown in FIG. 25a, and the second preview interface includes the first sub-object of the text type and the second sub-object of the image type. The first sub-object of the text type may be the sub-object 2501 in FIG. 25a, and the p function controls may be the function controls “Abstract”, “Keyword”, “Entity”, “Opinion”, “Classification”, “Emotion”, and “association” in the function list 2503 shown in FIG. 25b. The second sub-object of the image type may be the sub-object 2502 in FIG. 25a, and the q function controls may be the function controls “Introduction to Huawei”. “Huawei official website”. “Huawei Vmall”, “Huawei cloud”, and “Huawei recruitment” in the function list 2504 shown in FIG. 25b.

S3305: The electronic device detects a third touch operation performed on a first function control in the p function controls.

For example, the third touch operation may be an operation that the user taps the abstract function option in the function list 2503 shown in FIG. 25c.

S3306: The electronic device displays, on the second preview interface in response to the third touch operation, first service information corresponding to the first function option, where the first service information is obtained after the electronic device processes the first sub-object on the second preview interface.

For example, the second preview interface may be the interface shown in FIG. 25a, and the first service information may be the abstract information 2505 corresponding to the first sub-object shown in FIG. 25c.

S3307: The electronic device detects a fourth touch operation performed on a second function control in the q function controls.

For example, the third touch operation may be the operation that the user taps the “Introduction to Huawei” function option in the function list 2504 shown in FIG. 25d.

S3308. The electronic device displays, on the second preview interface in response to the fourth touch operation, second service information corresponding to the second function option, where the second service information is obtained after the electronic device processes the second sub-object on the second preview interface.

For example, the second preview interface may be the interface shown in FIG. 25a, and the first service information may be the information 2506 about “Introduction to Huawei” corresponding to the second sub-object shown in FIG. 25d.

In this solution, on a photographing preview interface, the electronic device may display, in response to an operation performed by a user on the smart reading mode control, different function options respectively corresponding to different types of preview sub-objects, and process a preview sub-object based on a function option selected by the user, to obtain service information corresponding to the function option, so as to display, on the preview interface, different sub-objects and service information corresponding to the selected function option. Therefore, a preview processing function of the electronic device can be improved.

Service information of the first sub-object of the text type is obtained after the electronic device processes a character in the preview object on the second preview interface. The character may include characters of various countries, for example, a Chinese character, an English character, a Russian character, a German character, a French character, a Japanese character, and the like, and may further include a number, a letter, a symbol, and the like. The service information may include abstract information, keyword information, entity information, opinion information, classification information, emotion information, association information, product remark information, or the like. A function option corresponding to a preview sub-object of the text type may be used to correspondingly process a character in the preview sub-object of the text type, so that the electronic device displays, on the second preview interface, service information associated with character content in the preview sub-object, and converts unstructured character content in the preview sub-object into structured character content, so as to reduce an information amount, reduce time spent by the user in reading a large amount of character information in a text object, help the user read a small amount of information that the user cares most, and facilitate reading and information management of the user.

In some other embodiments of this application, that the electronic device displays service information corresponding to a function option (for example, the first service information corresponding to the first function option or the second service information corresponding to the second function option) in step S3306 and step 3308 may include: displaying, by the electronic device, a function interface on the second preview interface in a superimposing manner, where the function interface includes service information corresponding to the function option. The function interface is located in front of the second preview interface. In this way, the user can conveniently learn of the service information by using the function interface in front.

For example, the function interface may be the area 2505 in which the abstract information in a pop-up window form shown in FIG. 25d is located, the area 2506 in which the information about “Introduction to Huawei” is located, or the like.

In some other embodiments of this application, the displaying, by the electronic device, service information corresponding to a first function option in step S3306 may include: displaying, by the electronic device in a marking manner on the preview object displayed on the second preview interface, the first service information corresponding to the first function option. In this way, the service information in the preview object may be highlighted in the marking manner, so that the user browses the service information conveniently.

In some other embodiments of this application, in response to the detecting, by the electronic device, a touch operation performed by a user on the smart reading mode control, the method may further include: displaying, by the electronic device, a language setting control on the touchscreen, where the language setting control is used to set a language type of the service information, to help the user set and switch the language type of the service information. For example, the language setting control may be the language setting control 2101 shown in FIG. 21a, and may be configured to set or switch the language type of the service information.

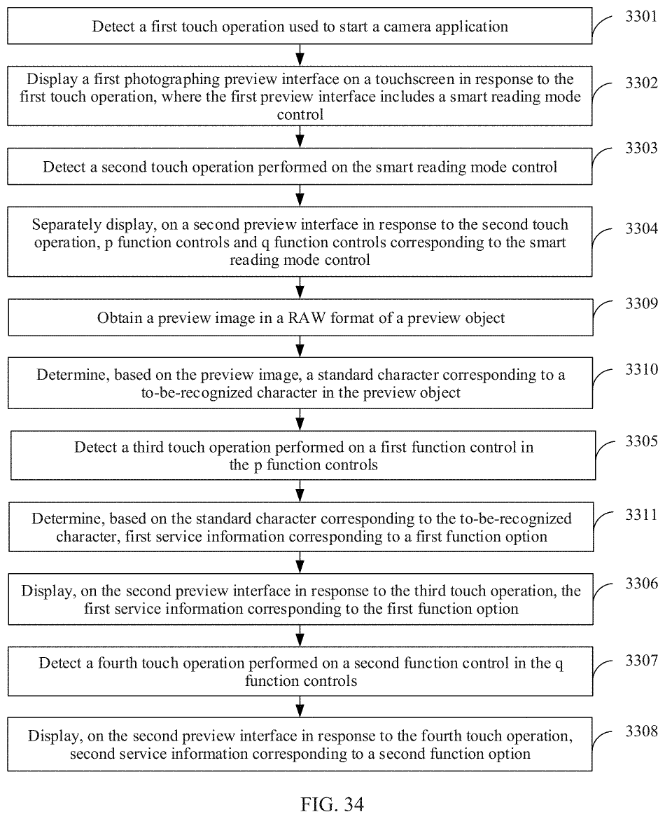

Referring to FIG. 34, before the displaying, on the second preview interface, first service information corresponding to the first function option in step S3306, the method may further include the following steps.

S3309. The electronic device obtains a preview image in a RAW format of the preview object.

The preview image is an original image that is obtained by a camera of the electronic device and on which ISP processing is not performed.

S3310: The electronic device determines, based on the preview image, a standard character corresponding to a to-be-recognized character in the preview object.

To be specific, in this way, the electronic device may directly process an original image that is in the RAW format and that is output by the camera of the electronic device, without a need to perform, before character recognition, ISP processing on the original image to generate a picture. A picture preprocessing operation (including some inverse processes of ISP processing) performed during character recognition in some other methods is omitted, so that computing resources are saved, noise introduced due to preprocessing can be avoided, and recognition accuracy can be improved.

S3311: The electronic device determines, based on the standard character corresponding to the to-be-recognized character, the first service information corresponding to the first function option.

Specifically, for an algorithm and a process of determining, by the electronic device, the first service information of the first function option based on the recognized standard character in the preview object, refer to the detailed description of each function option in the foregoing embodiment. Details are not described herein again.

It should be noted that step S3311 may be performed after step S3305, the foregoing steps S3309 to S3310 may be performed before step S3305, or may be performed after step S3305. This is not limited in this embodiment of this application.

Step S3310 may specifically include the following steps.

S3401: The electronic device performs binary processing on the preview image, to obtain a preview image including a black pixel and a white pixel.

The electronic device performs binary processing on the preview image, so that the preview image can present an obvious black and white effect, to highlight a contour of the to-be-recognized character in the preview image. In addition, the preview image includes only the black pixel and the white pixel, so that a calculated data amount is reduced.

S3402: The electronic device determines, based on a location relationship between adjacent black pixels in the preview image, at least one target black pixel included in the to-be-recognized character.

For example, referring to FIG. 31, the electronic device may determine, based on the foregoing described principle that “characters are highly correlated internally, and characters are very sparse externally”, the at least one target black pixel included in the to-be-recognized character.

S3403: The electronic device performs encoding based on coordinates of the target black pixel, to obtain a first encoding vector of the to-be-recognized character.

S3404: The electronic device calculates a similarity between the first encoding vector and a preset second encoding vector of at least one standard character in a standard library.

S3405: The electronic device determines, based on the similarity, the standard character corresponding to the to-be-recognized character.

In the character recognition method described in step S3401 to step S3405, the electronic device may perform encoding based on the coordinates of the target black pixel included in the to-be-recognized character, and determine, based on a similarity between the to-be-recognized character and the standard character in the standard library, the standard character corresponding to the to-be-recognized character. Compared with a classification recognition method in a conventional character recognition method, the method in which a similarity is calculated based on an encoding vector including coordinates of a pixel and then a character is recognized and that is provided in this embodiment of this application is more accurate.

In some other embodiments of this application, a size range of the standard character is a preset size range. Step S3403 may specifically include: scaling, by the electronic device, down/up a size range of the to-be-recognized character to the preset size range; and performing, by the electronic device, encoding based on coordinates of the target black pixel in the scaled-down/up to-be-recognized character, to obtain the first encoding vector.

In some other embodiments of this application, a size range of the standard character is a preset size range. Step S3403 may specifically include: performing, by the electronic device, encoding based on the coordinates of the target black pixel in the to-be-recognized character, to obtain a third encoding vector; calculating, by the electronic device, a ratio Q of the preset size range to a size range of the to-be-recognized character; and calculating, by the electronic device based on the third encoding vector, the ratio Q, and an image scaling algorithm, the first encoding vector corresponding to the to-be-recognized character that is scaled down/up by Q times.

A size range of a character is a size range of an area enclosed by a first straight line tangent to a left side of a leftmost black pixel of the character, a second straight line tangent to a right side of a rightmost black pixel of the character, a third straight line tangent to an upper side of an uppermost black pixel of the character, and a fourth straight line tangent to a bottom side of a bottom black pixel of the character.

Because the to-be-recognized character and the standard character may have different size ranges, the to-be-recognized character usually needs to be processed before being compared with the standard character. For example, for the to-be-recognized character that is not scaled down/up, refer to FIG. 32a, and for the scaled-down/up to-be-recognized character, refer to FIG. 32b.

For a specific process of obtaining the first encoding vector based on the scaled-down/up to-be-recognized character or the value Q in step S3403, refer to the detailed description of the character recognition process in the foregoing embodiment. Details are not described herein again.

In some other embodiments of this application, the standard library includes a reference standard character and a first similarity between a second encoding vector of each of other standard characters and a second encoding vector of the reference standard character. Step 3404 may specifically include: calculating, by the electronic device, a second similarity between the first encoding vector and the second encoding vector of the reference standard character; determining at least one target first similarity, where an absolute value of a difference between the target first similarity and the second similarity is less than or equal to a preset threshold; and calculating a third similarity between the first encoding vector and a second encoding vector of a standard character corresponding to each of the at least one target first similarity. Based on this, step S3405 may specifically include: determining, by the electronic device based on the third similarity, the standard character corresponding to the to-be-recognized character. A standard character corresponding to a maximum third similarity is a standard character that matches the to-be-recognized character.

For example, for specific descriptions of step S3404 and step S3405 performed by the electronic device, refer to the detailed process that is of recognizing the to-be-recognized character based on the reference standard character “k” and that is described by using Table 1 as an example in the foregoing embodiment. Details are not described herein again.

In this way, the electronic device does not need to sequentially compare the to-be-recognized character with each standard character in the standard library, so that a similarity calculation range can be narrowed down, a process of calculating a similarity between the to-be-recognized character and Chinese characters in the standard library one by one is effectively avoided, and a time for calculating a similarity is greatly reduced.

With reference to the foregoing embodiments and corresponding accompanying drawings, another embodiment of this application provides a method for displaying service information on a preview interface. The method may be implemented by an electronic device having the hardware structure shown in FIG. 1 and the software structure shown in FIG. 2. The method may include the following steps.

S3501: The electronic device detects a first touch operation used to start a camera application.

S3502: The electronic device displays a first photographing preview interface on the touchscreen in response to the first touch operation, where the first preview interface includes a smart reading mode control.

S3503: The electronic device detects a second touch operation performed on the smart reading mode control.

S3504: The electronic device separately displays, on a second preview interface in response to the second touch operation, p function controls and q function controls corresponding to the smart reading mode control, where a preview object exists on the second preview interface, the preview object includes a first sub-object and a second sub-object, the first sub-object is of a text type, the second sub-object is of an image type, the p function controls correspond to the first sub-object, the q function controls correspond to the second sub-object, and the p function controls are different from the q function controls.

S3505: The electronic device obtains a preview image in a RAW format of the preview object.

S3506: The electronic device performs binary processing on the preview image, to obtain a preview image represented by a black pixel and a white pixel.

S3507: The electronic device determines, based on a location relationship between adjacent black pixels in the preview image, at least one target black pixel included in the to-be-recognized character.

S3508: The electronic device scales down/up a size range of the to-be-recognized character to the preset size range.

S3509: The electronic device performs encoding based on coordinates of the target black pixel in the scaled-down/up to-be-recognized character, to obtain the first encoding vector.

S3510: The electronic device calculates a second similarity between the first encoding vector and a reference standard character.

S3511: The electronic device determines at least one target first similarity, where an absolute value of a difference between the target first similarity and the second similarity is less than or equal to a preset threshold.

S3512: The electronic device calculates a third similarity between the first encoding vector and a second encoding vector of a standard character corresponding to each of the at least one target first similarity.

S3513: The electronic device determines, based on the third similarity, a standard character corresponding to the to-be-recognized character.

S3514: The electronic device detects a third touch operation performed on a first function control in the p function controls.

S3515: The electronic device determines, in response to the third touch operation based on the standard character corresponding to the to-be-recognized character, first service information corresponding to the first function option, where the first service information is obtained after the electronic device processes the first sub-object on the second preview interface.

S3516: The electronic device displays, on the second preview interface, the first service information corresponding to the first function option.

S3517: The electronic device detects a fourth touch operation performed on a second function control in the q function controls.

S3518: The electronic device displays, on the second preview interface in response to the fourth touch operation, second service information corresponding to a second function option, where the second service information is obtained after the electronic device processes the second sub-object on the second preview interface.

Steps S3505 to S3513 may be performed before step S3514, or may be performed after step S3514. This is not limited in this embodiment of this application.

It may be understood that, to implement the foregoing functions, the electronic device includes corresponding hardware and/or software modules for performing the functions. Algorithm steps in the examples described with reference to the embodiments disclosed in this specification can be implemented by hardware or a combination of hardware and computer software in this application. Whether a function is performed by hardware or hardware driven by computer software depends on particular applications and design constraints of the technical solutions. A person skilled in the art may use different methods to implement the described functions for each particular application with reference to the embodiments, but it should not be considered that the implementation goes beyond the scope of the embodiments of this application.

In the embodiments of this application, the electronic device may be divided into function modules according to the example in the foregoing method. For example, each function module corresponding to each function may be obtained through division, or two or more functions may be integrated into one processing module. The integrated module may be implemented in a form of hardware. It should be noted that, in this embodiment of this application, division into modules is an example, and is merely a logical function division. In actual implementation, another division manner may be used.

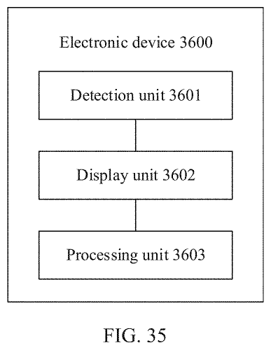

When function modules are obtained through division by using corresponding functions, FIG. 35 is a schematic diagram of possible composition of an electronic device 3600 according to the foregoing embodiment. As shown in FIG. 35, the electronic device 3600 may include a detection unit 3601, a display unit 3602, and a processing unit 3603.

The detection unit 3601 may be configured to support the electronic device 3600 in performing step S3301, step S3303, step S3305, step S3307, step S3501, step S3503, step S3514, step S3517, and the like, and/or another process used for the technology described in this specification.

The display unit 3601 may be configured to support the electronic device 3600 in performing step S3302, step S3304, step S3306, step S3308, step S3502, step S3504, step S3516, step S3518, and the like, and/or another process used for the technology described in this specification.

The processing unit 3601 may be configured to support the electronic device 3600 in performing step S3308 to step S3311, step S3401 to step S3405, step S3505 to step S35013, step S3515, and the like, and/or another process used for the technology described in this specification.

It should be noted that all related content of the steps in the foregoing method embodiments may be cited in function descriptions of corresponding function modules. Details are not described herein again.

The electronic device provided in the embodiments of this application is configured to perform the foregoing implementation method for displaying service information on a preview interface, to achieve an effect the same as that of the foregoing implementation method.

When an integrated unit is used, the electronic device may include a processing module and a storage module. The processing module may be configured to control and manage actions of the electronic device, for example, may be configured to support the electronic device in performing the steps performed by the detection unit 3601, the display unit 3602, and the processing unit 3603. The storage module may be configured to support the electronic device in storing a first preview interface, a second preview interface, a preview image of a preview object, service information obtained through processing, program code, data, and the like. In addition, the electronic device may further include a communications module, and the communications module may be configured to support communication between the electronic device and another device.

The processing module may be a processor or a controller. The processor may implement or execute various example logical blocks, modules, and circuits described with reference to content disclosed in this application. Alternatively, the processor may be a combination of processors implementing a computing function, for example, a combination of one or more microprocessors, or a combination of a digital signal processor (digital signal processing, DSP) and a microprocessor. The storage module may be a memory. The communications module may be specifically a device that interacts with another electronic device, such as a radio frequency circuit, a Bluetooth chip, or a Wi-Fi chip.

In an embodiment, when the processing module is a processor and the storage module is a memory, the electronic device in this embodiment may be a device in the structure shown in FIG. 1.

An embodiment of this application further provides a computer storage medium. The computer storage medium stores a computer instruction, and when the computer instruction is run on an electronic device, the electronic device performs the foregoing related method steps to implement the method for displaying service information on a preview interface in the foregoing embodiments.

An embodiment of this application further provides a computer program product. When the computer program product is run on a computer, the computer is enabled to perform the foregoing related method steps to implement the method for displaying service information on a preview interface in the foregoing embodiments.

In addition, an embodiment of this application further provides an apparatus. The apparatus may be specifically a chip, a component, or a module. The apparatus may include a processor and a memory that are connected. The memory is configured to store a computer executable instruction, and when the apparatus runs, the processor may execute the computer executable instruction stored in the memory, so that the chip performs the method for displaying service information on a preview interface in the foregoing method embodiments.

The electronic device, the computer storage medium, the computer program product, or the chip provided in the embodiments of this application is configured to perform the corresponding method provided above. Therefore, for beneficial effects that can be achieved, refer to the beneficial effects in the corresponding method provided above. Details are not described herein again.

It should be noted that, in the embodiments of this application, division into units is an example, and is merely a logical function division. In actual implementation, another division manner may be used. Function units in the embodiments of the present invention may be integrated into one processing unit, or each of the units may exist alone physically, or two or more units are integrated into one unit. The integrated unit may be implemented in a form of hardware, or may be implemented in a form of a software function unit.

According to the context, the term “when” used in the foregoing embodiments may be interpreted as a meaning of “if” or “after” or “in response to determining” or “in response to detecting”. Similarly, according to the context, the phrase “when it is determined that” or “if (a stated condition or event) is detected” may be interpreted as a meaning of “when it is determined that” or “in response to determining” or “when (a stated condition or event) is detected” or “in response to detecting (a stated condition or event)”.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, the procedure or functions according to the embodiments of the present invention are all or partially generated. The computer may be a general purpose computer, a dedicated computer, a computer network, or other programmable apparatuses. The computer instructions may be stored in a computer readable storage medium or may be transmitted from one computer readable storage medium to another computer readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk), or the like.

For a purpose of explanation, the foregoing description is described with reference to a specific embodiment. However, the foregoing example discussion is not intended to be detailed, and is not intended to limit this application to a disclosed precise form. According to the foregoing teaching content, many modification forms and variation forms are possible. Embodiments are selected and described to fully illustrate the principles of this application and practical application of the principles, so that another person skilled in the art can make full use of this application and various embodiments that have various modifications applicable to conceived specific usage.

1. A method for displaying service information on a preview interface, wherein the method is implemented by an electronic device comprising a touchscreen, and wherein the method comprises:
detecting a first touch operation to start a camera application;
displaying, in response to the first touch operation, a first preview interface comprising a control on the touchscreen;
detecting a second touch operation on the control;
displaying, on a second preview interface in response to the second touch operation, p function controls and q function controls corresponding to the control, wherein the second preview interface comprises a preview object comprising a first sub-object and a second sub-object, wherein the first sub-object is of a text type, wherein the second sub-object is of an image type, wherein the p function controls correspond to the first sub-object, wherein the q function controls correspond to the second sub-object, wherein p and q are natural numbers, and wherein the p function controls are different from the q function controls;
detecting a third touch operation on a first function control in the p function controls;
processing the first sub-object to obtain first service information corresponding to a first function option;
displaying, on the second preview interface in response to the third touch operation, the first service information;
detecting a fourth touch operation on a second function control in the q function controls,
processing the second sub-object to obtain second service information corresponding to a second function option; and
displaying, on the second preview interface in response to the fourth touch operation, the second service information.

2. The method of claim 1, wherein before displaying the first service information, the method further comprises:
obtaining a first preview image of the preview object;
determining, based on the first preview image, a first standard character corresponding to a to-be-recognized character in the preview object; and
determining, based on the first standard character, the first service information.

3. The method claim 2, further comprising
performing a binary processing on the first preview image to obtain a second preview image comprising a black pixel and a white pixel;
determining, based on a location relationship between adjacent black pixels in the second preview image, a target black pixel in the to-be-recognized character;
encoding, based on first coordinates of the target black pixel, the target black pixel to obtain a first encoding vector of the to-be-recognized character;
calculating a first similarity between the first encoding vector and a preset second encoding vector of a second standard character in a standard library; and
determining, based on the first similarity, the first standard character.

4. The method of claim 3, wherein a first size range of the first standard character is a preset size range, and wherein the method further comprises:
scaling a second size range of the to-be-recognized character to the preset size range to obtain a scaled to-be-recognized character; and
encoding, based on second coordinates of the target black pixel in the scaled to-be-recognized character, the target black pixel to obtain the first encoding vector.

5. The method of claim 3, wherein the standard library comprises a reference standard character and a second similarity between a third encoding vector of each of third standard characters and a fourth encoding vector of the reference standard character, and wherein the method further comprises:
calculating a third similarity between the first encoding vector and the fourth encoding vector;
determining a target similarity, wherein an absolute value of a difference between the target similarity and the third similarity is less than or equal to a preset threshold;
calculating a fourth similarity between the first encoding vector and a fifth encoding vector of a fourth standard character corresponding to the target similarity; and
determining, based on the fourth similarity, the first standard character.

6. The method of claim 1, further comprising displaying a function interface comprising the first service information on the second preview interface in a superimposing manner.

7. The method of claim 1, wherein the first service information comprises abstract information, keyword information, entity information, opinion information, classification information, emotion information, association information, or product remark information.

8. An electronic device comprising:
a touchscreen configured to detect a first touch operation to start a camera application;
a processor coupled the touchscreen and configured to instruct, in response to the first touch operation, the touchscreen to display a first preview interface comprising a control,
wherein the touchscreen is further configured to:
display the first preview interface; and
detect a second touch operation on the control,
wherein the processor is further configured to instruct, in response to the second touch operation, the touchscreen to display a second preview interface, wherein the second preview interface comprises p function controls and q function controls corresponding to the control and a preview object, wherein the preview object comprises a first sub-object and a second sub-object, wherein the first sub-object is of a text type, wherein the second sub-object is of an image type, wherein the p function controls correspond to the first sub-object, wherein the q function controls correspond to the second sub-object, wherein p and q are natural numbers, and wherein the p function controls are different from the q function controls,
wherein the touchscreen is further configured to:
display the second preview interface; and
detect a third touch operation on a first function control in the p function controls,
wherein the processor is further configured to:
process the first sub-object to obtain first service information corresponding to a first function option; and
instruct, in response to the third touch operation, the touchscreen to display, on the second preview interface, the first service information,
wherein the touchscreen is further configured to:
display the first service information; and
detect a fourth touch operation on a second function control in the q function controls,
wherein the processor is further configured to:
process the second sub-object to obtain second service information corresponding to a second function option; and
instruct, in response to the fourth touch operation, the touchscreen to display, on the second preview interface, the second service information,
wherein the touchscreen is further configured to display, on the second preview interface, the second service information; and
a memory coupled to the processor and the touch screen and configured to store the first preview interface and the second preview interface.

9. The electronic device of claim 8, wherein before displaying the first service information, the processor is further configured to:
obtain a first preview image of the preview object;
determine, based on the first preview image, a first standard character corresponding to a to-be-recognized character in the preview object; and
determine, based on the first standard character, the first service information.

10. The electronic device of claim 9, wherein the processor is further configured to:
perform binary processing on the first preview image to obtain a second preview image comprising a black pixel and a white pixel;
determine, based on a location relationship between adjacent black pixels in the second preview image, a target black pixel in the to-be-recognized character;
encode, based on first coordinates of the target black pixel, the target black pixel to obtain a first encoding vector of the to-be-recognized character;
calculate a first similarity between the first encoding vector and a preset second encoding vector of a second standard character in a standard library; and
determine, based on the first similarity, the first standard character.

11. The electronic device of claim 10, wherein a first size range of the first standard character is a preset size range, and wherein the processor is further configured to:
scale a second size range of the to-be-recognized character to the preset size range to obtain a scaled to-be-recognized character; and
encode, based on second coordinates of the target black pixel in the scaled to-be-recognized character, the target black pixel to obtain the first encoding vector.

12. The electronic device of claim 10, wherein the standard library comprises a reference standard character and a second similarity between a third encoding vector of each of third standard characters and a fourth encoding vector of the reference standard character, and wherein the processor is further configured to:
calculate a third similarity between the first encoding vector and the fourth encoding vector;
determine a target similarity, wherein an absolute value of a difference between the target similarity and the third similarity is less than or equal to a preset threshold;
calculate a fourth similarity between the first encoding vector and a fifth encoding vector of a fourth standard character corresponding to the target similarity; and
determine, based on the fourth similarity, the first standard character.

13. The electronic device of claim 8, wherein the touchscreen is further configured to display a function interface comprising the first service information on the second preview interface in a superimposing manner.

14. The electronic device of claim 8, wherein the first service information comprises abstract information, keyword information, entity information, opinion information, classification information, emotion information, association information, or product remark information.

15.-17. (canceled)

18. The method of claim 3, wherein a first size range of the first standard character is a preset size range, and wherein the method further comprises:
encoding, based on the first coordinates, the target black pixel to obtain a sixth encoding vector;
calculating a ratio of the preset size range to a second size range of the to-be-recognized character (Q); and
calculating, based on the sixth encoding vector, Q, and an image scaling algorithm, the first encoding vector, wherein the first encoding vector is scaled by Q times.

19. The method of claim 1, further comprising further displaying the first service information in a marking manner on the preview object.

20. The electronic device of claim 10, wherein a first size range of the first standard character is a preset size range, and wherein the processor is further configured to:
encode, based on the first coordinates, the target black pixel to obtain a sixth encoding vector;
calculate a ratio of the preset size range to a second size range of the to-be-recognized character (Q); and
calculate, based on the sixth encoding vector, Q, and an image scaling algorithm, the first encoding vector, wherein the first encoding vector is scaled by Q times.

21. The electronic device of claim 8, wherein the touchscreen is further configured to display the first service information in a marking manner on the preview object.

22. A computer program product comprising computer-executable instructions stored on a non-transitory computer-readable medium that, when executed by a processor, cause an apparatus to:
detect a first touch operation to start a camera application;
display, in response to the first touch operation, a first preview interface comprising a control on a touchscreen;
detect a second touch operation on the control;
display, on a second preview interface in response to the second touch operation, p function controls and q function controls corresponding to the control, wherein the second preview interface comprises a preview object comprising a first sub-object and a second sub-object, wherein the first sub-object is of a text type, wherein the second sub-object is of an image type, wherein the p function controls correspond to the first sub-object, wherein the q function controls correspond to the second sub-object, wherein p and q are natural numbers, and wherein the p function controls are different from the q function controls;
detect a third touch operation on a first function control in the p function controls;
process the first sub-object to obtain first service information corresponding to a first function option;
display, on the second preview interface in response to the third touch operation, the first service information;
detect a fourth touch operation on a second function control in the q function controls;
process the second sub-object to obtain second service information corresponding to a second function option; and
display, on the second preview interface in response to the fourth touch operation, the second service information.

23. The computer program product of claim 22, wherein before displaying the first service information, the computer-executable instructions further cause the apparatus to:
obtain a first preview image of the preview object;
determine, based on the first preview image, a first standard character corresponding to a to-be-recognized character in the preview object; and
determine, based on the first standard character, the first service information.
